(19) United States
(12) Patent Application Publication
(10) Pub. No.: US 2025/0342541 A1
(43) Pub. Date: Nov. 6, 2025

(54) MANAGING DATA

(71) Applicant: Apple Inc., Cupertino, CA (US)

(72) Inventors: Mischa K. MCLACHLAN, San Francisco, CA (US); Nicholas D. FELTON, Sunnyvale, CA (US)

(21) Appl. No.: 19/065,807

(22) Filed: Feb. 27, 2025

Related U.S. Application Data
(60) Provisional application No. 63/643,317, filed on May 6, 2024.
(60) Provisional application No. 63/657,633, filed on Jun. 7, 2024.

(51) Int. Cl. G06Q 50/06

(52) U.S. Cl. CPC G06Q 50/06

(57) ABSTRACT

The present disclosure generally relates to managing data. Some techniques are for connecting to an energy account of an energy provider in accordance with some embodiments. Other techniques are for outputting different types of comparisons for different time periods in accordance with some embodiments. Other techniques are for outputting data when data is not complete in accordance with some embodiments. Other techniques are for outputting comparison data of different types in accordance with some embodiments.

### CROSS-REFERENCE TO RELATED APPLICATIONS

This application claims priority to U.S. Provisional Patent Application Ser. No. 63/657,633, entitled “MANAGING DATA” filed Jun. 7, 2024, and to U.S. Provisional Patent Application Ser. No. 63/643,317, entitled “MANAGING DATA” filed May 6, 2024, which are hereby incorporated by reference in their entireties for all purposes.

### FIELD

The present disclosure relates generally to computer user interfaces, and more specifically to techniques for managing data.

### BACKGROUND

Electronic devices can be used to output information to a user. Such information can be based on data that is tracked over time.

### SUMMARY

Some techniques for managing data using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing data. Such methods and interfaces optionally complement or replace other methods for managing data. Such methods and interfaces reduce the cognitive burden on a user and produce a more efficient human-machine interface. For battery-operated computing devices, such methods and interfaces conserve power and increase the time between battery charges. Such methods and interfaces provide information in a manner that is comprehensible to the user based on considerations that are relevant to how the user would readily use the information. Accordingly, the methods and interfaces can reduce the number of unnecessary, extraneous, and/or repetitive received inputs to obtain the desired information.

In some embodiments, a method that is performed at a computer system that is in communication with a display generation component and an input device is described. In some embodiments, the method comprises: detecting, via the input device, an input corresponding to a request to display energy usage data; and in response to detecting the input corresponding to the request to display energy usage data: in accordance with a determination that a first set of one or more criteria is satisfied, displaying, via the display generation component, a first representation of energy usage data corresponding to a first energy account of a first energy provider, wherein the first representation of energy usage data includes an indication of a first amount of energy used in a first time period; and in accordance with a determination that a second set of one or more criteria, different from the first set of one or more criteria, is satisfied, displaying, via the display component, a second representation of energy usage data corresponding to a second energy account, different from the first energy account, of a second energy provider, different from the first energy provider, wherein the second representation of energy usage data includes an indication of a second amount of energy used in a second time period.

In some embodiments, a non-transitory computer-readable storage medium storing one or more programs configured to be executed by one or more processors of a computer system that is in communication with a display generation component and an input device is described. In some embodiments, the one or more programs includes instructions for: detecting, via the input device, an input corresponding to a request to display energy usage data; and in response to detecting the input corresponding to the request to display energy usage data: in accordance with a determination that a first set of one or more criteria is satisfied, displaying, via the display generation component, a first representation of energy usage data corresponding to a first energy account of a first energy provider, wherein the first representation of energy usage data includes an indication of a first amount of energy used in a first time period; and in accordance with a determination that a second set of one or more criteria, different from the first set of one or more criteria, is satisfied, displaying, via the display component, a second representation of energy usage data corresponding to a second energy account, different from the first energy account, of a second energy provider, different from the first energy provider, wherein the second representation of energy usage data includes an indication of a second amount of energy used in a second time period.

In some embodiments, a transitory computer-readable storage medium storing one or more programs configured to be executed by one or more processors of a computer system that is in communication with a display generation component and an input device is described. In some embodiments, the one or more programs includes instructions for: detecting, via the input device, an input corresponding to a request to display energy usage data; and in response to detecting the input corresponding to the request to display energy usage data: in accordance with a determination that a first set of one or more criteria is satisfied, displaying, via the display generation component, a first representation of energy usage data corresponding to a first energy account of a first energy provider, wherein the first representation of energy usage data includes an indication of a first amount of energy used in a first time period; and in accordance with a determination that a second set of one or more criteria, different from the first set of one or more criteria, is satisfied, displaying, via the display component, a second representation of energy usage data corresponding to a second energy account, different from the first energy account, of a second energy provider, different from the first energy provider, wherein the second representation of energy usage data includes an indication of a second amount of energy used in a second time period.

In some embodiments, a computer system configured to communicate with a display generation component and an input device is described. In some embodiments, the computer system comprises one or more processors and memory storing one or more programs configured to be executed by the one or more processors. In some embodiments, the one or more programs includes instructions for: detecting, via the input device, an input corresponding to a request to display energy usage data; and in response to detecting the input corresponding to the request to display energy usage data: in accordance with a determination that a first set of one or more criteria is satisfied, displaying, via the display generation component, a first representation of energy usage data corresponding to a first energy account of a first energy provider, wherein the first representation of energy usage data includes an indication of a first amount of energy used in a first time period; and in accordance with a determination that a second set of one or more criteria, different from the first set of one or more criteria, is satisfied, displaying, via the display component, a second representation of energy usage data corresponding to a second energy account, different from the first energy account, of a second energy provider, different from the first energy provider, wherein the second representation of energy usage data includes an indication of a second amount of energy used in a second time period.

In some embodiments, a computer system configured to communicate with a display generation component and an input device is described. In some embodiments, the computer system comprises means for performing each of the following steps: detecting, via the input device, an input corresponding to a request to display energy usage data; and in response to detecting the input corresponding to the request to display energy usage data: in accordance with a determination that a first set of one or more criteria is satisfied, displaying, via the display generation component, a first representation of energy usage data corresponding to a first energy account of a first energy provider, wherein the first representation of energy usage data includes an indication of a first amount of energy used in a first time period; and in accordance with a determination that a second set of one or more criteria, different from the first set of one or more criteria, is satisfied, displaying, via the display component, a second representation of energy usage data corresponding to a second energy account, different from the first energy account, of a second energy provider, different from the first energy provider, wherein the second representation of energy usage data includes an indication of a second amount of energy used in a second time period.

In some embodiments, a computer program product is described. In some embodiments, the computer program product comprises one or more programs configured to be executed by one or more processors of a computer system that is in communication with a display generation component and an input device. In some embodiments, the one or more programs include instructions for: detecting, via the input device, an input corresponding to a request to display energy usage data; and in response to detecting the input corresponding to the request to display energy usage data: in accordance with a determination that a first set of one or more criteria is satisfied, displaying, via the display generation component, a first representation of energy usage data corresponding to a first energy account of a first energy provider, wherein the first representation of energy usage data includes an indication of a first amount of energy used in a first time period; and in accordance with a determination that a second set of one or more criteria, different from the first set of one or more criteria, is satisfied, displaying, via the display component, a second representation of energy usage data corresponding to a second energy account, different from the first energy account, of a second energy provider, different from the first energy provider, wherein the second representation of energy usage data includes an indication of a second amount of energy used in a second time period.

In some embodiments, a method that is performed at a computer system that is in communication with an input device and an output device is described. In some embodiments, the method comprises: detecting, via the input device, an input corresponding to a respective time period type; and in response to detecting the input corresponding to the respective time period type: in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

In some embodiments, a non-transitory computer-readable storage medium storing one or more programs configured to be executed by one or more processors of a computer system that is in communication with an input device and an output device is described. In some embodiments, the one or more programs includes instructions for: detecting, via the input device, an input corresponding to a respective time period type; and in response to detecting the input corresponding to the respective time period type: in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

In some embodiments, a transitory computer-readable storage medium storing one or more programs configured to be executed by one or more processors of a computer system that is in communication with an input device and an output device is described. In some embodiments, the one or more programs includes instructions for: detecting, via the input device, an input corresponding to a respective time period type; and in response to detecting the input corresponding to the respective time period type: in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

In some embodiments, a computer system configured to communicate with an input device and an output device is described. In some embodiments, the computer system comprises one or more processors and memory storing one or more programs configured to be executed by the one or more processors. In some embodiments, the one or more programs includes instructions for: detecting, via the input device, an input corresponding to a respective time period type; and in response to detecting the input corresponding to the respective time period type: in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

In some embodiments, a computer system configured to communicate with an input device and an output device is described. In some embodiments, the computer system comprises means for performing each of the following steps: detecting, via the input device, an input corresponding to a respective time period type; and in response to detecting the input corresponding to the respective time period type: in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

In some embodiments, a computer program product is described. In some embodiments, the computer program product comprises one or more programs configured to be executed by one or more processors of a computer system that is in communication with an input device and an output device. In some embodiments, the one or more programs include instructions for: detecting, via the input device, an input corresponding to a respective time period type; and in response to detecting the input corresponding to the respective time period type: in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

In some embodiments, a method that is performed at a computer system that is in communication with an input device and an output device is described. In some embodiments, the method comprises: detecting, via the input device, an input corresponding to a request to output current data; and in response to detecting the input corresponding to the request to output current data: in accordance with a determination that a current time period is not associated with data, outputting, via the output device, an indication of data for a preceding time period; and in accordance with a determination that the current time period is associated with data, outputting, via the output device, an indication of data for the current time period without outputting the indication of data for the preceding time period.

In some embodiments, a non-transitory computer-readable storage medium storing one or more programs configured to be executed by one or more processors of a computer system that is in communication with an input device and an output device is described. In some embodiments, the one or more programs includes instructions for: detecting, via the input device, an input corresponding to a request to output current data; and in response to detecting the input corresponding to the request to output current data: in accordance with a determination that a current time period is not associated with data, outputting, via the output device, an indication of data for a preceding time period; and in accordance with a determination that the current time period is associated with data, outputting, via the output device, an indication of data for the current time period without outputting the indication of data for the preceding time period.

In some embodiments, a transitory computer-readable storage medium storing one or more programs configured to be executed by one or more processors of a computer system that is in communication with an input device and an output device is described. In some embodiments, the one or more programs includes instructions for: detecting, via the input device, an input corresponding to a request to output current data; and in response to detecting the input corresponding to the request to output current data: in accordance with a determination that a current time period is not associated with data, outputting, via the output device, an indication of data for a preceding time period; and in accordance with a determination that the current time period is associated with data, outputting, via the output device, an indication of data for the current time period without outputting the indication of data for the preceding time period.

In some embodiments, a computer system configured to communicate with an input device and an output device is described. In some embodiments, the computer system comprises one or more processors and memory storing one or more programs configured to be executed by the one or more processors. In some embodiments, the one or more programs includes instructions for: detecting, via the input device, an input corresponding to a request to output current data; and in response to detecting the input corresponding to the request to output current data: in accordance with a determination that a current time period is not associated with data, outputting, via the output device, an indication of data for a preceding time period; and in accordance with a determination that the current time period is associated with data, outputting, via the output device, an indication of data for the current time period without outputting the indication of data for the preceding time period.

In some embodiments, a computer system configured to communicate with an input device and an output device is described. In some embodiments, the computer system comprises means for performing each of the following steps: detecting, via the input device, an input corresponding to a request to output current data; and in response to detecting the input corresponding to the request to output current data: in accordance with a determination that a current time period is not associated with data, outputting, via the output device, an indication of data for a preceding time period; and in accordance with a determination that the current time period is associated with data, outputting, via the output device, an indication of data for the current time period without outputting the indication of data for the preceding time period.

In some embodiments, a computer program product is described. In some embodiments, the computer program product comprises one or more programs configured to be executed by one or more processors of a computer system that is in communication with an input device and an output device. In some embodiments, the one or more programs include instructions for: detecting, via the input device, an input corresponding to a request to output current data; and in response to detecting the input corresponding to the request to output current data: in accordance with a determination that a current time period is not associated with data, outputting, via the output device, an indication of data for a preceding time period; and in accordance with a determination that the current time period is associated with data, outputting, via the output device, an indication of data for the current time period without outputting the indication of data for the preceding time period.

In some embodiments, a method that is performed at a computer system that is in communication with an input device and an output device is described. In some embodiments, the method comprises: detecting, via the input device, an input corresponding to a request to output data for a first time period; and in response to detecting the input corresponding to the request to output data for the first time period: in accordance with a determination that a subset of multiple subsets of the data for the first time period includes a negative value, outputting, via the output device, a comparison of the data for the first time period relative to a second time period, different from the first time period, as an amount; and in accordance with a determination that a subset of multiple subsets of the data for the first time period does not include a negative value, outputting, via the output device, the comparison of the data for the first time period relative to the second time period as a percentage.

In some embodiments, a non-transitory computer-readable storage medium storing one or more programs configured to be executed by one or more processors of a computer system that is in communication with an input device and an output device is described. In some embodiments, the one or more programs includes instructions for: detecting, via the input device, an input corresponding to a request to output data for a first time period; and in response to detecting the input corresponding to the request to output data for the first time period: in accordance with a determination that a subset of multiple subsets of the data for the first time period includes a negative value, outputting, via the output device, a comparison of the data for the first time period relative to a second time period, different from the first time period, as an amount; and in accordance with a determination that a subset of multiple subsets of the data for the first time period does not include a negative value, outputting, via the output device, the comparison of the data for the first time period relative to the second time period as a percentage.

In some embodiments, a transitory computer-readable storage medium storing one or more programs configured to be executed by one or more processors of a computer system that is in communication with an input device and an output device is described. In some embodiments, the one or more programs includes instructions for: detecting, via the input device, an input corresponding to a request to output data for a first time period; and in response to detecting the input corresponding to the request to output data for the first time period: in accordance with a determination that a subset of multiple subsets of the data for the first time period includes a negative value, outputting, via the output device, a comparison of the data for the first time period relative to a second time period, different from the first time period, as an amount; and in accordance with a determination that a subset of multiple subsets of the data for the first time period does not include a negative value, outputting, via the output device, the comparison of the data for the first time period relative to the second time period as a percentage.

In some embodiments, a computer system configured to communicate with an input device and an output device is described. In some embodiments, the computer system comprises one or more processors and memory storing one or more programs configured to be executed by the one or more processors. In some embodiments, the one or more programs includes instructions for: detecting, via the input device, an input corresponding to a request to output data for a first time period; and in response to detecting the input corresponding to the request to output data for the first time period: in accordance with a determination that a subset of multiple subsets of the data for the first time period includes a negative value, outputting, via the output device, a comparison of the data for the first time period relative to a second time period, different from the first time period, as an amount; and in accordance with a determination that a subset of multiple subsets of the data for the first time period does not include a negative value, outputting, via the output device, the comparison of the data for the first time period relative to the second time period as a percentage.

In some embodiments, a computer system configured to communicate with an input device and an output device is described. In some embodiments, the computer system comprises means for performing each of the following steps: detecting, via the input device, an input corresponding to a request to output data for a first time period; and in response to detecting the input corresponding to the request to output data for the first time period: in accordance with a determination that a subset of multiple subsets of the data for the first time period includes a negative value, outputting, via the output device, a comparison of the data for the first time period relative to a second time period, different from the first time period, as an amount; and in accordance with a determination that a subset of multiple subsets of the data for the first time period does not include a negative value, outputting, via the output device, the comparison of the data for the first time period relative to the second time period as a percentage.

In some embodiments, a computer program product is described. In some embodiments, the computer program product comprises one or more programs configured to be executed by one or more processors of a computer system that is in communication with an input device and an output device. In some embodiments, the one or more programs include instructions for: detecting, via the input device, an input corresponding to a request to output data for a first time period; and in response to detecting the input corresponding to the request to output data for the first time period: in accordance with a determination that a subset of multiple subsets of the data for the first time period includes a negative value, outputting, via the output device, a comparison of the data for the first time period relative to a second time period, different from the first time period, as an amount; and in accordance with a determination that a subset of multiple subsets of the data for the first time period does not include a negative value, outputting, via the output device, the comparison of the data for the first time period relative to the second time period as a percentage.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing data, thereby increasing the effectiveness, efficiency, and user satisfaction with such devices. Such methods and interfaces may complement or replace other methods for managing data.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AC illustrate exemplary user interfaces for outputting energy usage data associated with an energy account in accordance with some embodiments.

FIG. 7 is a flow diagram illustrating a method for connecting to an energy account of an energy provider in accordance with some embodiments.

FIG. 8 is a flow diagram illustrating a method for outputting different types of comparisons for different time periods in accordance with some embodiments.

FIG. 9 is a flow diagram illustrating a method for outputting data when data is not complete in accordance with some embodiments.

FIG. 10 is a flow diagram illustrating a method for outputting comparison data of different types in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing data. For example, different representations of energy usage can be displayed depending on which energy account is connected. By further example, different types of comparisons can be output for different time period types. By further example, different information can be output based on whether complete data for a given time period is available. By further example, the comparisons can be presented in different ways depending on the values associated with the time periods being compared. Such techniques can reduce the cognitive burden on a user who accesses usage data, thereby enhancing productivity. Further, such techniques can reduce processor and battery power otherwise wasted on redundant user inputs.

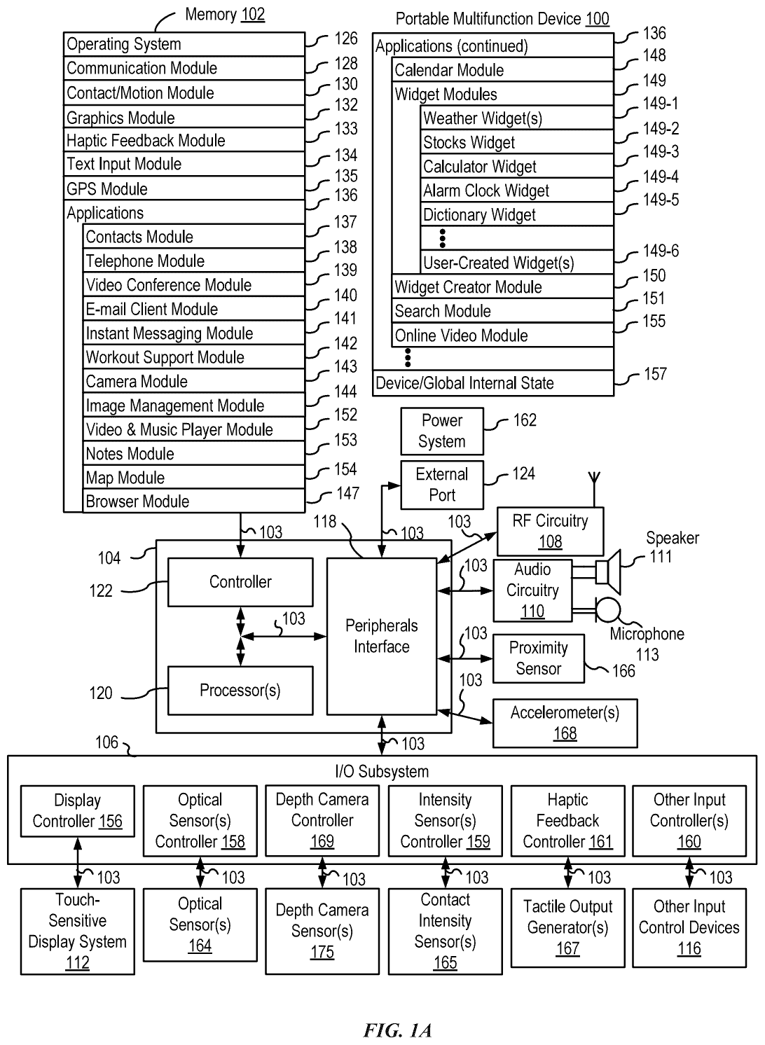

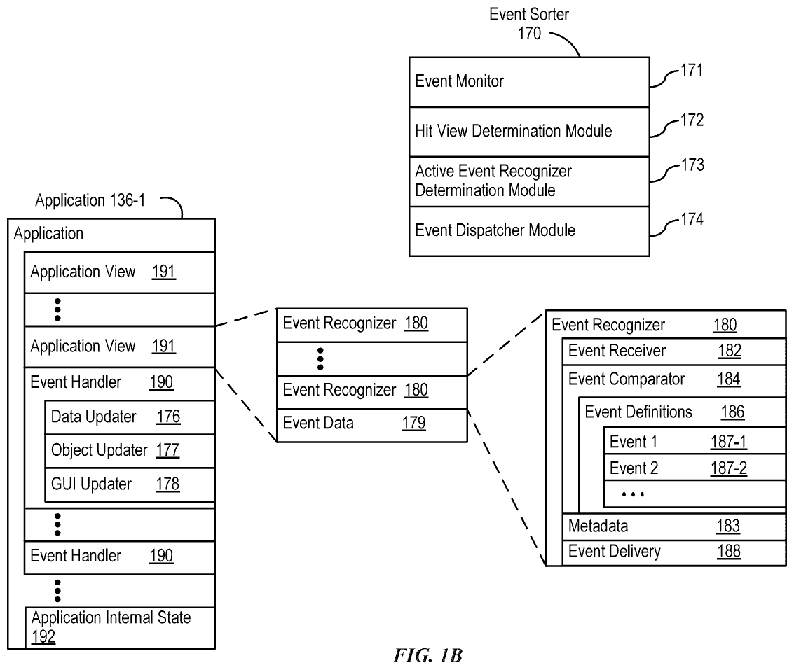

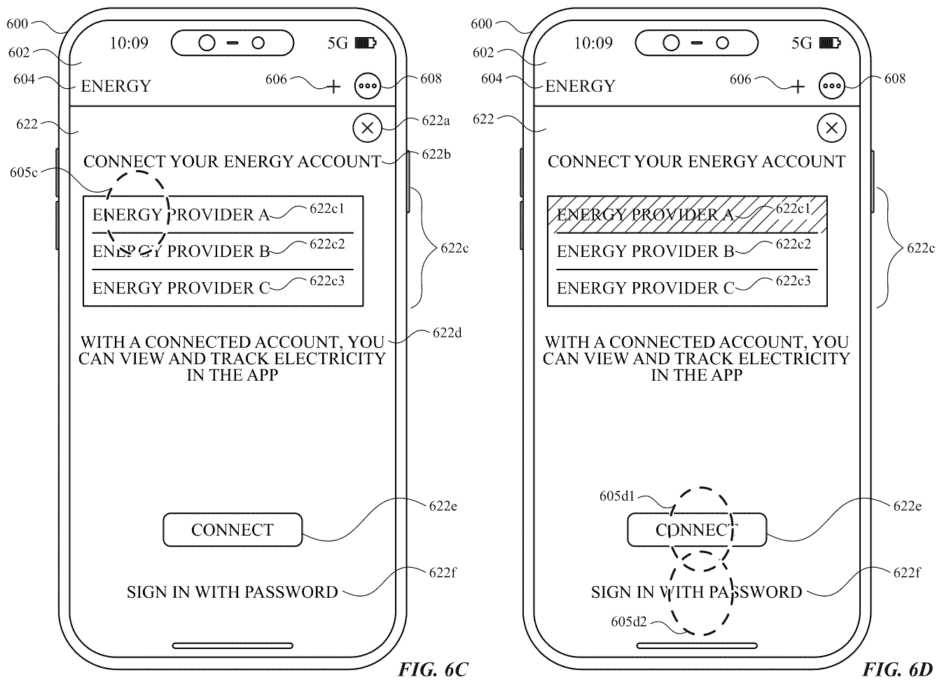

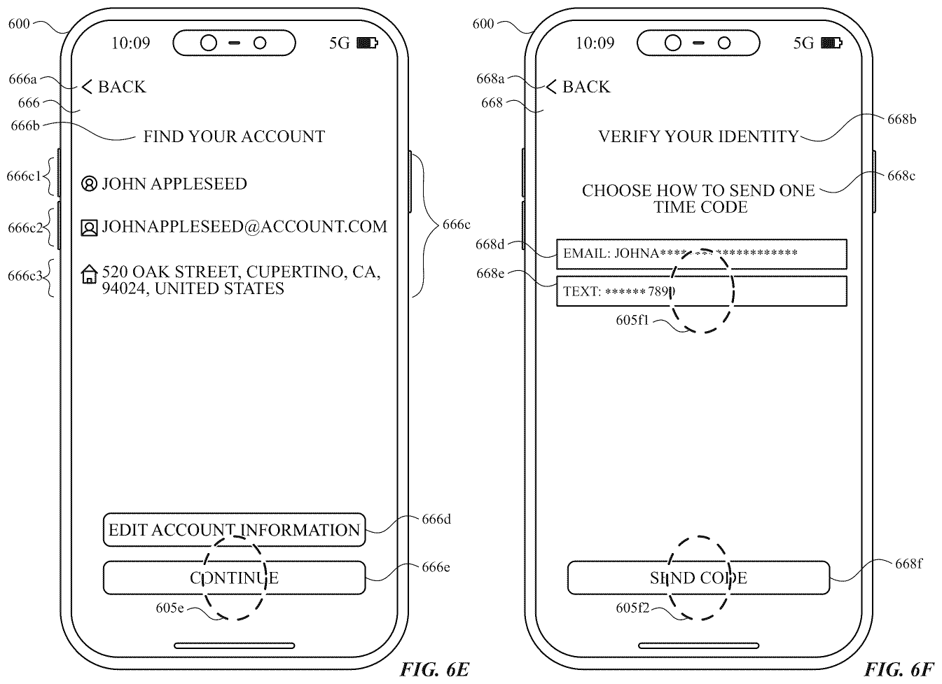

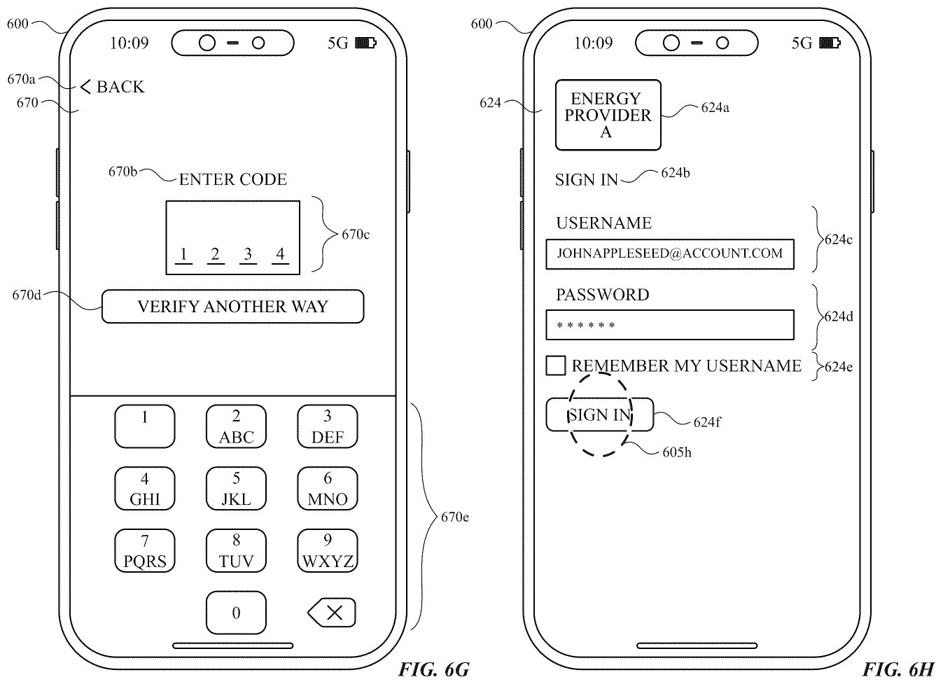

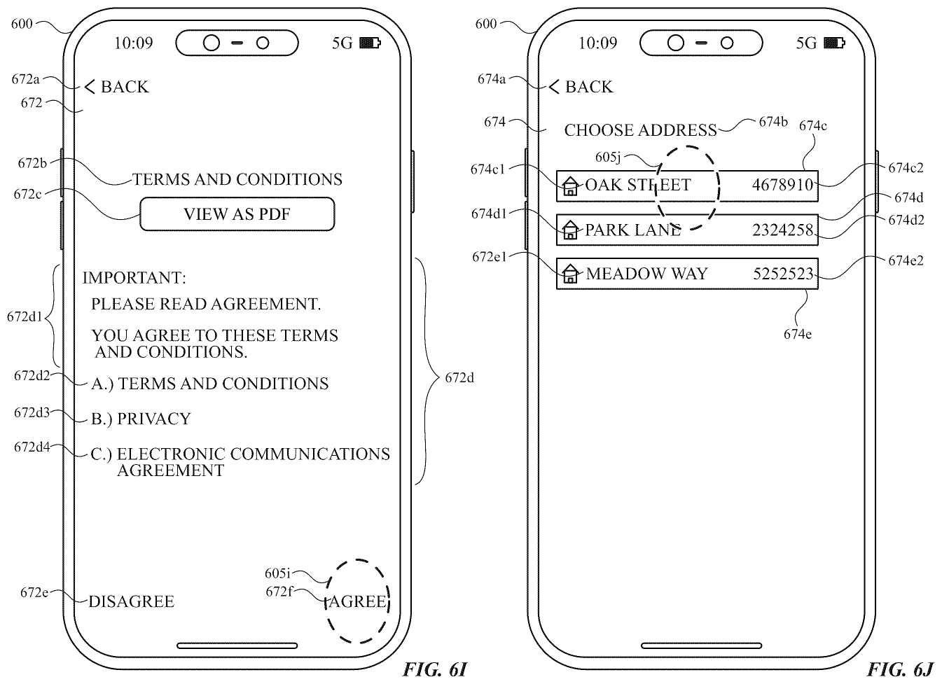

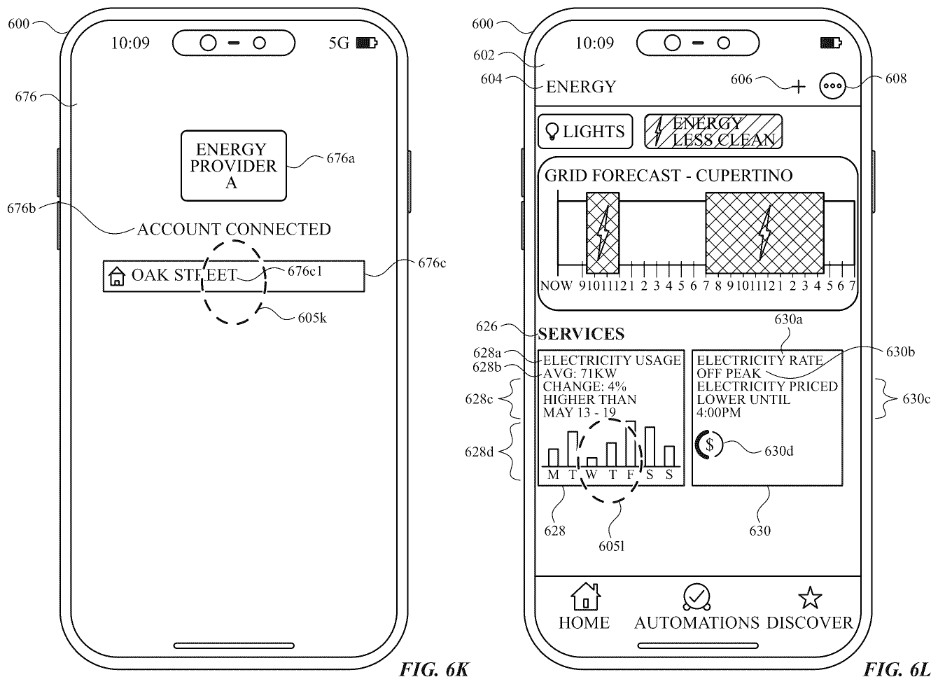

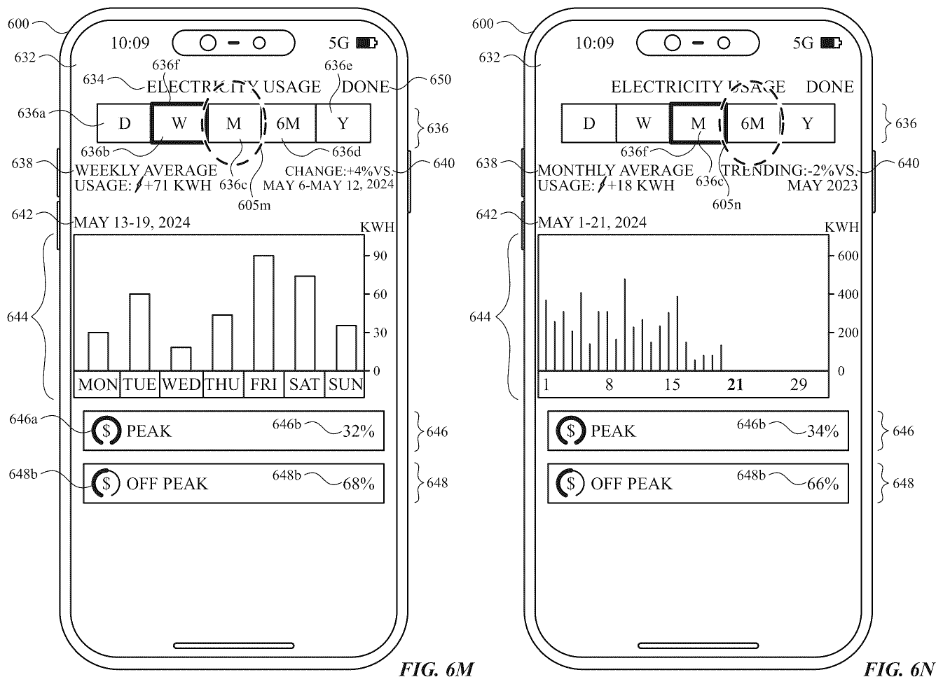

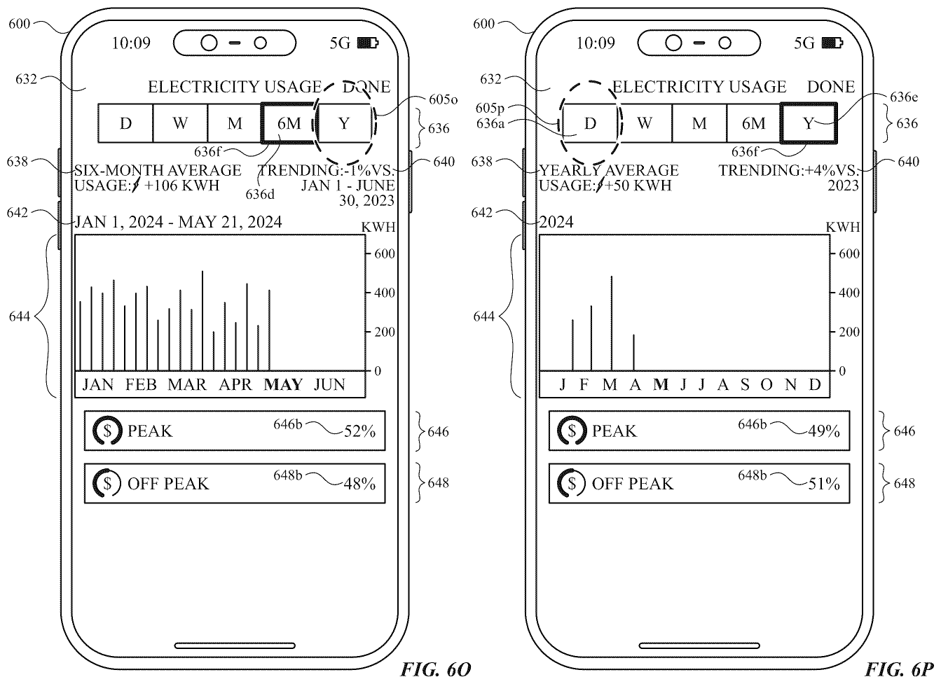

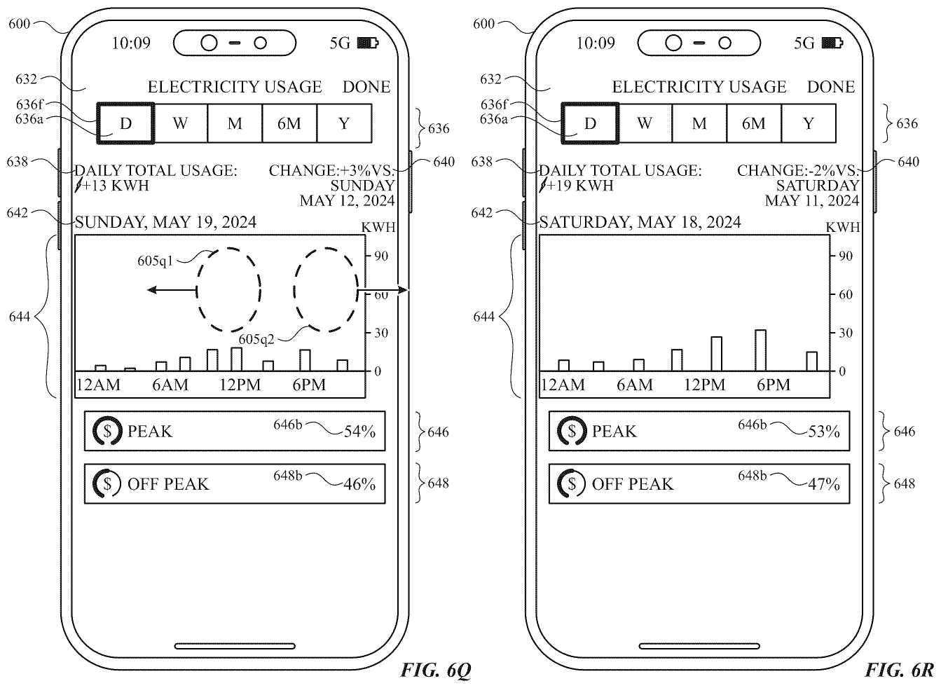

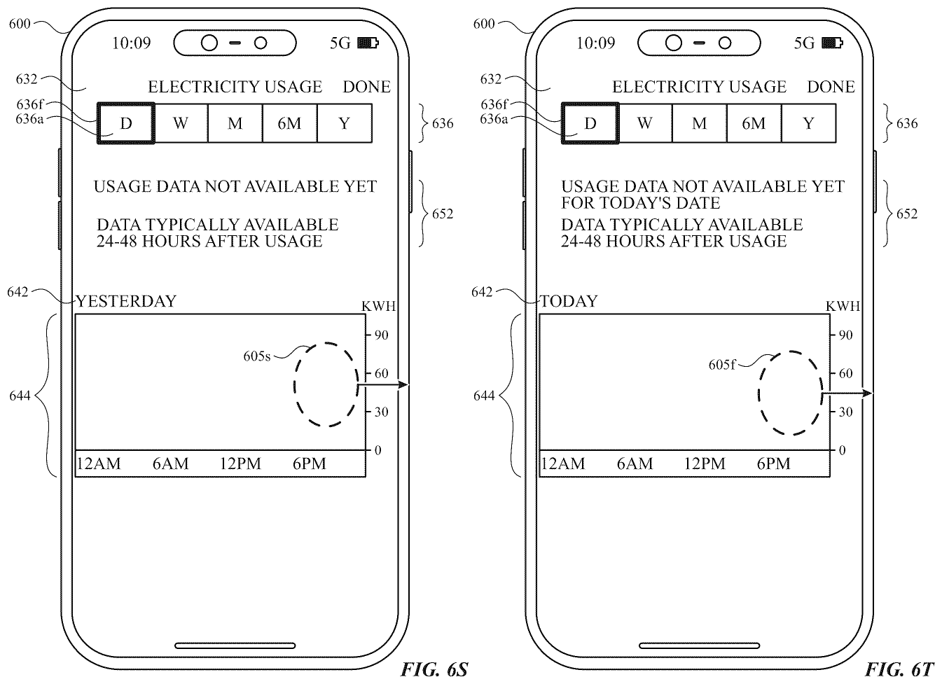

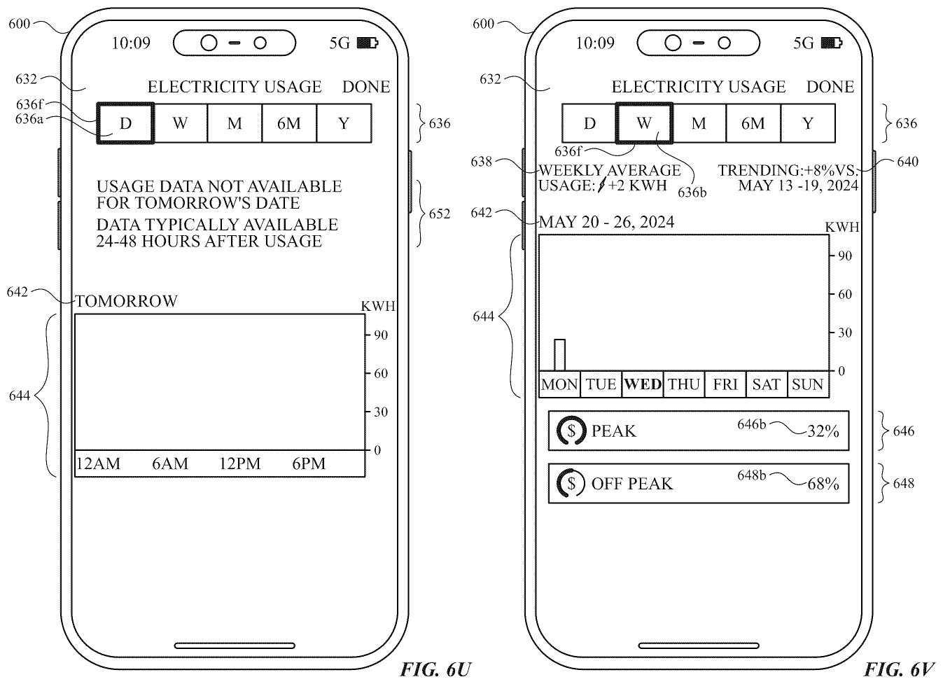

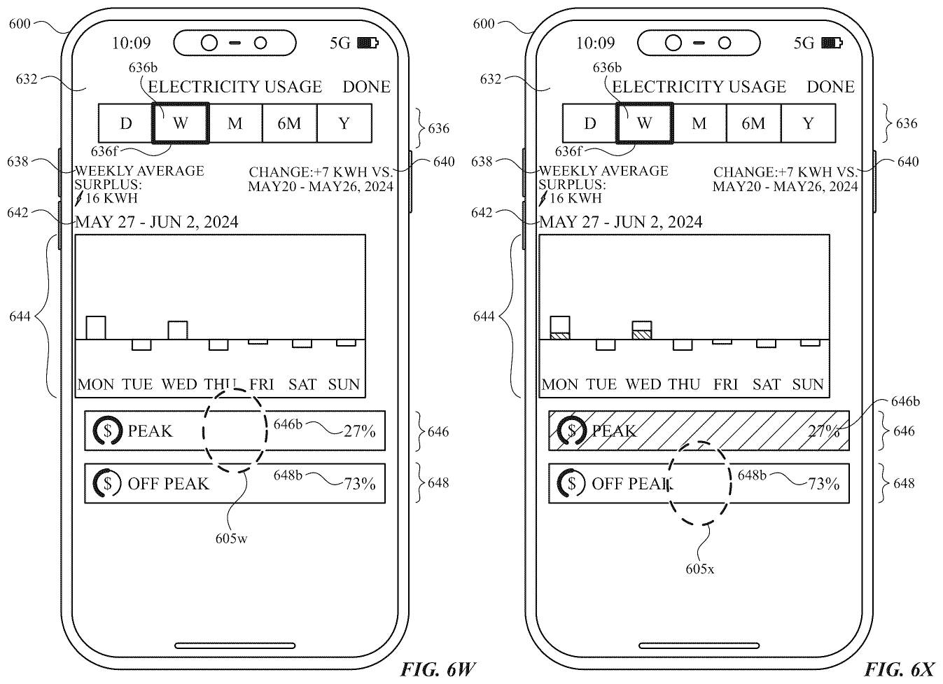

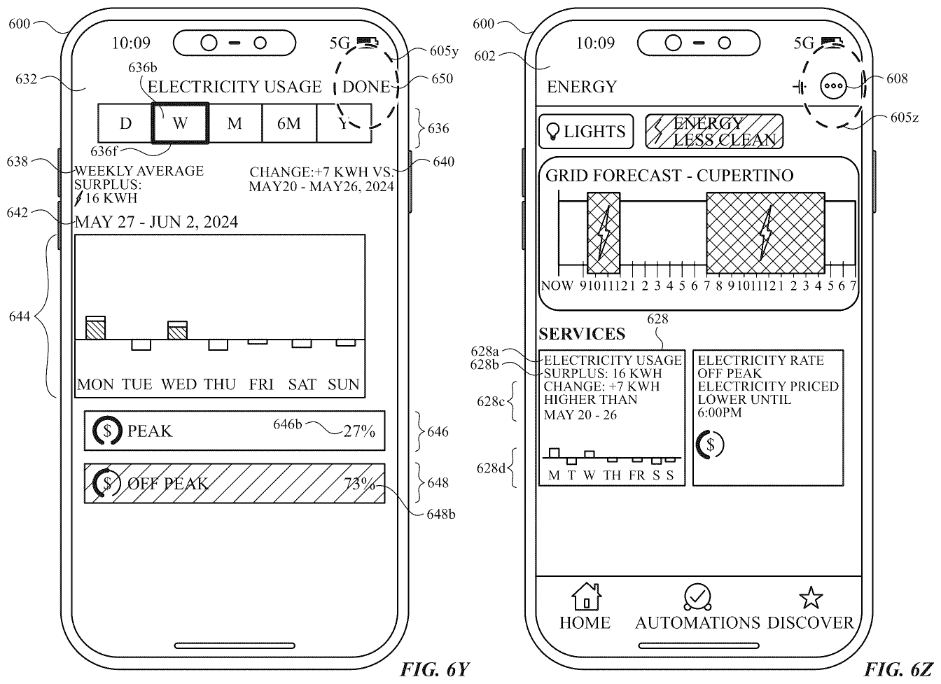

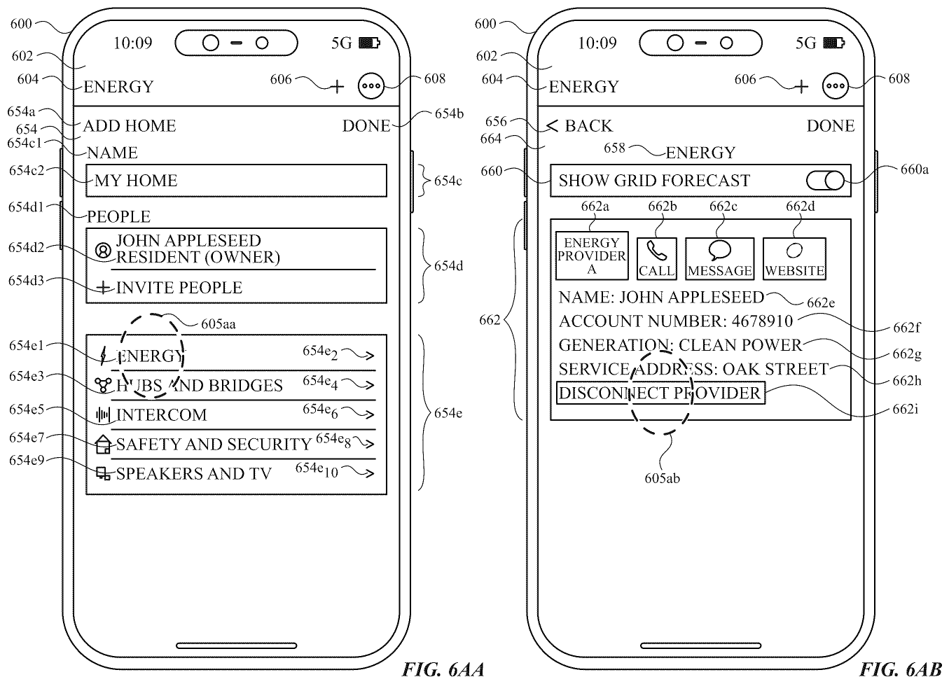

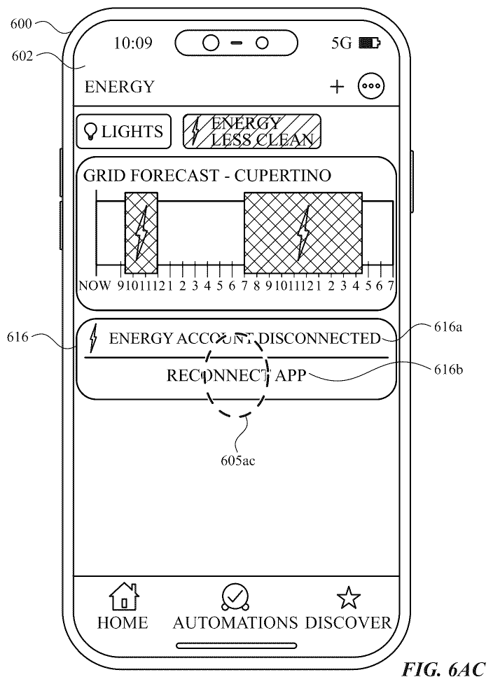

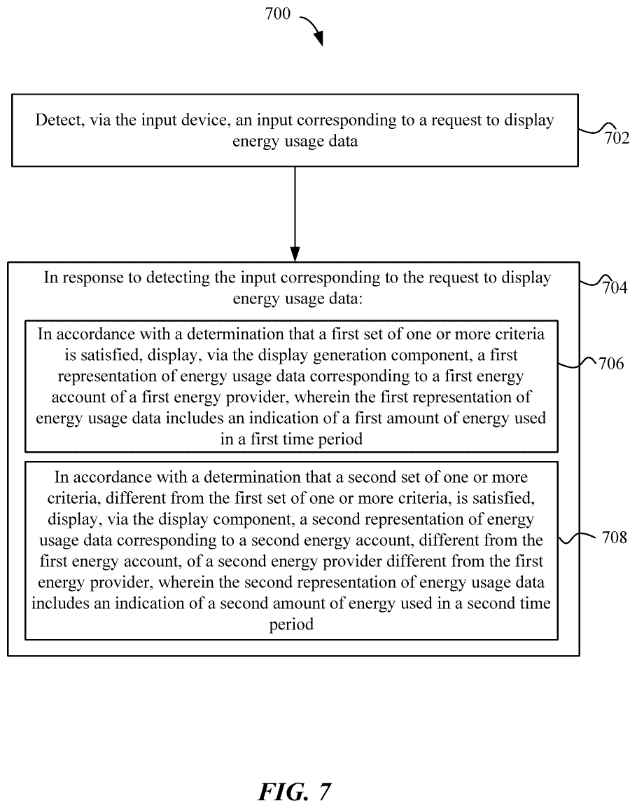

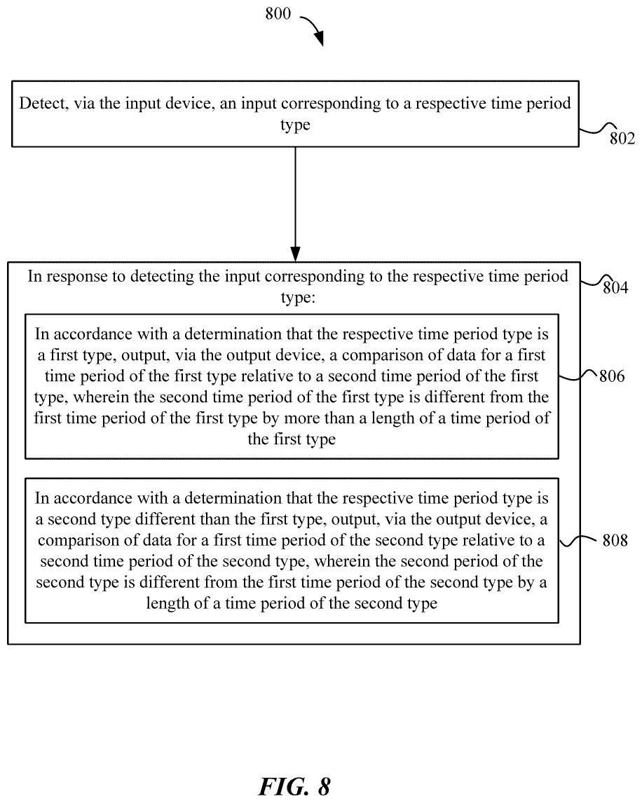

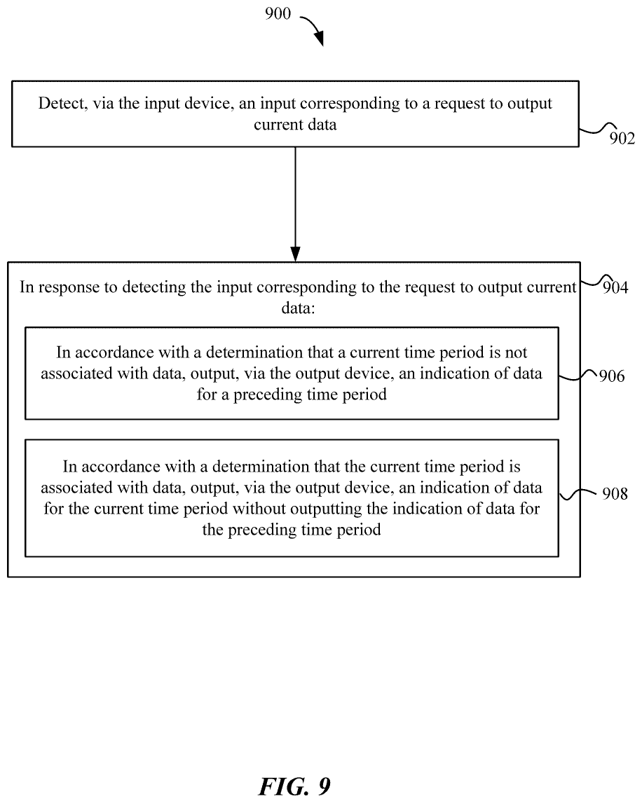

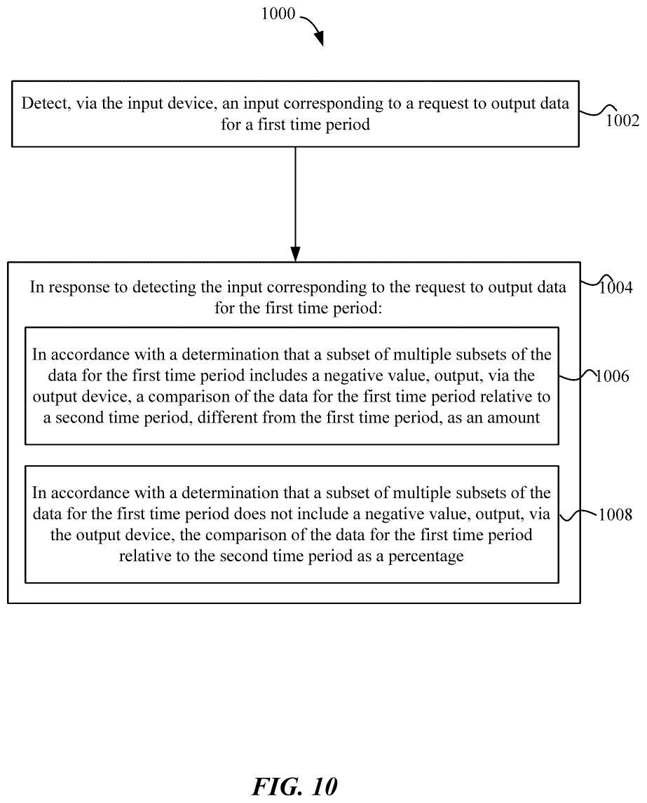

Below, FIGS. 1A-1B, 2, 3, 4A-4B, and 5A-5B provide a description of exemplary devices for performing the techniques for managing data. FIGS. 6A-6AC illustrate exemplary user interfaces for outputting energy usage data associated with an energy account in accordance with some embodiments. FIG. 7 is a flow diagram illustrating a method for connecting to an energy account of an energy provider in accordance with some embodiments. The user interfaces in FIGS. 6A-6K and 6Z-6AC are used to illustrate the processes described below, including the processes in FIG. 7. FIG. 8 is a flow diagram illustrating a method for outputting different types of comparisons for different time periods in accordance with some embodiments. The user interfaces in FIGS. 6L-6R and 6V-6Y are used to illustrate the processes described below, including the processes in FIG. 8. FIG. 9 is a flow diagram illustrating a method for outputting data when data is not complete in accordance with some embodiments. The user interfaces in FIGS. 6L-6Y are used to illustrate the processes described below, including the processes in FIG. 9. FIG. 10 is a flow diagram illustrating a method for outputting comparison data of different types in accordance with some embodiments. The user interfaces in FIGS. 6W-6Y are used to illustrate the processes described below, including the processes in FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

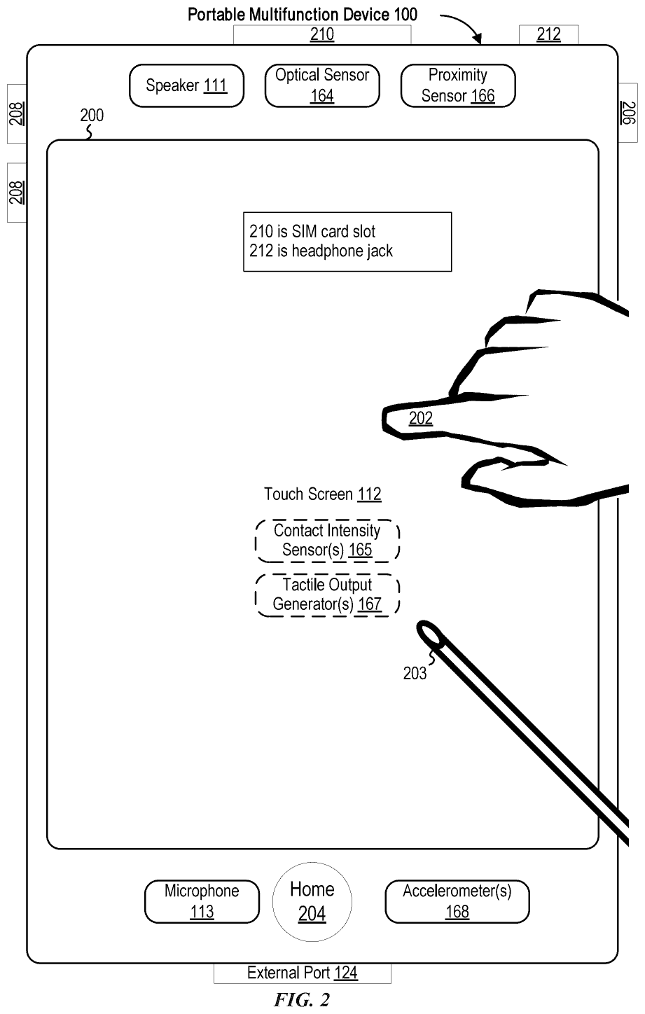

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

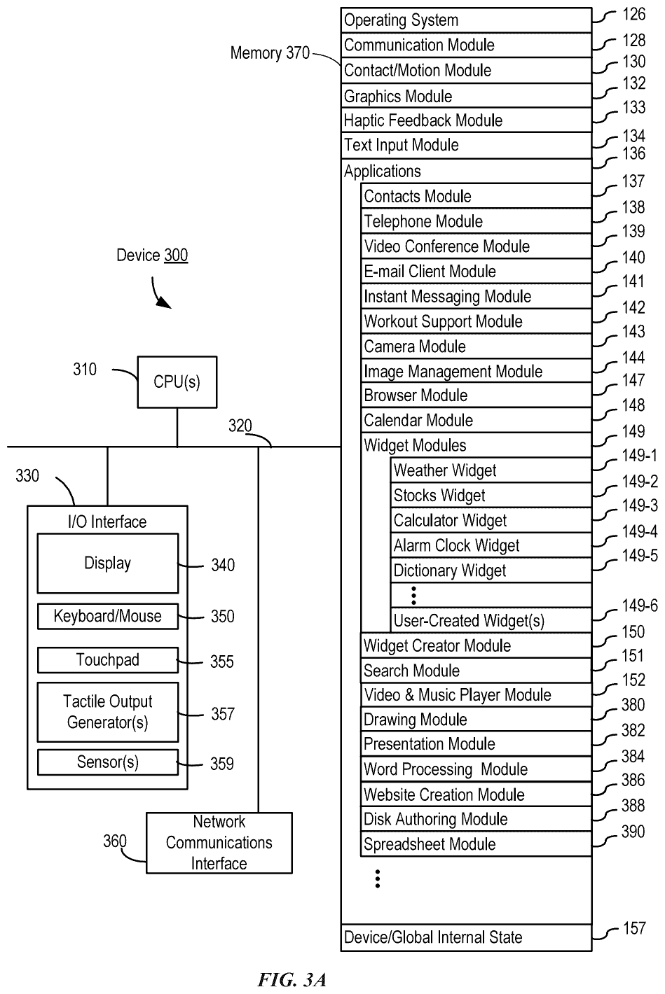

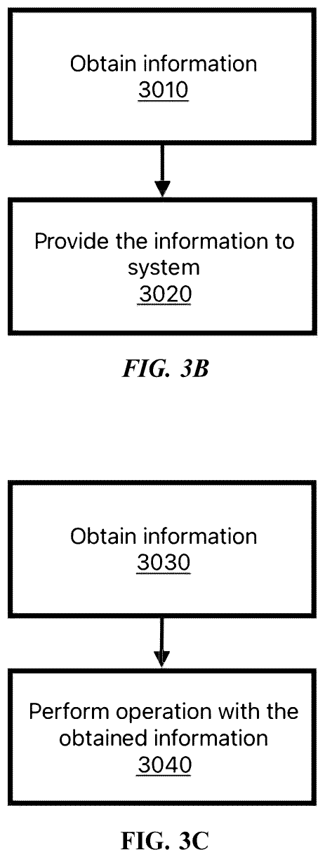

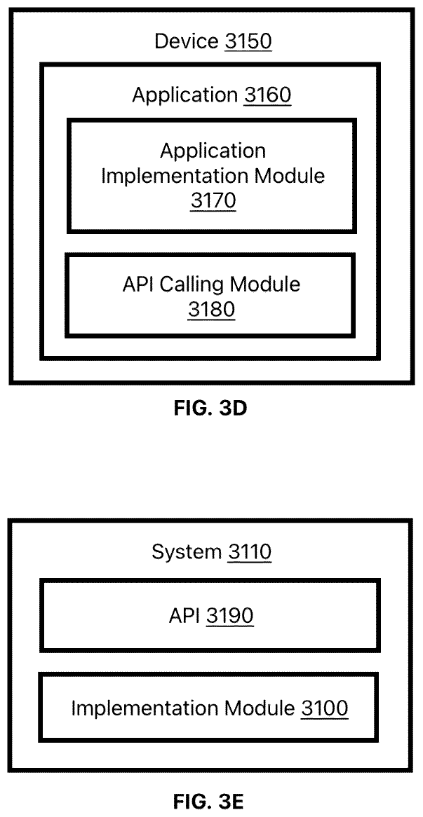

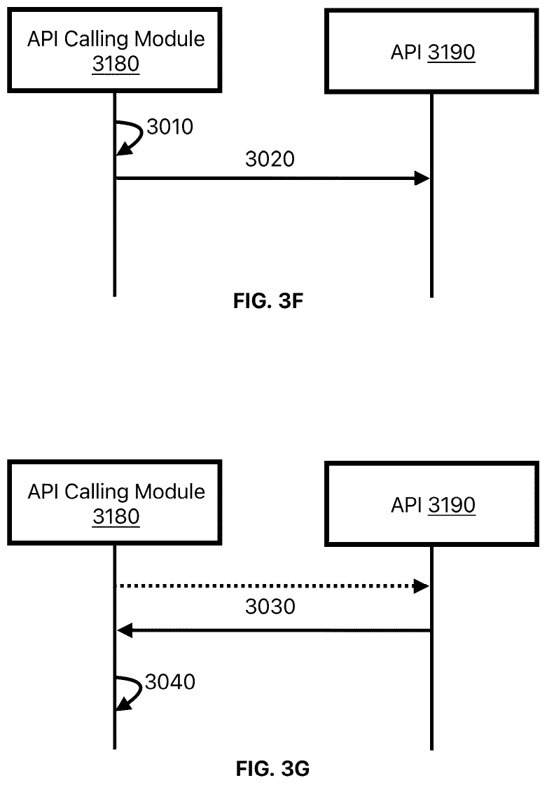

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection (e.g., with an accessory), a device detection API (e.g., for locating nearby devices (e.g., media devices and/or smartphone)), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700-1000 (FIG. 7-10) method by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by AP I-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

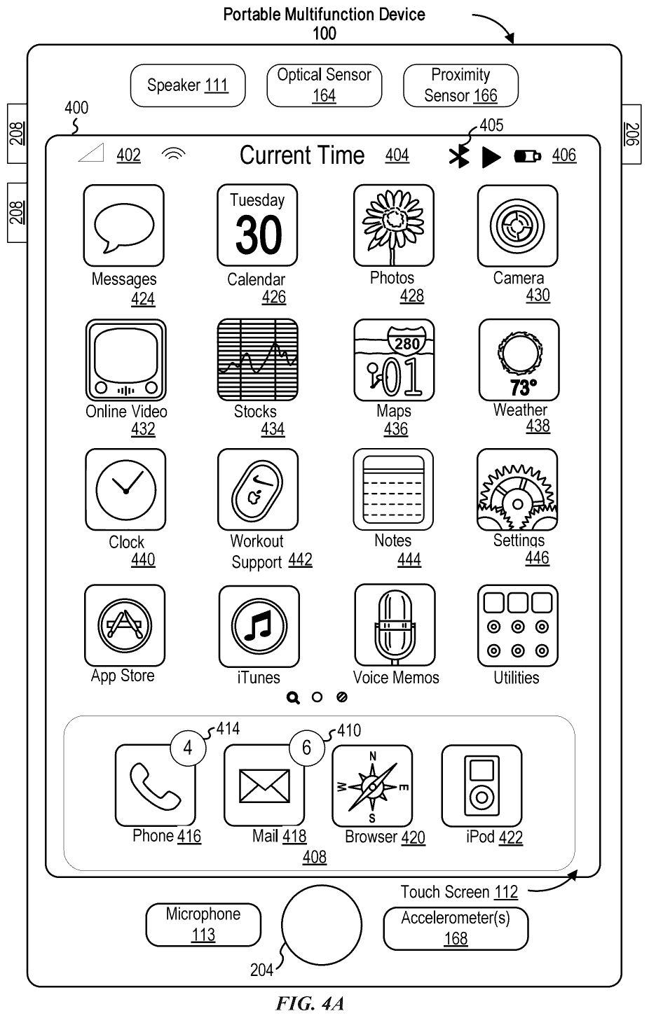

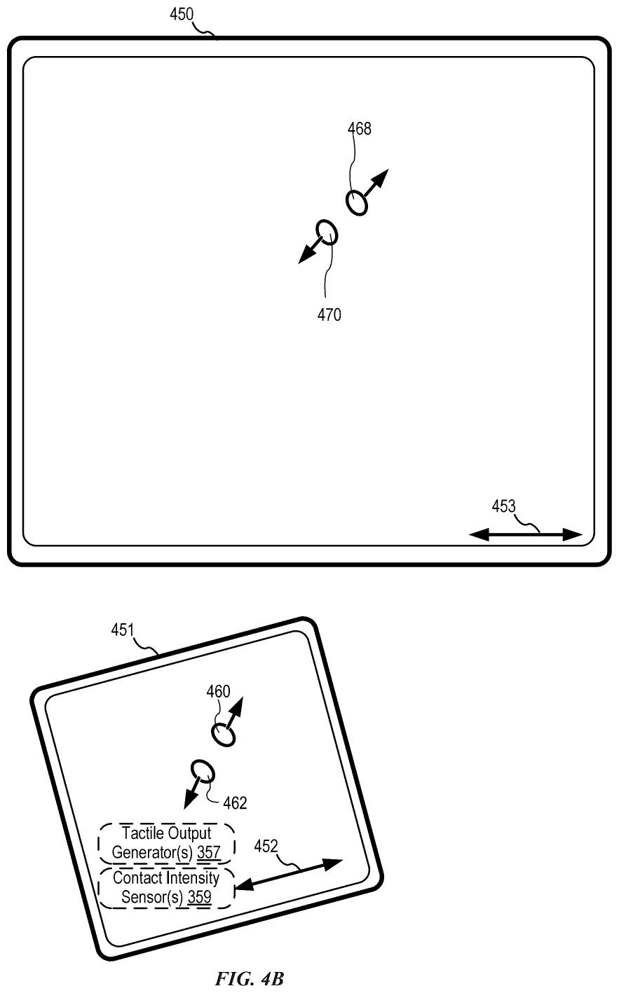

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

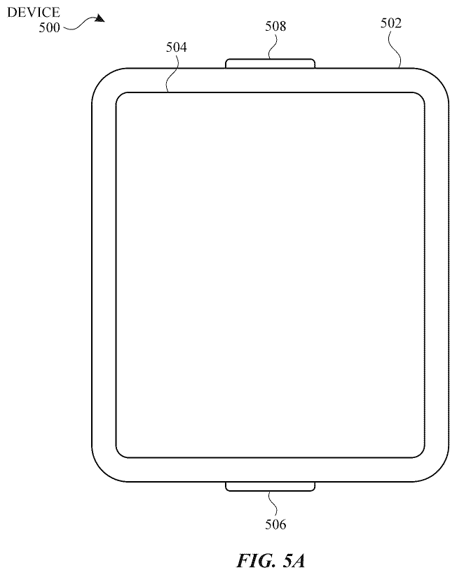

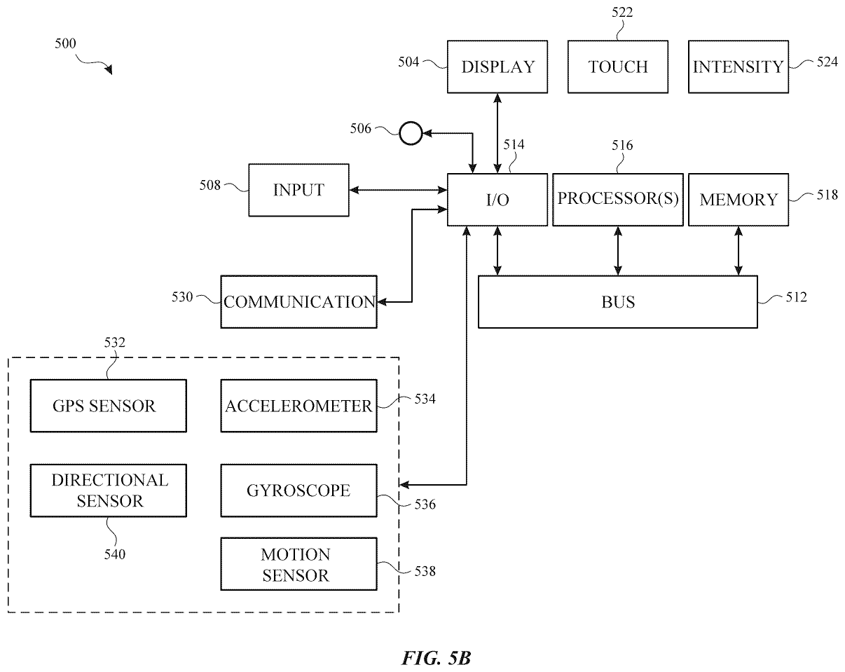

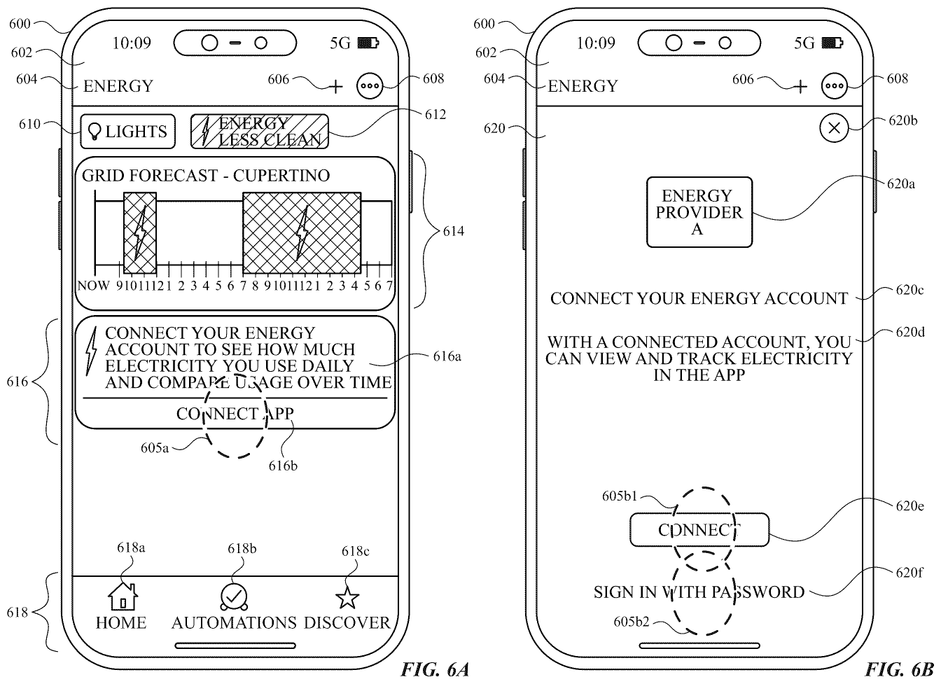

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including methods 700, 800, 900, and 1000 (FIGS. 7, 8, 9, and 10). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6AC illustrate exemplary user interfaces for managing energy usage data associated with an energy account in accordance with some embodiments. The user interfaces in these figures are used to illustrate the processes described below, including the processes in FIGS. 7-10.

FIGS. 6A-6AC illustrate computer system 600 as a smart phone. It should be recognized that computer system 600 can be another type of computer system, such as a smart watch, a tablet, a laptop, a desktop, a communal device, a smart speaker, an accessory, a personal gaming system, a laptop computer, a fitness tracking device, and/or a head-mounted display (HMD) device.

FIGS. 6A-6K illustrate exemplary user interfaces for connecting to an energy account of an energy provider in accordance with some embodiments. The user interfaces in these figures are used to illustrate the processes described below, including the processes in FIG. 7.

FIGS. 6A-6K illustrate a process where computer system 600 connects to an energy account. Connecting to an energy account can allow computer system 600 to display data regarding energy usage. In some embodiments, an energy account is created with an external energy provider and corresponds to an energy grid based on a location of a home, an apartment, an office, a hotel, and/or other type of location connected to the energy grid.

As illustrated in FIG. 6A, computer system 600 displays user interface 602 (e.g., a landing page corresponding to a home application). In some embodiments, computer system 600 displays user interface 602 in response to detecting an input directed to an icon for a home application within a home screen and/or a list of application. In some embodiments, the home application is an application that can be connected with (e.g., tied to, assigned to, and/or linked to) a physical address (e.g., a house, an apartment, an office, a hotel, and/or another type of location) and/or a set of one or more accessory devices. When connected with the physical address and/or the set of one or more accessory devices, computer system 600 displays, via one or more user interfaces of the home application, management controls that allow a user to view, interact with and/or manage the connected physical address through use of the set of one or more accessory devices, external data, and/or automated systems. It should be recognized that user interface 602 can be navigated to in other ways, such as a voice request to display user interface 602 and/or different sets of inputs.

As illustrated in FIG. 6A, user interface 602 includes title indicator 604 (e.g., “Energy”), add control 606, settings control 608, lights control 610, energy control 612, energy forecast 614, connection control 616, and control region 618. It should be recognized that more, fewer, and/or different elements can be included in user interface 602.

In some embodiments, in response to detecting an input directed to add control 606, computer system 600 displays an add user interface (e.g., a user interface that includes options to allow a user to add accessories, rooms, and/or new physical addresses). In some embodiments, in response to detecting an input directed to settings control 608, computer system 600 displays a settings user interface (e.g., a user interface that includes options to allow a user to view settings for their physical address and/or for rooms in their physical address). In some embodiments, in response to detecting an input directed to lights control 610, computer system 600 displays a lighting user interface (e.g., a user interface that includes controls for lighting withing a connected physical address). In some embodiments, in response to detecting an input directed to energy control 612, computer system 600 displays and/or maintains display of an energy user interface (e.g., user interface 602). As illustrated in FIG. 6A by the hashing, energy control 612 is selected, indicating that the energy user interface is currently being displayed.

As illustrated in FIG. 6A, control region 618 includes home control 618a, automation control 618b, and discover control 618c. In some embodiments, in response to detecting an input directed to home control 618a, computer system 600 displays a home landing page (e.g., user interface 602). In some embodiments, in response to detecting an input directed to automation control 618b, computer system 600 displays an automation landing page (e.g., a user interface for creating automations). In some embodiments, in response to detecting an input directed to discover control 618c, computer system 600 displays a discover landing page (e.g., a user interface for discovering features of the home application).

In some embodiments, energy forecast 614 indicates whether and/or when there will be one or more any clean energy periods that correspond to an energy grid based on a current location of computer system 600 or a default location of the home application. In some embodiments, computer system 600 displays one or more indications of clean energy periods in response to receiving information from an external source (e.g., the internet, a weather application, and/or another application).

As illustrated in FIG. 6A, connection control 616 includes text indicator 616a (e.g., “Connect your energy account to see how much electricity you use daily and compare usage over time”) and text indicator 616b (e.g., “Connect app”). In some embodiments, connection control 616 is included in user interface 602 when an energy provider supports one or more features described below for a current location of computer system 600 and/or a home location configured for the home application. For example, connection control 616 is included in user interface 602 when the current location of computer system 600 is a location that receives energy from at least one energy provider that supports one or more featured described below. In such an example, connection control 616 is not included in user interface 602 when the current location of computer system 600 is a location that receives energy from one or more energy providers that do not support one or more features described below (e.g., and the location does not receive energy from an energy provider that supports one or more features described below). For another example, connection control 616 is included in user interface 602 when the home location configured for the home application is a location that is provided energy by at least one energy provider that supports one or more featured described below. In such an example, connection control 616 is not included in user interface 602 when the home location configured for the home application is a location that receives energy from an energy provider that does not support one or more featured described below (e.g., and the home location is not provided energy by an energy provider that supports one or more features described below). At FIG. 6A, computer system 600 detects selection input 605a directed to connection control 616. In some embodiments, selection input 605a is a tap input, a mouse click input, and/or a gaze input directed to connection control 616. It should be recognized that other inputs and/or other user interface elements can be used to initiate a process to connect an energy account.

FIG. 6B illustrates a scenario following FIG. 6A where a single energy provider supports one or more features described below for a current location of computer system 600 and/or a home location configured for the home application. As illustrated in FIG. 6B, in response to detecting selection input 605a, computer system 600 displays user interface 620 (e.g., a connection user interface) as overlaid over user interface 602. In some embodiments, computer system 600 displays user interface 620 instead of user interface 602. User interface 620 includes provider indicator 620a, exit control 620b, text indicator 620c (e.g., “Connect your energy account”), text indicator 620d (e.g., “With a connected account, you can view and track electricity in the app”), connect control 620e, and password control 620f.

In some embodiments, provider indicator 620a indicates an energy provider (e.g., “Energy Provider A”) that can be used. As illustrated in FIG. 6B, computer system 600 initiates a process for connecting an existing energy account corresponding to the energy provider. In some embodiments, in response to detecting an input directed to exit control 620b, computer system 600 ceases displaying user interface 620. In some embodiments, in response to detecting an input directed to connect control 620e, computer system 600 continues a process for connecting an existing energy account corresponding to the energy provider as described below with respect to FIGS. 6E-6H. In some embodiments, in response to detecting an input directed to password control 620f, computer system 600 displays a website user interface corresponding to Energy Provider A that allows a user to sign in via password as described below with respect to FIG. 6H. At FIG. 6B, computer system 600 detects selection input 605b1 directed to connect control 620e and selection input 605b2 directed to password control 620f.

FIG. 6C illustrates an alternate scenario following FIG. 6A where multiple energy providers support one or more features described below for a current location of computer system 600 and/or a home location configured for the home application. As illustrated in FIG. 6C, in response to detecting selection input 605a, computer system 600 displays user interface 622 as overlaid over user interface 602. In some embodiments, computer system 600 displays user interface 622 instead of user interface 602. User interface 622 includes exit control 622a, text indicator 622b (e.g., “Connect your energy account”), provider region 620c, text indicator 622d (e.g., “With a connected account, you can view and track electricity in the app”), connect control 622c, and password control 622f. It should be recognized that user interface 622 can include more, fewer, and/or different user interface elements than illustrated.

In some embodiments, in response to detecting an input directed to exit control 622a, computer system 600 ceases to display user interface 622. In some embodiments, in response to detecting an input directed to connect control 662e, computer system 600 ceases to display user interface 622 and displays the next step in connecting an energy account (e.g., through a different user interface within the home application). In some embodiments, in response to detecting an input directed to password control 662f, computer system 600 ceases to display user interface 622 and displays the next step in connecting an energy account (e.g., through a website user interface corresponding to a selected energy provider as described below with respect to FIG. 6H).

Provider region 620c includes first provider indicator 620c1 (e.g., “Energy Provider A”), second provider indicator 620c2 (e.g., “Energy Provider B”), and third provider indicator 620c3 (e.g., “Energy Provider C”). In some embodiments, computer system 600 displays energy providers that correspond to a location of a home connected with computer system 600. For example, in a scenario where computer system 600 makes a determination that third provider indicator 620c3 (e.g., “Energy Provider C”) does not offer service to a location of a home address connected with computer system 600, computer system 600 does not display third provider indicator 620c3 as an option from which to connect an energy account.

In some embodiments, multiple energy accounts can be connected with the same energy provider. For example, in a scenario where a user has two homes, two different energy accounts, one for each home, can be connected with the same energy provider. In some embodiments, different energy accounts can be connected with different energy providers. At FIG. 6C, computer system 600 detects selection input 605c directed to first provider indicator 620c1.

As illustrated in FIG. 6D, in response to detecting selection input 605c, computer system 600 displays first provider indicator 622c1 as selected to connect an energy account. In FIG. 6D, the selected first provider is visually distinct from the other providers as denoted by the hatching (e.g., the selected first provider indicator may have a different background color or some other visual indicator of selection). At FIG. 6D, computer system 600 detects selection input 605d1 directed to connect control 622e and selection input 605d2 directed to password control 622f.

FIGS. 6E-6G illustrate a scenario following selection input 605b1 (FIG. 6B) or selection input 605d1 (FIG. 6D). As illustrated in FIG. 6E, in response to detecting selection input 605b1 and/or selection input 605d1, computer system displays user interface 666 (e.g., an account user interface). User interface 666 includes back control 666a, text indicator 666b (e.g., “Find your account”), user information region 666c, edit information control 666d, and continue control 666e. It should be recognized that more, fewer, and/or different elements can be included in user interface 666. In some embodiments, in response to detecting an input directed to back control 666a, computer system 600 ceases to display user interface 666 and displays user interface 602.

As illustrated in FIG. 6E, user information region 666c includes name indicator 666c1 (e.g., “John Appleseed”), user email indicator 666c2 (e.g., Johnappleseed@account.com), and user address indicator 666c3 (e.g., “520 Oak Street, Cupertino, CA, 94024, United States”). In some embodiments, name indicator 666c1 indicates a name corresponding to a user of computer system 600. In some embodiments, user email indicator 666c2 indicates an email corresponding to the user of computer system 600. In some embodiments, user address indicator 666c3 indicates an address corresponding to a home belonging to the user of computer system 600. In some embodiments, the information within user information region 666c is acquired from a contact card of computer system 600. In such embodiments, the contact card can be a user interface corresponding to computer system 600 that contains a user's name, email address, phone number, home address, birthday, and/or other relevant data. In other embodiments, the name, email, and address can be manually entered by a user of the computer system 600 to identify an energy account with the chosen energy provider. It should be recognized that user interface region 666c can include more, fewer, and/or different information and/or some information can be obfuscated, such as hiding the full name of the user.

In some embodiments, in response to detecting an input directed to edit information control 666d, computer system 600 displays an editing user interface to allow a user to edit (e.g., change and/or modify) the information found in user information region 666c. In some embodiments, in response to detecting an input directed to continue control 666e, computer system 600 continues the connection flow. At FIG. 6E, computer system 600 detects selection input 605e directed to continue control 666c.

As illustrated in FIG. 6F, in response to detecting selection input 605e, computer system 600 ceases to display user interface 666 and displays user interface 668 (e.g., a verification option user interface). In some embodiments, in response to detecting selection input 605e, computer system 600 sends at least a portion of information included in user information region 666c to a selected energy provider (e.g., Energy Provider A as illustrated in FIG. 6B and FIG. 6D) so that the selected energy provider can identify one or more energy accounts corresponding to an identity. As illustrated in FIG. 6F, user interface 668 includes back control 668a, text indicator 668b (e.g., “Verify your identity”), text indicator 668c (e.g., “Choose how to send one-time code”), email option control 668d, text option control 668e, and verify control 668f. As illustrated in FIG. 6F, email option control 668d and text option control 668e represent different methods that a user can user to verify an identity received from the selected energy provider. It should be recognized that more, fewer, and/or different elements can be included in user interface 668. In addition, in some embodiments, user interface 668 can be skipped when verification is not necessary and instead proceed to FIG. 6I.

In some embodiments, in response to detecting an input directed to back control 668a, computer system 600 ceases to display user interface 668 and displays user interface 602. In some embodiments, in response to detecting an input directed to email option control 668d, computer system 600 makes a determination to send a verification code through email in response to detecting an input directed to verify control 668f. As illustrated in FIG. 6F, computer system 600 displays an email address as obfuscated within email option control 668d (e.g., JohnA*******************). In some embodiments, computer system 600 displays the email address in response to receiving the data from the selected energy provider. For the purposes of this disclosure, obfuscation is defined as obscuring sensitive and/or private data. As illustrated in FIG. 6F, computer system 600 obfuscates the email address displayed within email option control 668d to protect the data. In some embodiments, computer system 600 obfuscates the full email address. In some embodiments, computer system 600 obfuscates a portion of the email address (e.g., as illustrated in FIG. 6F). In some embodiments, computer system 600 does not obfuscate the email address.

In some embodiments, in response to detecting an input directed to text option control 668c, computer system 600 makes a determination to send a verification code through text in response to detecting an input directed to verify control 668f. In some embodiments, computer system 600 displays a phone number in response to receiving the data from the selected energy provider. As illustrated in FIG. 6F, computer system 600 displays the phone number as obfuscated within text option control 668c (e.g., ******7890). As illustrated in FIG. 6F, computer system 600 obfuscates the phone number displayed within text option control 668e to protect the data. In some embodiments, computer system 600 obfuscates the full phone number. In some embodiments, computer system 600 obfuscates a portion of the phone number (e.g., as illustrated in FIG. 6F). In some embodiments, computer system 600 does not obfuscate the phone number.

In some embodiments, in response to detecting an input directed to verify control 668f, computer system 600 receives a one-time verification code through the selected method (e.g., email and/or text). It should be recognized that more, less, and/or different methods can be used with techniques described herein. At FIG. 6F, computer system 600 detects selection input 605f1 directed to text option control 668e and, after, selection input 605f2 directed to verify control 668f.

In between FIG. 6F and FIG. 6G, computer system 600 received a one-time verification code via text. As illustrated in FIG. 6G, in response to detecting selection input 605f2, computer system 600 ceases displaying user interface 668 and displays user interface 670 (e.g., a code entry user interface). User interface 670 includes back control 670a, text indicator 670b (e.g., “Enter code”), entry field indicator 670c, verify option control 670d, and keyboard 670e. It should be recognized that more, fewer, and/or different elements can be included in user interface 670.

In some embodiments, in response to detecting an input directed to back control 670a, computer system 600 ceases to display user interface 670 and displays user interface 602. In some embodiments, entry field indicator 670c indicates a field where a one-time code is entered (e.g., in response to computer system 600 detecting inputs directed to keyboard 670e). In some embodiments, in response to detecting an input directed to verify option control 670d, computer system 600 displays an options user interface that includes other methods of verification. In some embodiments, in response to detecting inputs directed to keyboard 670e, computer system 600 displays numbers (e.g., and/or letters) within entry field 670c. In between FIGS. 6F and 6G, computer system 600 detected inputs directed to keyboard 670e that correspond to the received one-time code (e.g., “1234” as displayed in entry field indicator 670c).

At FIG. 6G, computer system 600 determines that the received one-time code has been entered. At FIG. 6G, in response to determining that the received one-time code has been entered (e.g., and matches the sent one-time code), computer system 600 verifies the identity of the user of computer system 600 to connect the home application to an existing energy account.

FIG. 6H illustrates a scenario following selection input 605b2 (FIG. 6B) or selection input 605d2 (FIG. 6D) where computer system 600 connects an energy account through an external website corresponding to a selected energy provider. In this scenario, a user has a preexisting account with the energy provider (e.g., a username and password).

As illustrated in FIG. 6H, in response to detecting selection input 605b2 or selection input 605d2, computer system 600 displays user interface 624 (e.g., a website user interface corresponding to Energy Provider A). In some embodiments, user interface 624 is displayed via a browser application of computer system 600 rather than the home application. In other embodiments, user interface 624 is displayed by the home application. User interface 624 includes provider indicator 624a, text indicator 624b (e.g., “Sign in”), entry field 624c, entry field 624d, remember control 624c, and sign in control 624f. It should be recognized that more, fewer, and/or different elements can be included in user interface 624.

In some embodiments, provider indicator 624a indicates the energy provider to which user interface 624 corresponds. In some embodiments, entry field 624c indicates a field where a username is entered. In some embodiments, entry field 624d indicates a field where a password is entered. In between FIG. 6B or 6D and FIG. 6H, computer system 600 detected inputs directed to a keyboard that correspond to a username (e.g., Johnappleseed@account.com), as displayed in entry field 624c and a password as displayed in entry field 624d.

In some embodiments, in response to detecting an input directed to remember control 624c, computer system 600 stores (e.g., remembers and/or retains) an entered username and displays the stored username every time computer system 600 displays user interface 624. In some embodiments, in response to detecting an input directed to sign in control 624f, computer system 600 continues the connection flow. At FIG. 6H, computer system 600 detects selection input 605h directed to sign in control 624f.

FIG. 6I illustrates a scenario following FIG. 6G or 6H. As illustrated in FIG. 6I, in response to verifying the identity of the user of computer system 600 (e.g., either through a one-time verification code and/or through an external website), computer system 600 displays user interface 672 (e.g., a terms and conditions user interface). User interface 672 includes back control 672a, text indicator 672b (e.g., “Terms and Conditions”), view control 672c, terms and conditions region 672d, disagree control 672e, and agree control 672f. It should be recognized that more, fewer, and/or different elements can be included in user interface 672 and, in some embodiments, user interface 672 is optional and/or might not be included in the connection flow.

In some embodiments, in response to detecting an input directed to back control 672a, computer system 600 ceases displaying user interface 672 and displays user interface 602. In some embodiments, in response to detecting an input directed to view control 672c, computer system 600 displays the terms and conditions of connecting to an existing energy account in a portable document format (PDF). Terms and Conditions region 672d includes text indicator 672d1 (e.g., “Important: Please read agreement. You agree to these terms and conditions.”), Terms and Conditions control 672d2, Privacy control 672d3, and Agreement control 672d4. In some embodiments, in response to detecting an input directed to Terms and Conditions control 672d2, computer system 600 displays the terms and conditions of connecting to an energy account within user interface 672. In some embodiments, in response to detecting an input directed to Privacy control 672d3, computer system 600 displays privacy information as a part of connecting to an existing energy account within user interface 672. In some embodiments, in response to detecting an input directed to Agreement control 672d4, computer system 600 displays information corresponding to electronic communications as a part of connecting to an energy account.

In some embodiments, in response to detecting an input directed to disagree control 672c, computer system 600 does not approve the progress made in the connection flow and ceases the connection flow (e.g., ceases displaying user interface 672 and displays user interface 602). In some embodiments, in response to detecting an input directed to agree control 672f, computer system 600 approves the progress made in the connection flow and continues the connection flow. Please note that the displayed terms and conditions are related to a user connecting to an existing energy account from a device and are not related to an energy provider (e.g., providers). At FIG. 6I, computer system 600 detects selection input 605i directed to agree control 672f.

FIG. 6J illustrates a scenario following selection input 605i where the selected energy provider has multiple energy accounts for an identity. As illustrated in FIG. 6J, in response to detecting selection input 605i, computer system 600 ceases displaying user interface 672 and displays user interface 674 (e.g., an address option user interface). User interface 674 includes back control 674a, text indicator 674b (e.g., “Choose address”), address control 674c, address control 674d, and address control 674c. Please note that address control 674c, address control 674d, and address control 674c all correspond to different accounts based on the identity that was verified above and Energy Provider A.

As illustrated in FIG. 6J, address control 674c includes address indicator 674c1 and account number indicator 674c2. In some embodiments, address indicator 674c1 (e.g., Oak Street) indicates a name of an existing energy account that can be connected to. In some embodiments, account number indicator 674c2 (e.g., 4678910) indicates the account number corresponding to the energy account within address control 674c. In some embodiments, in response to detecting an input directed to address control 674c, computer system 600 selects the energy account corresponding to address control 674c (e.g., Oak Street) to connect.

As illustrated in FIG. 6J, address control 674d includes address indicator 674d1 and account number indicator 674d2. In some embodiments, address indicator 674d1 (e.g., Park Lane) indicates another existing energy account that can be connected to. In some embodiments, account number indicator 674d2 (e.g., 2324258) indicates the account number corresponding to the energy account within address control 674d. In some embodiments, in response to detecting an input directed to address control 674d, computer system 600 selects the energy account corresponding to address control 674c (e.g., Park Lane) to connect.

As illustrated in FIG. 6J, address control 674e includes address indicator 674c1 and account number indicator 674c2. In some embodiments, address indicator 674c1 (e.g., Meadow Way) indicates another existing energy account that can be connected to. In some embodiments, account number indicator 674e2 (e.g., 5252523) indicates the account number corresponding to the energy account within address control 674c. In some embodiments, in response to detecting an input directed to address control 674e, computer system 600 selects the address corresponding to address control 674c (e.g., Meadow Way) to connect an energy account to. It should be recognized that more, fewer, and/or different energy accounts and/representations of each energy account can be used with techniques described herein than illustrated in FIG. 6J. At FIG. 6J, computer system 600 detects selection input 605j directed to address control 674c.

FIG. 6K illustrates a scenario following selection input 605j or where the selected energy provider has a single energy account for an identity. As illustrated in FIG. 6K, in response to detecting selection input 605i or selection input 605j, computer system 600 displays user interface 676 (e.g., a successful connection user interface). User interface 676 includes provider indicator 676a, text indicator 676b (e.g., “Account connected”), and selected address control 676c. In some embodiments, provider indicator 676a indicates the existing energy account from which to connect the home application to (e.g., “Energy Provider A”). As illustrated in FIG. 6K, selected address control 676c includes selected address indicator 676c. In some embodiments, selected address indicator 676c1 indicates the name of the energy account (e.g., “Oak Street”). In some embodiments, in response to detecting an input directed to address control 676c, computer system 600 ceases displaying user interface 676 and displays an updated user interface 602 that includes data corresponding to a connected energy account. At FIG. 6K, computer system 600 detects selection input directed to address control 676c.

FIGS. 6L-6R and 6V-6Y illustrate exemplary user interfaces for outputting different types of comparisons for different time periods in accordance with some embodiments. The user interfaces in these figures are used to illustrate the processes described below, including the processes in FIG. 8. FIGS. 6L-6Y illustrate exemplary user interfaces for outputting data when data is not complete in accordance with some embodiments. The user interfaces in these figures are used to illustrate the processes described below, including the processes in FIG. 9. FIGS. 6L-6Z illustrate a process where computer system 600 displays energy usage data corresponding to a connected energy account. FIGS. 6L-6U take place on Tuesday, May 21, 2024. At FIG. 6L, in response to detecting selection input 605k, computer system 600 completes the connection flow and connects the energy account corresponding to Energy Provider A to Oak Street (e.g., the user's selected energy account). As illustrated in FIG. 6L, as part of completing the connection flow, computer system 600 ceases to display user interface 676 and displays user interface 602 to include energy usage widget 628 and electricity rate widget 630.

Computer system 600 displays energy usage widget 628 to allow a user to view data corresponding to their energy usage based on the selected energy account (e.g., Oak Street). Energy usage widget 628 includes title indicator 628a (e.g., “Electricity usage”), summary value indicator 628b (e.g., Avg: 71 kWh), comparison indicator 628c (e.g., “Change: +4% vs. May 13-19”), and graph 628d (e.g., a bar graph).

In some embodiments, summary value indicator 628b indicates a value of energy usage in kilowatts corresponding to the selected energy account. In some embodiments, the value corresponding to summary value indicator 628b is positive, indicating energy usage. In some embodiments, the value corresponding to summary value indicator 628b is negative, indicating that more energy was generated than used (e.g., and is stored).

Please note that positive and negative values will be expanded on more in the solar section of this disclosure. As illustrated in FIG. 6L, computer system 600 displays the value corresponding to summary value indicator 628b as, “+71 kWh”, indicating that the weekly energy usage average for the week of May 13 through the 19 was 71 kilowatts used.

In some embodiments, comparison indicator 628c indicates a comparison of the level (e.g., either an increase or decrease) of energy usage of a selected time period to a previous (e.g., past and/or complete) time period. In some embodiments, computer system 600 changes the display of comparison indicator 628c based on the progress through a selected time period. For example, in a scenario where energy usage for a time period is complete (e.g., the time period is complete and computer system 600 has all the data corresponding to energy usage for that time period), computer system 600 displays comparison indicator 628c with “Change:” to indicate that computer system 600 knows the final data outcome for energy average usage for the selected time period. As another example, in a scenario where energy usage for a time period is incomplete (e.g., the time period is incomplete and computer system 600 does not yet have all the data corresponding to energy usage for that time period), computer system 600 displays comparison indicator 628c with “Trending:” to indicate that computer system 600 is predicting the final data outcome for energy average usage for the selected time period. In the case that computer system 600 determines that the energy usage for the selected time period is positive (e.g., more energy was used than generated), computer system 600 displays comparison indicator 628c as a percent. In the case that computer system 600 determines that the energy usage for the selected time period is negative (e.g., more energy was generated than was used (e.g., and is stored)), computer system 600 displays comparison indicator 628c as an amount instead of a percent. In the case that computer system 600 determines that the energy usage for the time period against which the selected time period is compared is negative, computer system 600 displays comparison indicator 628c as an amount instead of a percent.

In some embodiments, graph 628d indicates the net usage of energy for the selected time period (e.g., day, week, month, six months, and/or year) corresponding to the selected energy account. As illustrated in FIG. 6L, computer system 600 displays graph 628d with a week time period, including individual days of the week. Additionally, as illustrated in FIG. 6L, computer system 600 displays data bars corresponding to energy (electricity) usage within graph 628d. It should be recognized that other types of data can be used with techniques described herein, such as health data, workout data, and/or energy data (e.g., solar, hydropower, wind, geothermal, biomass, oil, coal, natural gas, and/or nuclear).

As illustrated in FIG. 6L, computer system 600 displays the data bars of graph 628d as rising above the x-axis, indicating energy usage. In some embodiments, computer system 600 displays the data bars of graph 628d as going below the x-axis, indicating an energy surplus. In some embodiments, computer system 600 visually distinguishes data corresponding to a surplus (e.g., data bars that go below the x-axis) from data corresponding to usage (e.g., data bars that go above the x-axis). For example, data corresponding to a surplus can be colored green and data corresponding to usage can be colored orange.

Electricity rate widget 630 includes title indicator 630a (e.g., “Electricity rate”), status indicator 630b, pricing indicator 630c, and graphic indicator 630d. In some embodiments, status indicator 630b indicates whether the connected energy grid is currently in a peak, partial-peak, and/or off-peak status for the selected energy account. In some embodiments, pricing indicator 630c indicates the price of energy corresponding to the connected energy grid based on a current time (e.g., “Electricity priced lower until 4:00 PM”). In some embodiments, graphic indicator 630d indicates whether the connected energy grid is currently in a peak, partial-peak, and/or off-peak status for the selected energy account.

As illustrated in FIG. 6L, computer system 600 displays energy usage widget 628 with usage data corresponding to the week of May 13-May 19 (e.g., at FIG. 6L, computer system 600 makes a determination that the data for the current week of May 20-May 26 is incomplete (e.g., computer system 600 has no data for the current week of May 20-May 26) and, in response to making a determination that the data for the current week of May 20-May 26 is incomplete, computer system 600 displays energy usage widget 628 with the most recent set of complete energy usage data (e.g., May 13-May 19). In some embodiments, in a scenario where computer system 600 has the energy usage data corresponding to Monday the 20^{th} (e.g., computer system 600 has data for the current week of May 20-May 26) of the current week, computer system 600 displays the energy usage data for May 20-May 26. At FIG. 6L, computer system 600 detects selection input 605l directed to energy usage widget 628.

As illustrated in FIG. 6M, in response to detecting selection input 605l, computer system 600 ceases displaying user interface 602 and displays user interface 632 (e.g., an energy usage user interface corresponding to the selected energy account). Please note that computer system 600 initially displays data corresponding to the week of May 13 through 19 (e.g., instead of data corresponding to the week of May 20-21) based on a determination that the week of May 13 through 19 is a complete week (e.g., and there is no data for May 20-21 yet) and computer system 600 can display the full energy usage data. In some embodiments, computer system 600 displays data corresponding to an incomplete week. For example, computer system 600 can displays data corresponding to the current date of Tuesday May 21 and the corresponding week (e.g., May 20 through 26).

User interface 632 includes title indicator 634 (e.g., Electricity usage), done control 650, slider control 636, summary value indicator 638, comparison indicator 640, date indicator 642, graph 644, peak control 646, and off-peak control 648. Please note that computer system 600 displays energy usage widget 628 within user interface 602 to act as a preview to user interface 632, and many of the user interface elements displayed within energy usage widget 628 correspond to user interface elements displayed within user interface 632. For example, title indicator 628a corresponds to title indicator 634, and summary value indicator 628b corresponds to summary value indicator 638. Additionally, please note that the user interface elements found in user interface 632 follow the same rules and logic as the user interface elements found in energy usage widget 628. In some embodiments, summary value indicator 638 includes an average of values corresponding to one or more subsets within the corresponding time period. The subsets can be subsets illustrated in a graph or any other subset of the corresponding time period.

In some embodiments, in response to detecting an input directed to done control 650, computer system 600 ceases displaying user interface 632 and displays user interface 602. In some embodiments, in response to detecting an input directed to slider control 636, computer system 600 displays energy usage data corresponding to a selected time period for a selection of a time period type. Each of the time period types represents a duration of time that is different from any other one of the time period types. As illustrated in FIG. 6M, computer system 600 displays day control 636a, week control 636b, month control 636c, six-month control 636d, year control 636e, and selection indicator 636f as parts of slider control 636. In some embodiments, in response to detecting an input directed to day control 636a, computer system 600 displays energy usage data for a day time period within graph 644. In some embodiments, in response to detecting an input directed to week control 636b, computer system 600 displays energy usage data for a week time period within graph 644. In some embodiments, in response to detecting an input directed to month control 636c, computer system 600 displays energy usage data for a month time period within graph 644. In some embodiments, in response to detecting an input directed to six-month control 636d, computer system 600 displays energy usage data for a six month time period within graph 644. In some embodiments, in response to detecting an input directed to year control 636e, computer system 600 displays energy usage data for a year time period within graph 644. In some embodiments, selection indicator 636f indicates which time period computer system 600 is displaying energy usage data for. As illustrated in FIG. 6M, computer system 600 displays selection indicator 636f over week control 636b, indicating that computer system 600 is currently displaying energy usage data for a weekly time period, as illustrated by graph 644.

In some embodiments, summary value indicator 638 indicates an average value corresponding energy usage based on the selected time period. As illustrated in FIG. 6M, computer system 600 displays summary value indicator 638 with “Weekly average usage: +71 kWh” to indicate that the average energy usage for the selected timer period is 71 kilowatts. In some embodiments, the value corresponding to summary value indicator 638 is positive, indicating energy usage. In some embodiments, the value corresponding to summary value indicator 638 is negative, indicating that more energy was generated than used (e.g., and is stored). As illustrated in FIG. 6M, computer system 600 displays the value corresponding to summary value indicator 638 as, “+71 kWh”, indicating that the energy usage average for the week of May 13 through 19 was 71 kilowatts used (e.g., was positive). In some embodiments, the amount of energy usage indicated by summary value indicator 638 is displayed as an average. In some embodiments, the amount of energy usage indicated by summary value indicator 638 is displayed in an amount (e.g., a whole number).

In some embodiments, comparison indicator 640 indicates a comparison of the level (e.g., either an increase or decrease) of energy usage of a selected time period to a previous (e.g., past and/or complete) time period. For example, as illustrated in FIG. 6M, computer system 600 displays graph 644 with data corresponding to the week of May 13 through 19, 2024 (e.g., as indicated by date indicator 642). Computer system 600 displays comparison indicator 640 as “Change: +4% vs. May 6 through 12” to indicate that the data corresponding to the week of May 13 through 19, 2024 (e.g., as indicated by date indicator 642 and graph 644) is compared to the data corresponding to the week of May 6 through 12. As illustrated in FIG. 6M, comparison indicator 640 indicates that there was an increase of energy usage for week of May 13 through 19 by 4% as compared to the week of May 6 through 12. In some embodiments, the amount of energy usage indicated by comparison indicator 640 is displayed in a percentage. In some embodiments, the amount of energy usage indicated by comparison indicator 640 is displayed in an amount (e.g., a whole number).

It will be understood that solely positive or negative values can be associated with energy usage data or other data of any one, more than one, and/or all of the values corresponding to the current time period and/or another time period (e.g., a preceding time period) that provides a basis for comparison to the current time period. Examples of such data are shown in FIGS. 6M-6R and 6V. Where all of the values for comparison are either solely positive or solely negative, a comparison can be presented as a percentage, ratio, and the like. The comparison data can include an indication of the percentage (e.g., “%”). The comparison data can include an indication of whether the amount is an increase (e.g., positive and/or “+”) or a decrease (e.g., negative and/or “−”) relative to the time period against which the current time period is being compared. In some embodiments, providing the comparison data as a percentage, rather than an amount of change, can provide a helpful reference for observation by a user.

As illustrated in FIG. 6M, comparison indicator 640 indicates a comparison between the data corresponding to the week of May 13 through 19 and the week of May 6 through May 12 (e.g., computer system 600 compares data of a complete week time period to the data of the preceding week time period). In some embodiments, computer system 600 compares data for a selected time period (e.g., day, week, or year) to the immediate comparable preceding time period. For example, as illustrated in FIG. 6M, displays a comparison between the data corresponding to the week of May 13 through 19 and the week of May 6 through May 12 (e.g., the preceding week). In some embodiments, computer system 600 compares data for a selected time period (e.g., month or six months) to the preceding time period of a previous year. In some embodiments, in addition to displaying comparison data within comparison indicator 640, computer system 600 displays the total energy usage data for a time period. In some embodiments, in the case that the energy usage for a segment of the time period (e.g., an hour of a day time period, a day of a week time period, a day for a month time period, a week for a six-month time period, and/or a month for a year time period) equals zero (e.g., the amount of energy generated equals the amount of energy used), computer system 600 displays graph 644 with a segment that equals zero (e.g., the bar of the segment does not rise up for descend down to indicate that the energy usage equals zero.

In some embodiments, date indicator 642 indicates the date range (and/or date) for the selected time period. As illustrated in FIG. 6M, computer system 600 displays date indicator 642 as “May 13 through 19, 2024”, indicating that the energy usage data included in graph 644 corresponds to the week of May 13 through 19, 2024.

In some embodiments, graph 644 indicates the net usage of energy for the selected time period (e.g., day, week, month, six months, and/or year) corresponding to the energy account. As illustrated in FIG. 6M, computer system 600 displays graph 644 with a week time period (e.g., for the week of May 13 through 19), including individual days of the week (Monday through Sunday) along the x-axis and kilowatt amount along the y-axis. In some embodiments, computer system scales the time period increments and kilowatt amount based on the selected time period. For example, computer system 600 displays months along the x-axis rather than days and an increased value of kilowatts to reflect a year time period.

In some embodiments, in response to detecting an input directed to peak control 646, computer system 600 displays energy usage data during peak hours within graph 644. Computer system 600 displays peak graphic indicator 646a and peak usage indicator 646b within peak control 646. In some embodiments, peak graphic indicator 646a indicates that peak control 646 corresponds to energy usage during peak hours. In some embodiments, peak usage indicator 646b indicates the percentage of total energy usage detected within peak hours during the selected time period (e.g., 32% of energy usage was detected during peak hours). In some embodiments, in response to detecting an input directed to off-peak control 648, computer system 600 displays energy usage data during off-peak hours within graph 644. Computer system 600 displays peak graphic indicator 648a and off-peak usage indicator 648b within off-peak control 648. In some embodiments, off-peak graphic indicator 648a indicates that off-peak control 648 corresponds to energy usage during off-peak hours. In some embodiments, computer system 600 displays off-peak usage indicator 648b indicates the percentage of total energy usage detected within off-peak hours during the selected time period (e.g., 68% of energy usage was detected during off-peak hours). These usage types are described further herein. At FIG. 6M, computer system 600 detects selection input 605m directed to month control 636c.

As illustrated in FIG. 6N, in response to detecting selection input 605m, computer system 600 changes the selected time period type (e.g., from a weekly time period type to a monthly time period type). In response to changing the selected time period type, computer system 600 displays selection indicator 636f over month control 636c. Additionally, as illustrated in FIG. 6N, in response to changing the selected time period type, computer system 600 displays energy usage data corresponding to a month time period (e.g., May 2024). As illustrated in FIG. 6N, computer system 600 updates summary value indicator 638, comparison indicator 640, date indicator 642, graph 644, peak control 646, and off-peak control 648 to correspond to energy usage data based on the month of May in 2024.

As illustrated in FIG. 6N, computer system 600 updates summary value indicator 638 to indicate energy usage data based on the month of May in 2024 (e.g., “Monthly average usage: +18 kWh”. As illustrated in FIG. 6N, computer system 600 displays the value corresponding to summary value indicator 638 as, “+18 kWh”, indicating that the energy usage average for the month of May was 18 kilowatts used.

As illustrated in FIG. 6N, computer system 600 updates comparison indicator 640 to indicate a comparison of energy usage between May 2024 and May 2023. As illustrated in FIG. 6N, computer system 600 displays graph 644 with data corresponding to the month of May in 2024 (e.g., as indicated by date indicator 642 (e.g., “May 1 through May 21, 2024”). Computer system 600 displays comparison indicator 640 as “Trending: −2% vs. May 2023” to indicate that the data corresponding to the month of May 2024 (e.g., as indicated by date indicator 642 and graph 644) is compared to the data corresponding to the month of May 2023. As illustrated in FIG. 6N, computer system 600 displays comparison indicator 640 as “Trending” to indicate that the month of May 2024 is incomplete and that the data is still trending (e.g., computer system 600 does not yet have all the energy usage data for May 2024 and is predicting the final data outcome for energy average usage for May 2024).

As illustrated in FIG. 6N, computer system 600 updates date indicator 642 to indicate the date range for the selected time period. As illustrated in FIG. 6N, computer system 600 displays date indicator 642 as “May 1 through May 21, 2024”, indicating that the energy usage data included in graph 644 corresponds to the month of May 2024.

As illustrated in FIG. 6N, computer system 600 updates graph 644 to display energy usage data for a month time period (e.g., the month of May 2024), including individual days of the month along the x-axis and kilowatt amount along the y-axis. As illustrated in FIG. 6N, computer system 600 increases the kilowatt amount scale along the y-axis to accommodate the change in the selected time period. As illustrated in FIG. 6N, computer system 600 displays graph 644 as incomplete, indicating that computer system 600 has not received data corresponding to energy usage for the dates of the 22^{nd} through the 31^{st}.

As illustrated in FIG. 6N, computer system 600 updates peak control 646 (e.g., more specifically peak usage indicator 646b) to indicate the percentage of total energy usage detected within peak hours during the selected time period of May 2024 (e.g., 34% of energy usage was detected during peak hours so far in May 2024). As illustrated in FIG. 6N, computer system 600 updates off-peak control 648 (e.g., more specifically off-peak usage indicator 648b) to indicate the percentage of total energy usage detected within off-peak hours during the selected time period of May 2024 (e.g., 66% of energy usage was detected during peak hours so far in May 2024). As illustrated in FIG. 6N, computer system 600 indicates the current day (e.g., Tuesday May 21, 2024) by bolding the date (e.g., (“21”) within graph 644. At FIG. 6N, computer system 600 detects selection input 605n directed to six-month control 636d.

As illustrated in FIG. 6O, in response to detecting selection input 605n, computer system 600 changes the selected time period type (e.g., from a monthly time period type to a six-month time period type). In response to changing the selected time period type, computer system 600 displays selection indicator 636f over six-month control 636d. Additionally, as illustrated in FIG. 6O, in response to changing the selected time period type, computer system 600 displays energy usage data corresponding to a six-month time frame (e.g., computer system 600 displays energy usage data for the last six months of the calendar year of 2024 and does not display energy usage data corresponding to 2023). As illustrated in FIG. 6O, computer system 600 updates summary value indicator 638, comparison indicator 640, date indicator 642, graph 644, peak control 646, and off-peak control 648 to correspond to energy usage data based on the last six months within the calendar year of 2024 (e.g., January through June).

As illustrated in FIG. 6O, computer system 600 updates summary value indicator 638 to indicate energy usage data on the last six months within the calendar year of 2024 (e.g., “Six-month average usage: +106 kWh”). As illustrated in FIG. 6O, computer system 600 displays the value corresponding to summary value indicator 638 as, “+106 kWh”, indicating that the energy usage average for the months of January 1 through May 21 (excluding the remaining ten days of May and the month of June because computer system 600 does not have energy usage for those time periods yet) was 106 kilowatts used.

As illustrated in FIG. 6O, computer system 600 updates comparison indicator 640 to indicate a comparison of energy usage between January 1 through May 21, 2024 and January 1 through Jun. 30, 2023. As illustrated in FIG. 6O, computer system 600 displays graph 644 with data corresponding to the months of January 1 through May 21, 2024 (e.g., as indicated by date indicator 642 (e.g., “January 1 through May 21, 2024”). Computer system 600 displays comparison indicator 640 as “Trending: −1% vs. January 1 through June 30” to indicate that the data corresponding to the month of January 1 through May 21 (e.g., as indicated by date indicator 642 and graph 644) is compared to the data corresponding to the month of January 1 through May 21, 2024. As illustrated in FIG. 6O, computer system 600 displays comparison indicator 640 as “Trending” to indicate that the six-month time period of January 2024 through June 2024 is incomplete and that the data is still trending (e.g., computer system 600 does not yet have all the energy usage data for January 2024 through June 2024 and is predicting the final data outcome for energy average usage for January 2024 through June 2024).

As illustrated in FIG. 6O, computer system 600 updates date indicator 642 to indicate the date range for the selected time period. As illustrated in FIG. 6O, computer system 600 displays date indicator 642 as “Jan. 1 through May 21, 2024”, indicating that the energy usage data included in graph 644 corresponds to the month of May 2024.

As illustrated in FIG. 6O, computer system 600 updates graph 644 to display energy usage data for a six-month time period (e.g., January 2024 through June 2024), including individual weeks of the months along the x-axis and kilowatt amount along the y-axis. As illustrated in FIG. 6O, computer system 600 displays graph 644 as incomplete, indicating that computer system 600 has not received data corresponding to energy usage for the dates of the 22^{nd} through the 31^{st} of May and the entire month of June. As illustrated in FIG. 6O, computer system 600 indicates the current month (e.g., May) by bolding May within graph 644.

As illustrated in FIG. 6O, computer system 600 updates peak control 646 (e.g., more specifically peak usage indicator 646b) to indicate the percentage of total energy usage detected within peak hours during the selected six-month time period of January 2024 through June 2024 (e.g., 52% of energy usage was detected during peak hours so far in May 2024). As illustrated in FIG. 6O, computer system 600 updates off-peak control 648 (e.g., more specifically off-peak usage indicator 648b) to indicate the percentage of total energy usage detected within off-peak hours during the selected six-month time period of January 2024 through June 2024 (e.g., 48% of energy usage was detected during peak hours so far in May 2024). As illustrated in FIG. 6O, computer system 600 indicates the current month (e.g., May 2024) by bolding May within graph 644. At FIG. 6O, computer system 600 detects selection input 6050 directed to year control 636c.

As illustrated in FIG. 6P, in response to detecting selection input 6050, computer system 600 changes the selected time period type (e.g., from a six-month time period type to a yearly time period type). In response to changing the selected time period type, computer system 600 displays selection indicator 636f over year control 636c. Additionally, as illustrated in FIG. 6P, in response to changing the selected time period type, computer system 600 displays energy usage data corresponding to a year time period (e.g., computer system 600 displays energy usage data for the calendar year of 2024). As illustrated in FIG. 6P, computer system 600 updates summary value indicator 638, comparison indicator 640, date indicator 642, graph 644, peak control 646, and off-peak control 648 to correspond to energy usage data based on the calendar year of 2024 (e.g., January through December).

As illustrated in FIG. 6P, computer system 600 updates summary value indicator 638 to indicate energy usage data for the calendar year of 2024 (e.g., “Yearly average usage: +50 kWh”. As illustrated in FIG. 6P, computer system 600 displays the value corresponding to summary value indicator 638 as, “+50 kWh”, indicating that the energy usage average for the months of January through December (excluding the remaining ten days of May and the month of June through December because computer system 600 does not have energy usage for those time periods yet) was 50 kilowatts used.

As illustrated in FIG. 6P, computer system 600 updates comparison indicator 640 to indicate a comparison of energy usage between 2023 and 2024. As illustrated in FIG. 6P, computer system 600 displays graph 644 with data corresponding 2024 (e.g., as indicated by date indicator 642 (e.g., “2024”). Computer system 600 displays comparison indicator 640 as “Trending: +4% vs. 2023” to indicate that the data corresponding to 2024 (e.g., as indicated by date indicator 642 and graph 644) is compared to the data corresponding to 2023. As illustrated in FIG. 6P, computer system 600 displays comparison indicator 640 as “Trending” to indicate that the year time period of 2024 is incomplete and that the data is still trending (e.g., computer system 600 does not yet have all the energy usage data for 2024 and is predicting the final data outcome for energy average usage for 2024).

As illustrated in FIG. 6P, computer system 600 updates date indicator 642 to indicate the date range for the selected time period. As illustrated in FIG. 6P, computer system 600 displays date indicator 642 as “2024”, indicating that the energy usage data included in graph 644 corresponds to the year of 2024.

As illustrated in FIG. 6P, computer system 600 updates graph 644 to display energy usage data for a year time period (e.g., 2024), including individual months along the x-axis and kilowatt amount along the y-axis. As illustrated in FIG. 6P, computer system 600 displays graph 644 as incomplete, indicating that computer system 600 has not received data corresponding to energy usage for the dates of the 22^{nd} through the 31^{st} of May and the entirety of June through December. As illustrated in FIG. 6P, computer system 600 indicates the current month (e.g., May) by bolding May within graph 644.

As illustrated in FIG. 6P, computer system 600 updates peak control 646 (e.g., more specifically peak usage indicator 646b) to indicate the percentage of total energy usage detected within peak hours during the selected year time period of 2024 (e.g., 49% of energy usage was detected during peak hours so far in 2024). As illustrated in FIG. 6P, computer system 600 updates off-peak control 648 (e.g., more specifically off-peak usage indicator 648b) to indicate the percentage of total energy usage detected within off-peak hours during the selected year time period of 2024 (e.g., 51% of energy usage was detected during peak hours so far in 2024). At FIG. 6P, computer system 600 detects selection input 605p directed to day control 636a.

As illustrated in FIG. 6Q, in response to detecting selection input 605p, computer system 600 changes the selected time period type (e.g., from a yearly time period type to a daily time period type). In response to changing the selected time period type, computer system 600 displays selection indicator 636f over day control 636a. Additionally, as illustrated in FIG. 6Q, in response to changing the selected time period type, computer system 600 displays energy usage data corresponding to a day time period (e.g., Sunday, May 19, 2024). Computer system 600 displays the energy usage data for Sunday, May 19, 2024, based on a determination that Sunday, May 19, 2024 is the last time period for day time periods that has complete data.

As illustrated in FIG. 6Q, computer system 600 updates summary value indicator 638, comparison indicator 640, date indicator 642, graph 644, peak control 646, and off-peak control 648 to correspond to energy usage data based on May 19, 2024.

In some embodiments, summary value indicator 638 indicates a total value corresponding energy usage based on the selected time period. As illustrated in FIG. 6Q, computer system 600 updates summary value indicator 638 to indicate energy usage data based on May 19, 2024 (e.g., “Daily total: +13 kWh”. As illustrated in FIG. 6Q, computer system 600 displays the value corresponding to summary value indicator 638 as, “+13 kWh”, indicating that the energy usage total for May 19 was 13 kilowatts used. In some embodiments, summary value indicator 638 includes a total (e.g., sum) of values corresponding to one or more subsets within the corresponding time period. The subsets can be subsets illustrated in a graph or any other subset of the corresponding time period. Where only some subsets are associated with data, summary value indicator 638 can include a total and/or a projected (e.g., trending) total based on the available data.

As illustrated in FIG. 6Q, computer system 600 updates comparison indicator 640 to indicate a comparison of energy usage between May 19 and May 12. As illustrated in FIG. 6Q, computer system 600 displays graph 644 with data corresponding to May 19 (e.g., as indicated by date indicator 642 (e.g., “Sunday, May 19, 2024”). Computer system 600 displays comparison indicator 640 as “Change: +3% vs. Sunday, May 12, 2024” to indicate that the data corresponding to May 19 (e.g., as indicated by date indicator 642 and graph 644) is compared to the data corresponding to May 12. As illustrated in FIG. 6Q, computer system 600 displays comparison indicator 640 as “Change” to indicate that May 19 is complete and that the corresponding energy usage data is complete (e.g., the time period is complete and computer system 600 has all the data corresponding to energy usage for May 19).

As illustrated in FIG. 6Q, computer system 600 updates date indicator 642 to indicate the date for the selected time period. As illustrated in FIG. 6Q, computer system 600 displays date indicator 642 as “Sunday, May 19, 2024”, indicating that the energy usage data included in graph 644 corresponds to Sunday, May 19, 2024.

As illustrated in FIG. 6Q, computer system 600 updates graph 644 to display energy usage data for a day time period (e.g., Sunday, May 19, 2024), including hours of the day in six-hour increments along the x-axis and kilowatt amount along the y-axis. As illustrated in FIG. 6Q, computer system 600 decreases the kilowatt amount scale along the y-axis to accommodate the change in selected time period. As illustrated in FIG. 6Q, computer system 600 displays graph 644 as complete, indicating that computer system 600 has complete data corresponding to energy usage for Sunday, May 19, 2024.

As illustrated in FIG. 6Q, computer system 600 updates peak control 646 (e.g., more specifically peak usage indicator 646b) to indicate the percentage of total energy usage detected within peak hours during the selected time period of Sunday, May 19, 2024 (e.g., 54% of energy usage was detected during peak hours on Sunday, May 19, 2024). As illustrated in FIG. 6Q, computer system 600 updates off-peak control 648 (e.g., more specifically off-peak usage indicator 648b) to indicate the percentage of total energy usage detected within off-peak hours during the selected time period of May 2024 (e.g., 46% of energy usage was detected during peak hours on Sunday, May 19, 2024). At FIG. 6Q, computer system 600 detects swipe input 605q1 and swipe input 605q2 directed to graph 644. In some embodiments, swipe input 605q1 and swipe input 605q2 are gaze inputs, pull down inputs, and/or tap inputs.

FIG. 6R illustrates a scenario where computer system 600 responds to detecting swipe input 605q1. As illustrated in FIG. 6R, in response to detecting swipe input 605q1, computer system 600 changes the selected time period (e.g., from Sunday May 19, 2024 to Saturday May 18, 2024). Additionally, as illustrated in FIG. 6R, in response to changing the selected time period, computer system 600 displays energy usage data corresponding to a day time period (e.g., Saturday, May 18, 2024). As illustrated in FIG. 6R, computer system 600 updates summary value indicator 638, comparison indicator 640, date indicator 642, graph 644, peak control 646, and off-peak control 648 to correspond to energy usage data based on May 18, 2024.

In some embodiments, in response to detecting swipe input 605q1 and swipe input 605q2 (e.g., inputs intended to display past and/or future time periods and the corresponding energy usage data), computer system 600 changes the display of comparison indicator 640. In some embodiments, computer system 600 displays comparison indicator 640 with a percent value if computer system 600 displayed comparison indicator 640 corresponding to the preceding time period with a percent value in response to detecting an input. In some embodiments, computer system 600 does not display comparison indicator 640 with a percent value (e.g., and displays comparison indicator 640 with an amount value (e.g., a whole number)) if computer system 600 displayed comparison indicator 640 corresponding to the preceding time period with a percent value in response to detecting an input.

In some embodiments, computer system 600 displays comparison indicator 640 with an amount value if computer system 600 displayed comparison indicator 640 corresponding to the preceding time period with an amount value in response to detecting an input. In some embodiments, computer system 600 does not display comparison indicator 640 with an amount value (e.g., and displays comparison indicator 640 with a percent value) if computer system 600 displayed comparison indicator 640 corresponding to the preceding time period with an amount value in response to detecting an input. In some embodiments, computer system 600 displays comparison indicator 640 with whichever value (e.g., percent or amount) best fits the selected time period in response to detecting an input.

As illustrated in FIG. 6R, computer system 600 updates summary value indicator 638 to indicate energy usage data based on May 18, 2024 (e.g., “Daily total: +19 kWh”. As illustrated in FIG. 6R, computer system 600 displays the value corresponding to summary value indicator 638 as, “+19 kWh”, indicating that the energy usage total for May 18 was 19 kilowatts used.

As illustrated in FIG. 6R, computer system 600 updates comparison indicator 640 to indicate a comparison of energy usage between May 18 and May 11. As illustrated in FIG. 6R, computer system 600 displays graph 644 with data corresponding to May 18 (e.g., as indicated by date indicator 642 (e.g., “Saturday, May 18, 2024”). Computer system 600 displays comparison indicator 640 as “Change: −2% vs. Saturday, May 11, 2024” to indicate that the data corresponding to May 18 (e.g., as indicated by date indicator 642 and graph 644) is compared to the data corresponding to May 11. As illustrated in FIG. 6R, computer system 600 displays comparison indicator 640 as “Change” to indicate that May 18 is complete and that the corresponding energy usage data is complete (e.g., the time period is complete and computer system 600 has all the data corresponding to energy usage for May 18).

As illustrated in FIG. 6R, computer system 600 updates date indicator 642 to indicate the date for the selected time period. As illustrated in FIG. 6R, computer system 600 displays date indicator 642 as “Saturday, May 18, 2024”, indicating that the energy usage data included in graph 644 corresponds to Saturday, May 18, 2024.

As illustrated in FIG. 6R, computer system 600 updates graph 644 to display energy usage data for a day time period (e.g., Saturday, May 18, 2024), including hours of the day in six-hour increments along the x-axis and kilowatt amount along the y-axis. As illustrated in FIG. 6R, computer system 600 displays graph 644 as complete, indicating that computer system 600 has complete data corresponding to energy usage for Saturday, May 18, 2024.

As illustrated in FIG. 6R, computer system 600 updates peak control 646 (e.g., more specifically peak usage indicator 646b) to indicate the percentage of total energy usage detected within peak hours during the selected time period of Saturday, May 18, 2024 (e.g., 53% of energy usage was detected during peak hours on Saturday, May 18, 2024). As illustrated in FIG. 6R, computer system 600 updates off-peak control 648 (e.g., more specifically off-peak usage indicator 648b) to indicate the percentage of total energy usage detected within off-peak hours during the selected time period of Saturday, May 18, 2024 (e.g., 47% of energy usage was detected during peak hours on Saturday, May 18, 2024).

FIG. 6R illustrates a scenario where computer system 600 responds to detecting swipe input 605q1 (e.g., a swipe to display a past time period). As illustrated in FIG. 6R, in response to detecting swipe input 605q1, computer system 600 changes the selected time period (e.g., from Sunday May 19, 2024 to Saturday May 18, 2024). Additionally, as illustrated in FIG. 6R, in response to changing the selected time period, computer system 600 displays energy usage data corresponding to a day time period (e.g., Saturday, May 18, 2024). As illustrated in FIG. 6R, computer system 600 updates summary value indicator 638, comparison indicator 640, date indicator 642, graph 644, peak control 646, and off-peak control 648 to correspond to energy usage data based on May 18, 2024.

As illustrated in FIG. 6R, computer system 600 updates summary value indicator 638 to indicate energy usage data based on May 18, 2024 (e.g., “Daily average usage: +19 kWh”. As illustrated in FIG. 6R, computer system 600 displays the value corresponding to summary value indicator 638 as, “+19 kWh”, indicating that the energy usage average for May 18 was 19 kilowatts used.

As illustrated in FIG. 6R, computer system 600 updates comparison indicator 640 to indicate a comparison of energy usage between May 18 and May 11. As illustrated in FIG. 6R, computer system 600 displays graph 644 with data corresponding to May 18 (e.g., as indicated by date indicator 642 (e.g., “Saturday, May 18, 2024”). Computer system 600 displays comparison indicator 640 as “Change: −2% vs. Saturday, May 11, 2024” to indicate that the data corresponding to May 18 (e.g., as indicated by date indicator 642 and graph 644) is compared to the data corresponding to May 11. As illustrated in FIG. 6R, computer system 600 displays comparison indicator 640 as “Change” to indicate that May 18 is complete and that the corresponding energy usage data is complete (e.g., the time period is complete and computer system 600 has all the data corresponding to energy usage for May 18).

As illustrated in FIG. 6R, computer system 600 updates date indicator 642 to indicate the date for the selected time period. As illustrated in FIG. 6R, computer system 600 displays date indicator 642 as “Saturday, May 18, 2024”, indicating that the energy usage data included in graph 644 corresponds to Saturday, May 18, 2024.

As illustrated in FIG. 6R, computer system 600 updates graph 644 to display energy usage data for a day time period (e.g., Saturday, May 18, 2024), including hours of the day in six-hour increments along the x-axis and kilowatt amount along the y-axis. As illustrated in FIG. 6R, computer system 600 displays graph 644 as complete, indicating that computer system 600 has complete data corresponding to energy usage for Saturday, May 18, 2024.

As illustrated in FIG. 6R, computer system 600 updates peak control 646 (e.g., more specifically peak usage indicator 646b) to indicate the percentage of total energy usage detected within peak hours during the selected time period of Saturday, May 18, 2024 (e.g., 53% of energy usage was detected during peak hours on Saturday, May 18, 2024). As illustrated in FIG. 6R, computer system 600 updates off-peak control 648 (e.g., more specifically off-peak usage indicator 648b) to indicate the percentage of total energy usage detected within off-peak hours during the selected time period of Saturday, May 18, 2024 (e.g., 47% of energy usage was detected during peak hours on Saturday, May 18, 2024).

FIG. 6S illustrates a scenario where computer system 600 responds to detecting swipe input 605q2 (e.g., a swipe to display a past time period that does not have data yet). As illustrated in FIG. 6S, in response to detecting swipe input 605q2, computer system 600 changes the selected time period (e.g., from Sunday May 19, 2024 to Monday May 20, 2024). Additionally, at FIG. 6S, computer system 600 makes a determination that it does not yet have energy usage data corresponding to Monday, May 20, 2024. As illustrated in FIG. 6S, in response to making a determination that it does not yet have energy usage data corresponding to Monday, May 20, 2024, computer system 600 ceases displaying summary value indicator 638, comparison indicator 640, peak control 646, and off-peak control 648. Additionally, as illustrated in FIG. 6S, computer system 600 displays text indicator 652 (e.g., “Usage data not available. Data Typically available 24-48 hours after usage”) and updates date indicator 642, graph 644 to correspond to energy usage data based on Monday May 20, 2024.

As illustrated in FIG. 6S, computer system 600 displays text indicator to indicate that computer system 600 has not finished gathering energy usage data for Monday, May 20, 2024. In some embodiments, computer system 600 displays text indicator 652 as, “Usage data not available for yesterday's date yet. Data typically available 24-48 hours after usage.”).

As illustrated in FIG. 6S, computer system 600 updates date indicator 642 to indicate the date for the selected time period. As illustrated in FIG. 6S, computer system 600 displays date indicator 642 as “Yesterday”, indicating that the lack of energy usage data included in graph 644 corresponds to Monday, May 20, 2024 (e.g., the current date at FIG. 6S is Tuesday, May 21, 2024).

As illustrated in FIG. 6S, computer system 600 updates graph 644 to display no energy usage data for a day time period (e.g., Monday, May 20, 2024), including hours of the day in six-hour increments along the x-axis and kilowatt amount along the y-axis. As illustrated in FIG. 6S, computer system 600 displays graph 644 without data, indicating that computer system 600 does not yet have data corresponding to energy usage for Monday, May 20, 2024. At FIG. 6S, computer system 600 detects swipe input 605s directed to graph 644.

As illustrated in FIG. 6T, in response to detecting swipe input 605s, computer system 600 changes the selected time period (e.g., from Monday May 20, 2024 to Tuesday May 21, 2024 (e.g., the current date)). Additionally, at FIG. 6T, computer system 600 makes a determination that it does not yet have energy usage data corresponding to Tuesday, May 21, 2024. As illustrated in FIG. 6T, in response to making a determination that it does not yet have energy usage data corresponding to Tuesday, May 21, 2024, computer system 600 updates text indicator 652, date indicator 642, graph 644 to correspond to energy usage data based on Tuesday May 21, 2024.

As illustrated in FIG. 6T, computer system 600 displays text indicator 652 (e.g., “Usage data not available yet for today's date. Data typically available 24-48 hours after usage.”) to indicate that computer system 600 has not finished gathering energy usage data for Tuesday, May 21, 2024. In some embodiments, computer system 600 displays text indicator 652 as, “Usage data not available yet. Data typically available 24-48 hours after usage.”)

As illustrated in FIG. 6T, computer system 600 updates date indicator 642 to indicate the date for the selected time period. As illustrated in FIG. 6T, computer system 600 displays date indicator 642 as “Today”, indicating that the lack of energy usage data included in graph 644 corresponds to Tuesday, May 21, 2024 (e.g., the current date).

As illustrated in FIG. 6T, computer system 600 updates graph 644 to display no energy usage data for a day time period (e.g., Tuesday, May 21, 2024), including hours of the day in six-hour increments along the x-axis and kilowatt amount along the y-axis. As illustrated in FIG. 6T, computer system 600 displays graph 644 without data, indicating that computer system 600 does not yet have data corresponding to energy usage for Tuesday, May 21, 2024. At FIG. 6T, computer system 600 detects swipe input 605t directed to graph 644.

As illustrated in FIG. 6U, in response to detecting swipe input 605t, computer system 600 changes the selected time period (e.g., from Tuesday May 21, 2024 to Wednesday May 22, 2024 (e.g., a future date)). Additionally, at FIG. 6U, computer system 600 makes a determination that it does not have energy usage data corresponding to Wednesday, May 22, 2024. As illustrated in FIG. 6U, in response to making a determination that it does not have energy usage data corresponding to Wednesday, May 22, 2024, computer system 600 updates text indicator 652, date indicator 642, graph 644 to correspond to energy usage data based on Wednesday May 22, 2024.

As illustrated in FIG. 6U, computer system 600 displays text indicator 652 (e.g., “Usage data not available for tomorrow's date). Data typically available 24-48 hours after usage.”) to indicate that computer system 600 has not started gathering energy usage data for Wednesday, May 22, 2024. In some embodiments, computer system 600 displays text indicator 652 as, “Usage data not available. Data typically available 24-48 hours after usage.”)

As illustrated in FIG. 6U, computer system 600 updates date indicator 642 to indicate the date for the selected time period. As illustrated in FIG. 6U, computer system 600 displays date indicator 642 as “Tomorrow”, indicating that the lack of energy usage data included in graph 644 corresponds to Wednesday, May 22, 2024 (e.g., a future date).

As illustrated in FIG. 6U, computer system 600 updates graph 644 to display no energy usage data for a day time period (e.g., Wednesday, May 22, 2024), including hours of the day in six-hour increments along the x-axis and kilowatt amount along the y-axis. As illustrated in FIG. 6U, computer system 600 displays graph 644 without data, indicating that computer system 600 does not yet have data corresponding to energy usage for Wednesday, May 22, 2024.

FIG. 6V illustrates a scenario where the current date is Wednesday, May 22, 2024. As illustrated in FIG. 6V, computer system 600 displays energy usage data for the week of May 20 through 26, 2024, as a result of the week of May 20-May 26 having some data (e.g., Computer system 600 has completed energy usage data corresponding to Monday the 20^{th}).

Computer system 600 displays energy usage data for the week of May 20 through 26, 2024 in response to a request to display most recent energy usage data. Because computer system 600 has some data for the current week of May 20-May 26, computer system 600 displays graph 644 with the energy usage data for the week of May 20-May 26, including the energy usage data for Monday the 20^{th}, as opposed to displaying graph 644 with the most recent energy usage data (e.g., Monday the 20^{th}) and the previous six days from the previous week (e.g., computer system 600 displays energy usage data for the week of May 20-26 because computer system 600 has energy usage data for that week).

In some embodiments, computer system 600 displays data as illustrated in FIG. 6V in response to displaying user interface 602 and/or in response to detecting selection input 605l. As illustrated in FIG. 6V, computer system 600 displays summary value indicator 638, comparison indicator 640, date indicator 642, graph 644, peak control 646, and off-peak control 648 to correspond to energy usage data based on the week of May 20 through 26, 2024.

As illustrated in FIG. 6V, computer system 600 displays summary value indicator 638 to indicate energy usage data based on the week of May 20 through 26, 2024 (e.g., “Weekly average usage: +2 kWh”. As illustrated in FIG. 6V, computer system 600 displays the value corresponding to summary value indicator 638 as, “+2 kWh”, indicating that the energy usage average for the week of May 20 through 26, 2024 was 18 kilowatts used.

As illustrated in FIG. 6V, computer system 600 displays comparison indicator 640 to indicate a comparison of energy usage between the week of May 20 through 26, 2024 and the week of May 13 through 19, 2024. As illustrated in FIG. 6V, computer system 600 displays graph 644 with data corresponding to the week of May 20 through 26, 2024 (e.g., as indicated by date indicator 642 (e.g., “May 20 through May 26, 2024”). Computer system 600 displays comparison indicator 640 as “Trending: +8% vs. May 13 through 19, 2024” to indicate that the data corresponding to the week of May 20 through 26, 2024 (e.g., as indicated by date indicator 642 and graph 644) is compared to the data corresponding to the week of May 13 through 19, 2024. As illustrated in FIG. 6V, computer system 600 displays comparison indicator 640 as “Trending” to indicate that the week of May 20 through 26, 2024 is incomplete (e.g., as illustrated in FIG. 6V, computer system 600 displays data for Monday the 20^{th} only) and that the data is still trending (e.g., computer system 600 does not yet have all the energy usage data for the week of May 20 through 26, 2024 and is predicting the final data outcome for energy average usage for the week of May 20 through 26, 2024).

As illustrated in FIG. 6V, computer system 600 updates date indicator 642 to indicate the date range for the selected time period. As illustrated in FIG. 6V, computer system 600 displays date indicator 642 as “May 20 through May 26, 2024”, indicating that the energy usage data included in graph 644 corresponds to the week of May 20 through 26, 2024.

As illustrated in FIG. 6V, computer system 600 updates graph 644 to display energy usage data for a week time period (e.g., the week of May 20 through 26, 2024), including individual days of the week along the x-axis and kilowatt amount along the y-axis. As illustrated in FIG. 6V, computer system 600 displays graph 644 as incomplete, only displaying data for Monday the 20^{th}, indicating that Monday the 20^{th} is complete and that the corresponding energy usage data is complete (e.g., computer system 600 has all the data corresponding to energy usage for Monday the 20^{th}) while also indicating that computer system 600 has not received energy usage data for the dates of the Thursday the 23^{rd} through Sunday the 26^{th} (e.g., at FIG. 6V, computer system 600 is compiling energy usage data for Tuesday the 21^{st} and Wednesday the 22^{nd}). As illustrated in FIG. 6V, computer system 600 indicates the current day (e.g., Wednesday May 22, 2024) by bolding Wednesday within graph 644.

As illustrated in FIG. 6V, computer system 600 updates peak control 646 (e.g., more specifically peak usage indicator 646b) to indicate the percentage of total energy usage detected within peak hours during the selected time period the week of May 20 through 26, 2024 (e.g., 32% of energy usage was detected during peak hours so far in the week of May 20 through 26, 2024). As illustrated in FIG. 6V, computer system 600 updates off-peak control 648 (e.g., more specifically off-peak usage indicator 648b) to indicate the percentage of total energy usage detected within off-peak hours during the selected time period of the week of May 20 through 26, 2024 (e.g., 68% of energy usage was detected during peak hours so far in the week of May 20 through 26, 2024).

FIGS. 6W-6Y illustrate exemplary user interfaces for outputting comparison data of different types in accordance with some embodiments. The user interfaces in these figures are used to illustrate the processes described below, including the processes in FIG. 10.

FIGS. 6W-6Y illustrate a process where computer system 600 displays energy usage with solar energy corresponding to a connected energy account. Please note that FIGS. 6W-6Y place on Monday the 3rd of June 2024, and computer system 600 displays energy data corresponding to the week of May 27 through Jun. 2, 2024. Additionally, computer system 600 displays graph 644 to reflect that fact that the week of May 27 through Jun. 2, 2024, is a “negative” energy usage week (e.g., computer system 600 detects that more energy was generated (e.g., and therefore stored as a surplus of energy) than was used). In some embodiments, a negative energy time period is due to solar energy, to not using generated energy, and/or to an external device, such as a battery. For the purposes of this disclosure, the surplus of energy corresponding to the week of May 27 through Jun. 2, 2024, is due to solar energy.

FIGS. 6W-6Y also illustrate a process where computer system 600 displays energy usage relating to different account features. For example, an energy account can include provisions that relate to energy usage at different times (e.g., hours) of a given day. By further example, an energy account can include a time-of-use (TOU) plan, in which energy is priced at different rates (e.g., monetary value) at different times (e.g., hours) of a given day. A TOU plan can have variable rates for a unit of energy consumed or generated. The rates can be distinguished by multiple categories (e.g., “peak”, “partial-peak”, and/or “off-peak”). Any number of categories can be provided for an energy account. Each category can have a corresponding rate that is applied within a range of time in which it is to be applied. The categories can be contiguous and non-overlapping in time, such that at any given moment within a time period, one and only one category applies. Energy data (e.g., energy usage and/or energy generation) can include information about which category of a TOU plan applies to any amount of energy used or generated. Accordingly, computer system 600 can provide an ability to output the information based on whether and how the energy corresponds to one of the multiple categories in the TOU plan.

As illustrated in FIG. 6W, computer system 600 displays summary value indicator 638 to indicate energy usage data based on the week of May 20 through 26, 2024 (e.g., “Weekly average surplus: 16 kWh”. As illustrated in FIG. 6W, computer system 600 displays the value corresponding to summary value indicator 638 as, “16 kWh”, indicating that the energy average surplus (e.g., the amount of unused energy) for the week of May 27 through June 2 was 16 kilowatts.

As illustrated in FIG. 6W, comparison indicator 640 indicates a comparison of energy usage between the week of May 27 through Jun. 2, 2024, and the week of May 20 through 26, 2024. As illustrated in FIG. 6W, computer system 600 displays graph 644 with data corresponding to the week of May 27 through Jun. 2, 2024 (e.g., as indicated by date indicator 642 (e.g., “May 27 through Jun. 2, 2024”). Computer system 600 displays comparison indicator 640 as “Change: +7 kWh vs. May 20 through 26, 2024” to indicate that the data corresponding to the week of May 27 through Jun. 2, 2024 (e.g., as indicated by date indicator 642 and graph 644) is compared to the data corresponding to the week of May 20 through 26, 2024.

It will be understood that both negative and positive values can be associated with energy usage data or other data of any one, more than one, and/or all of the values corresponding to the current time period and/or another time period (e.g., a preceding time period) that provides a basis for comparison to the current time period. Examples of such data are shown in FIGS. 6W-6Y. Where one or more of the values for comparison are positive and one or more of the value for comparison are negative, a comparison can be presented as an amount of change. The comparison data can include a unit of measurement (e.g., “kWh”). The comparison data can include an indication of whether the amount is an increase (e.g., positive and/or “+”) or a decrease (e.g., negative and/or “−”) relative to the time period against which the current time period is being compared. In some embodiments, providing the comparison data as an amount of change, rather than a percentage, can provide a helpful reference for observation by a user.

As illustrated in FIG. 6W, computer system 600 updates date indicator 642 to indicate the date range for the selected time period. As illustrated in FIG. 6W, computer system 600 displays date indicator 642 as “May 27 through Jun. 2, 2024”, indicating that the energy usage data included in graph 644 corresponds to the week of May 27 through Jun. 2, 2024.

As illustrated in FIG. 6W, computer system 600 updates graph 644 to display energy usage data for a week time period (e.g., the week of May 27 through Jun. 2, 2024), including individual days of the week along the x-axis and kilowatt amount along the y-axis. As illustrated in FIG. 6W, computer system 600 displays graph 644 as complete, indicating that computer system 600 has complete data corresponding to energy usage for the week of May 27 through Jun. 2, 2024. As illustrated in FIG. 6W, computer system 600 displays the data for the days of Tuesday the 28^{th}, Thursday the 30^{th}, Friday the 31^{st}, Saturday the 1^{st}, and Sunday the 2^{nd}, as going downwards, indicating that on those days, more energy was generated (e.g., and therefore stored as a surplus of energy) than was used.

As illustrated in FIG. 6W, computer system 600 updates peak control 646 (e.g., more specifically peak usage indicator 646b) to indicate the percentage of total energy usage detected within peak hours during the selected time period the week of May 27 through Jun. 2, 2024 (e.g., 27% of energy usage was detected during peak hours in the week of May 27 through Jun. 2, 2024). As illustrated in FIG. 6W, computer system 600 updates off-peak control 648 (e.g., more specifically off-peak usage indicator 648b) to indicate the percentage of total energy usage detected within off-peak hours during the selected time period of May 2024 (e.g., 73% of energy usage was detected during off-peak hours in the week of May 27 through Jun. 2, 2024). At FIG. 6W, computer system 600 detects selection input 605w directed to peak control 646.

As illustrated in FIG. 6X by the hatching corresponding to the dates of Monday the 27^{th} and Wednesday the 29^{th}, and peak control 646, in response to detecting selection input 605w, computer system 600 displays energy usage data during peak hours within graph 644. At FIG. 6X, computer system 600 detects selection input 605x directed to off-peak control 648.

As illustrated in FIG. 6Y by the hatching corresponding to the dates of Monday the 27^{th} and Wednesday the 29^{th}, and off-peak control 648, in response to detecting selection input 605x, computer system 600 displays energy usage data during off-peak hours within graph 644. At FIG. 6X, computer system 600 detects selection input 605x directed to done control 650.

FIGS. 6Z-6AC illustrate exemplary user interfaces for disconnecting from an energy account of an energy provider in accordance with some embodiments. The user interfaces in these figures are used to illustrate the processes described below.

FIGS. 6Z-6AC illustrate a process where computer system 600 disconnects from an energy account. As illustrated in FIG. 6Z, in response to detecting selection input 605y, computer system 600 ceases to display user interface 632 and displays user interface 602. As illustrated in FIG. 6Z, computer system 600 displays energy usage widget 628 with the same data as illustrated in FIG. 6W-6Y (e.g., title indicator 628a (e.g., “Electricity usage”), summary value indicator 628b (e.g., Surplus: 16 kWh), comparison indicator 628c (e.g., “Change: +7 kWh vs. May 27-June 2”), and graph 628d). At FIG. 6Z, computer system 600 detects selection input 605z directed to settings control 608.

As illustrated in FIG. 6AA, in response to detecting selection input 605z, computer system 600 displays user interface 654 (e.g., a settings user interface). User interface 654 includes add home control 654a, done control 654b, home info region 654c, owner region 654d, and controls region 654e. Computer system 600 adds a home to the home application in response to add home control 654a. Computer system 600 ceases displaying user interface 654 in response to detecting an input directed to done control 654b.

Home information region 654c includes name indicator 654c1 and my home indicator 654c1. In some embodiments, name indicator 654c1 indicates that home information region 654c includes the name corresponding to the physical address. In some embodiments, my home indicator 654c1 indicates the name of the physical address (e.g., “My Home”).

Owner region 654d includes people indicator 654d1, owner control 654d2, and invite control 654d3. In some embodiments, people indicator 654d1 indicates the people (e.g., user and/or users) corresponding to the physical address connected to the home application. In some embodiments, in response to detecting an input directed to owner control 654d2, computer system 600 displays a keyboard user interface, allowing a user to edit the name of a user that owns and/or corresponds to the physical address connected to the home application. As illustrated in FIG. 6AA, computer system 600 displays that John Appleseed is the resident (e.g., owner) of the physical address connected to the home application within owner control 654d2. In some embodiments, in response to detecting an input directed to invite control 654d3, computer system 600 invites (e.g., adds and/or includes) another user to the physical address connected to the home application and allows the other user to view, interact with and/or manage the connected physical address.

Control region 654e includes energy control 654e1, more control 654e2, hubs and bridges control 654c3, more control 654c4, intercom control 654e5, more control 654c6, safety and security control 654c7, more control 654c8, speakers and tv control 654c9, and more control 654e10. In some embodiments, in response to detecting an input directed to energy control 654e1, computer system 600 displays a user interface corresponding to an energy account. In some embodiments, in response to detecting an input directed to more control 654e2, computer system 600 displays a user interface corresponding to an energy account as an alternate method to detecting an input directed to energy control 654c1. In some embodiments, in response to detecting an input directed to hubs and bridges control 654e3, computer system 600 displays a user interface corresponding to a home hubs and bridges system. In some embodiments, in response to detecting an input directed to more control 654e4, computer system 600 displays a user interface corresponding to a home hubs and bridges system as an alternate method to detecting an input directed to hubs and bridges control 654e3. In some embodiments, in response to detecting an input directed to intercom control 654e5, computer system 600 displays a user interface corresponding to a home intercom system. In some embodiments, in response to detecting an input directed to more control 654e6, computer system 600 displays a user interface corresponding to a home intercom system as an alternate method to detecting an input directed to intercom control 654e5. In some embodiments, in response to detecting an input directed to safety and security control 654c7, computer system 600 displays a user interface corresponding to a home safety and security system. In some embodiments, in response to detecting an input directed to more control 654e8, computer system 600 displays a user interface corresponding to a home safety and security system as an alternate method to detecting an input directed to safety and security control 654e7. In some embodiments, in response to detecting an input directed to speakers and TV control 654e9, computer system 600 displays a user interface corresponding to connected home speaker and TV computer systems. In some embodiments, in response to detecting an input directed to more control 654e10, computer system 600 displays a user interface corresponding to connected home speaker and TV computer systems as an alternate method to detecting an input directed to speakers and TV control 654e9. At FIG. 6AB, computer system 600 detects selection input 605aa directed to energy control 654c1.

As illustrated in FIG. 6AB, in response to detecting selection input 605aa, computer system 600 ceases to display user interface 654, and displays user interface 664. User interface 664 (e.g., an energy account user interface) includes back control 656, title indicator 658 (e.g., “Energy”), show forecast control 660, and account information region 662.

Computer system 600 ceases displaying user interface 664 and displays user interface 654 in response to detecting an input directed to back control 656. In some embodiments, 602 in response to detecting an input directed to show forecast control 660 (e.g., more specifically, to toggle 660a), computer system 600 displays energy forecast 614 within user interface. In some embodiments, in response to detecting an input directed to show forecast control 660 (e.g., more specifically, to toggle 660a) computer system 600 ceases displaying energy forecast 614 within user interface 602.

Account information region 662 includes provider indicator 662a, call control 662b, message control 662c, website control 662d, username indicator 662e, account number indicator 662f, generation indicator 662g, address control 662h, and disconnect control 662i.

In some embodiments, provider indicator 662a indicates the energy provider that computer system 600 has connected an energy account with (e.g., Energy Provider A). In some embodiments, in response to detecting an input directed to call control 662b, computer system 600 displays a call user interface that allows a user to call the energy provider that computer system 600 has connected an energy account with. In some embodiments, in response to detecting an input directed to message control 662c, computer system 600 displays a message user interface that allows a user to message the energy provider that computer system 600 has connected an energy account with. In some embodiments, in response to detecting an input directed to website control 662d, computer system 600 displays a website user interface that corresponds to the energy provider that computer system 600 has connected an energy account with.

In some embodiments, username indicator 662e indicates the username corresponding to the connected energy account (e.g., “John Appleseed”). In some embodiments, account number indicator 662f indicates the account number corresponding to the connected energy account (e.g., “4678910”). In some embodiments, generation indicator 662g indicates the energy generation corresponding to the connected energy account (e.g., “Clean power”). In some embodiments, address control 662h indicates the service address corresponding to the connected energy account (e.g., “Oak Street”). In some embodiments, in response to detecting an input directed to disconnect control 662i, computer system 600 disconnects the energy account. At FIG. 6AB, computer system 600 detects selection input 605ab directed to disconnect control 662i. At FIG. 6AB, in response to detecting selection input 605ab, computer system 600 disconnects the established energy account.

As illustrated in FIG. 6AC, in response to detecting selection input 605ab, computer system 600 ceases displaying user interface 664 and displays user interface 602. Additionally, in response to disconnecting the established energy account, as illustrated in FIG. 6AC, computer system 600 updates connection control (e.g., more specifically, text indicator 616a (e.g., “Energy account disconnected”) and text indicator 616b (e.g., “Reconnect app”) to indicate that computer system 600 disconnected from an energy account and will no longer display data corresponding to energy usage. In some embodiments, an energy provider can disconnect an energy account (e.g., due to inactivity, a breach of contract, and/or an ending of service with the provider).

At FIG. 6AC, computer system 600 detects selection input 605ac directed to text indicator 616b. In response to detecting selection input 605ac, computer system 600 initiates a process to reconnect to the energy account. In some embodiments, the process to reconnect to the energy account is the same as described above. In other embodiments, the process to reconnect to the energy account does not require one or more user interfaces described above, such as selecting an energy provider and/or an energy account.

FIG. 7 is a flow diagram illustrating a method (e.g., method 700) for connecting to an energy account of an energy provider in accordance with some embodiments. Some operations in method 700 are, optionally, combined, the orders of some operations are, optionally, changed, and some operations are, optionally, omitted.

As described below, method 700 provides an intuitive way for connecting to an energy account of an energy provider. Method 700 reduces the cognitive burden on a user, thereby creating a more efficient human-machine interface. For battery-operated computing devices, enabling a user to interact with such devices faster and more efficiently conserves power and increases the time between battery charges.

In some embodiments, method 700 is performed at a computer system (e.g., 600) that is in communication (e.g., wired communication and/or wireless communication) with a display generation component (e.g., a display screen, a projector, and/or a touch-sensitive display) and an input device (e.g., a touch-sensitive surface, a camera, a depth sensor, a microphone, a hardware input mechanism, a rotatable input mechanism, a physical input mechanism, a button, a crown, a knob, a dial, a physical slider, and/or an accelerometer). In some embodiments, the computer system is a watch, a phone, a tablet, a fitness tracking device, a processor, a head-mounted display (HMD) device, a communal device, a media device, a speaker, a television, and/or a personal computing device.

The computer system detects (702), via the input device, an input (e.g., 605k, 605l, 605m, 605n, 6050, 605p, 605w, 605x, and/or 605y) (e.g., a selection input and/or a non-selection input) corresponding to (e.g., directed to, at a location of, related to, and/or associated with) a request to display energy usage data (e.g., oil usage, gas usage, and/or electrical usage data). In some embodiments, a selection input includes a tap input, a verbal input, an audible command, a gaze input, an air gesture, a mouse click, and/or a submission of a user-interface element and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, detecting the input corresponding to the request to display energy usage data includes detecting (e.g., via an accelerometer or other type of input device) a wrist raise of the computer system (e.g., when the computer system is a wearable device, such as a watch). In some embodiments, detecting the input corresponding to the request to display energy usage data includes detecting (e.g., via a touch-sensitive surface, a hardware input mechanism, a rotatable input mechanism, a physical input mechanism, a button, a crown, a knob, a dial, a physical slider, or other type of input device) a tap input on a user interface element and/or a tap input while the computer system is in a lower power mode (e.g., the display generation component is off). In some embodiments, detecting the input corresponding to the request to display energy usage data includes detecting (e.g., via a rotatable input mechanism or other type of input device) an input (e.g., a rotation of the rotatable input mechanism) corresponding to a request to scroll a user interface. In some embodiments, detecting the input corresponding to the request to display energy usage data includes detecting a voice request to display energy usage data. In some embodiments, rather than detecting the request to display energy usage data via the input device, the computer system detects the request to display energy usage data by receiving a notification and/or an update (e.g., of energy usage data) from an application (e.g., corresponding to energy usage data) and/or another computer system different from the computer system. In some embodiments, detecting the input corresponding to the request to display energy usage data includes detecting an input corresponding to a selection of a time period type.

In response to (704) detecting the input corresponding to the request to display energy usage data, in accordance with a determination that a first set of one or more criteria is satisfied, the computer system displays (706), via the display generation component, a first representation (e.g., 628, 628a-628d, 638, 640, 644, 646, 646b, 648, and/or 648b) (e.g., a graph, a total value, a partial value, an average value, and/or a relative value) of energy usage data (e.g., energy usage within a time period and/or comparison data relative to preceding time period) corresponding to a first energy account (e.g., 674c, 674d, 674c, and/or 676c) (e.g., financial account for a given subscriber, user, member, property, and/or facility) of a first energy provider (e.g., 620a, 622c1, 622c, 622c3, 624a, and/or 676a) (e.g., provider of oil service, gas service, and/or electrical service), wherein the first representation of energy usage data includes an indication (e.g., 628, 638, 640, 644, 646, 646b, 648, and/or 648b) (e.g., graphical information, plot on graph, and/or numerical value) of a first amount of energy used in a first time period (e.g., an hour, a day, a week, one or more months, and/or a year). In some embodiments, the indication of the first amount of energy used in the first time period includes energy corresponding to the first energy account. In some embodiments, the first representation includes graphical information (e.g., 644) indicating energy usage. In some embodiments, the first representation includes numerical information indicating energy usage. In some embodiments, displaying the first representation includes updating the first representation (e.g., the first representation is displayed while detecting the input corresponding to the request to display energy usage data). In some embodiments, the first set of one or more criteria is satisfied when the first energy account is established and/or configured for an account of the computer system. In some embodiments, the first set of one or more criteria is satisfied before detecting the input. In some embodiments, the first set of one or more criteria is satisfied based on one or more inputs provided in a connection stage in which the first energy account and/or the first energy provider are selected.

In response to (704) detecting the input corresponding to the request to display energy usage data, in accordance with a determination that a second set of one or more criteria, different from the first set of one or more criteria, is satisfied, the computer system displays (708), via the display component, a second representation (e.g., 628, 628a-628d, 638, 640, 644, 646, 646b, 648 and/or 648b) (e.g., a graph, a total value, an average value, and/or a relative value) of energy usage data (e.g., energy usage within a time period, comparison data relative to preceding time period) corresponding to a second energy account (e.g., 674c, 674d, 674c, and/or 676c), different from the first energy account, of a second energy provider (e.g., 620a, 622c1, 622c, 622c3, 624a, and/or 676a), different from the first energy provider (e.g., without displaying the first representation of energy usage data), wherein the second representation of energy usage data includes an indication (e.g., 628, 638, 640, 644, 646, 646b, 648, and/or 648b) of a second amount of energy (e.g., the same as or different from the first amount of energy) used in a second time period (e.g., the same as or different from the first period of time). In some embodiments, the indication of the second amount of energy used in the second time period includes energy corresponding to the second energy account. In some embodiments, the second representation includes graphical information (e.g., 644) indicating energy usage. In some embodiments, the second representation includes numerical information indicating energy usage. In some embodiments, displaying the second representation includes updating the second representation (e.g., when the second representation is displayed while detecting the input corresponding to the request to display energy usage data). In some embodiments, the second representation of energy usage data does not correspond to the first energy account and/or the first energy provider. In some embodiments, the first representation of energy usage data does not correspond to the second energy account and/or the second energy provider. In some embodiments, before detecting the input corresponding to the request to display energy usage data, the computer system detects, via the input device, an input corresponding to a selection of the first energy account, the second energy account, the first energy provider, and/or the second energy provider. Displaying different representations for different energy accounts of different energy providers when different criteria is satisfied allows the computer system to cater information provided to a user to a current context and/or make available information from disparate sources, thereby performing an operation when a set of conditions has been met without requiring further user input, reducing the number of inputs needed to perform an operation, and/or providing improved visual feedback to the user.

In some embodiments, in response to detecting the input corresponding to the request to display energy usage data and in accordance with a determination that a third set of one or more criteria, different from the first set of one or more criteria and the second set of one or more criteria, is satisfied, the computer system displays, via the display component, a third representation (e.g., 628, 628a-628d, 638, 640, 644, 646, 646b, 648, and/or 648b) (e.g., a graph, a total value, an average value, and/or a relative value) of energy usage data (e.g., energy usage within a time period and/or comparison data relative to preceding time period) corresponding to a third energy account (e.g., 674c, 674d, 674c, and/or 676c), different from the first energy account, of the first energy provider (e.g., without displaying the first representation of energy usage data and/or the second representation of energy usage data), wherein the third representation of energy usage data includes an indication (e.g., 628, 638, 640, 644, 646, 646b, 648, and/or 648b) of a third amount of energy (e.g., the same as or different from the first amount of energy and/or the second amount of energy) used in a third time period (e.g., the same as or different from the first time period and/or the second time period). In some embodiments, the indication of the third amount of energy used in the third time period includes energy corresponding to the third energy account. In some embodiments, the third representation includes graphical information (e.g., 644) indicating energy usage. In some embodiments, the third representation includes numerical information indicating energy usage. In some embodiments, displaying the third representation includes updating the third representation (e.g., when the third representation is displayed while detecting the input corresponding to the request to display energy usage data). In some embodiments, the third representation of energy usage data corresponds to the first energy provider. In some embodiments, the third representation of energy usage data does not correspond to the first energy account, the second energy account, and/or the second energy provider. In some embodiments, before detecting the input corresponding to the request to display energy usage data, the computer system detects, via the input device, an input corresponding to a selection of the third energy account. Displaying an additional representation for an additional energy account for a given energy provider allows the computer system to cater information provided to a user for each of multiple accounts, thereby performing an operation when a set of conditions has been met without requiring further user input, reducing the number of inputs needed to perform an operation, and/or providing improved visual feedback to the user.

In some embodiments, the input is a first input. In some embodiments, before detecting the input corresponding to the request to display energy usage data and in accordance with a determination that a third set of one or more criteria is satisfied (e.g., that the first energy provider has multiple energy accounts corresponding to a single account holder), the computer system displays, via the display generation component, a first representation (e.g., 674c1, 674c2, 674d1, 674d2, 674c1, and/or 674c2) of the first energy account and a representation (e.g., 674c1, 674c2, 674d1, 674d2, 674c1, and/or 674c2) of a third energy account (e.g., the second energy account of the first energy provider and/or another energy account of the first energy provider) of the first energy provider. In some embodiments, both of the first every account and the third energy account are associated with a single account holder. In some embodiments, both of the first every account and the third energy account are accounts serviced by the first energy provider. In some embodiments, the third set of one or more criteria is the same as or different from the first set of one or more criteria and/or the second set of one or more criteria. In some embodiments, in accordance with a determination that the third set of one or more criteria is not satisfied (e.g., that the first energy provider has only the first energy account corresponding to the single account holder), the computer system forgoes display of the first representation of the first energy account and the representation of the third energy account (e.g., instead of displaying the first representation of the first energy account and the representation of the third energy account, the computer system proceeds to display a user interface that would result from detecting an input corresponding to selection of the first representation). In some embodiments, while displaying the first representation of the first energy account and the representation of the third energy account, the computer system detects, via the input device, a second input (e.g., 605j) (e.g., a selection input and/or a non-selection input) corresponding to (e.g., directed to, at a location of, related to, and/or associated with) a respective representation (e.g., 674c1, 674c2, 674d1, 674d2, 674c1, and/or 674c2), wherein the first set of one or more criteria includes a criterion that is satisfied when the respective representation is the first representation, and wherein the first set of one or more criteria includes a criterion that is not satisfied when the respective representation is the second representation. In some embodiments, in response to detecting the input corresponding to the request to display energy usage data and in accordance with a determination that the first set of one or more criteria is not satisfied, the computer system forgoes display of the first representation. In some embodiments, the selected representation is recorded and subsequently applied when the request to display energy usage data is detected. Displaying different representations for different energy accounts for a given energy provider allows the computer system to provide the user with options to select a desired energy account, thereby performing an operation when a set of conditions has been met without requiring further user input, reducing the number of inputs needed to perform an operation, and/or providing improved visual feedback to the user.

In some embodiments, the input is a first input. In some embodiments, before detecting the input corresponding to the request to display energy usage data, the computer system detects an input (e.g., 605a, 605b1, 605b2, 605c, 605d1, 605d2, 605e, 605f1, 605f2, 605h, 605i, and/or 605j) corresponding to a request to authenticate with the first energy provider. In some embodiments, after (and/or in response to) detecting the input corresponding to the request to authenticate with the first energy provider, in accordance with a determination that the request to authenticate with the first energy provider (e.g., authenticate the first energy provider and/or the first energy account of the first energy provider) is in a first manner (e.g., using a code sent to the computer system), the computer system displays (e.g., at FIG. 6G), via the display generation component, an entry form (e.g., 670b, 670c, 670d, and/or 670c) to enter a code (e.g., received from the first energy provider) (e.g., without displaying a user interface corresponding to the first energy provider). In some embodiments, the entry form comprises a field for entering information for verification or authorization. In some embodiments, the information comprises a username, a password, a code, an identification, a credential, a license, and/or a key (e.g., a two-factor authentication key). In some embodiments, after detecting the input corresponding to the request to authenticate with the first energy provider, in accordance with a determination that the request to authenticate with the first energy provider (e.g., authenticate the first energy provider and/or the first energy account of the first energy provider) is in a second manner (e.g., using a user interface, such as a webpage and/or a screen of an application, corresponding to the first energy provider), the computer system forgoes (e.g., at FIG. 6H) display of the entry form (e.g., 670b, 670c, 670d, and/or 670c). In some embodiments, while detecting the input corresponding to a request to authenticate with the first energy provider, the computer system displays, via the display generation component, a first user interface element (e.g., 620e and/or 622e) to cause a code to be sent to the computer system (e.g., by the first energy provider) and/or a second user interface element (e.g., 620f and/or 622f) to access a user interface corresponding to the first energy provider. In some embodiments, while displaying the user interface including the first user interface element and/or the second user interface element, the computer system detects, via the input device, an input (e.g., a selection input and/or a non-selection input) (e.g., 605b1, 605b2, 605d1, and/or 605d2) corresponding to a respective user interface element. In some embodiments, the determination that the request to authenticate with the first energy provider in the first manner includes a determination that the respective user interface element is the first user interface element. In some embodiments, the determination that the request to authenticate with the first energy provider in the second manner includes a determination that the respective user interface element is the second user interface element. In some embodiments, the user interface corresponding to the first energy provider is for authenticating with the first energy provider. In some embodiments, after (and/or in response to) detecting the input corresponding to the request to authenticate with the first energy provider and in accordance with the determination that the request to authenticate with the first energy provider is in the second manner, the computer system displays, via the display generation component, a user interface (e.g., 624) corresponding to the first energy provider. In some embodiments, after (and/or in response to) detecting the input corresponding to the request to authenticate with the first energy provider and in accordance with the determination that the request to authenticate with the first energy provider is in the second manner, the computer system initiates a process to authenticate with the first energy provider via one or more user interfaces of the first energy provider. In some embodiments, in response to detecting the input corresponding to the request to authenticate with the first energy provider, the computer system displays, via the display generation component, a user interface (e.g., 666) including identity information (e.g., a name, an email address, a telephone number, and/or a physical address) (e.g., 666c1, 666c2, and/or 666c3), account information (e.g., a username, an email address, a name, email address, telephone number, and/or physical address) (e.g., 666c1, 666c2, and/or 666c3), a user interface element (e.g., 666d) to edit the identity information and/or the account information, and/or a user interface element (e.g., 666e) to accept the identity information and/or the account information. In some embodiments, while displaying the user interface including the identity information, the account information, the user interface element to edit the identity information and/or the account information, and/or the user interface element to accept the identity information and/or the account information, the computer system detects, via the input device, an input (e.g., a selection input and/or a non-selection input) (e.g., 605c) corresponding to the user interface element to accept the identity information and/or the account information. In some embodiments, in response to detecting the input corresponding to the user interface element to accept the identity information and/or the account information (and/or after identifying the first energy account with the first energy provider using the identity information and/or the account information), the computer system displays, via the display generation component, a representation (e.g., 668, 668d, and/or 668c) of account information corresponding to the first energy account (and/or a representation of account information corresponding to another energy account, different from the first energy account, of the first energy provider) and/or a user interface element (e.g., 668f) to receive a code from the first energy provider. In some embodiments, the representation of the account information corresponding to the first energy account is at least partially obfuscated. In some embodiments, the first energy account with the first energy provider is identified using the identity information and/or the account information by comparing the identity information and/or the account information to a record associated with the first energy provider before displaying the entry form. In some embodiments, in response to detecting the input corresponding to the user interface element to accept the identity information and/or the account information, the computer system sends the identity information and/or the account information to a device of the first energy provider. In some embodiments, while displaying the user interface element to receive a code from the first energy provider, the computer system detects, via the input device, an input (e.g., 605f2) corresponding to the user interface element to receive a code from the first energy provider. In some embodiments, the entry form to enter a code is displayed in response to detecting the input corresponding to the user interface element to receive a code form the first energy provider. In some embodiments, while displaying the entry form to enter a code, the computer system receives a communication (e.g., an email or text message). In some embodiments, in response to receiving the communication, the computer system displays, via the display generation component, a user interface element (e.g., concurrently with and/or on top of the entry form) to add a first code to the entry form. In some embodiments, while displaying the user interface element to add the first code to the entry form, the computer system detects, via the input device, an input (e.g., a selected input and/or a non-selection input) corresponding to the user interface element to add the first code to the entry form. In some embodiments, in response to detecting the input corresponding to the user interface element to add the first code to the entry form, the computer system adds the first code to the entry form (e.g., as illustrated by 670c in FIG. 6G). In some embodiments, while displaying the entry form to enter a code, the computer system detects, via the input device, a set of one or more inputs (e.g., tap and/or non-tap inputs) corresponding to a second code (e.g., typing the second code). In some embodiments, in response to detecting the set of one or more inputs corresponding to the second code, the computer system displays, via the display generation component, a representation of the second code (e.g., the second code or an obfuscated representation of the second code) (e.g., as illustrated by 670c in FIG. 6G). In some embodiments, in response to adding a correct code to the entry form, the computer system displays, via the display generation component, an indication (e.g., 672 and/or any element within 672, 674 and/or any element within 674, and/or 676 and/or any element within 676) that the first energy account has been verified (e.g., a terms and conditions user interface corresponding to displaying energy usage data). In some embodiments, in response to adding a correct code to the entry form, the computer system ceases display of the entry form. Displaying an entry form for authentication with respect to a given energy account allows the computer system to provide the user with an ability to connect the computer system to an energy account for obtaining information relating to the account, thereby performing an operation when a set of conditions has been met without requiring further user input and/or reducing the number of inputs needed to perform an operation.

In some embodiments, the input is a first input. In some embodiments, before detecting the input corresponding to the request to display energy usage data, the computer system detects an input (e.g., 605a, 605b1, 605b2, 605c, 605d1, 605d2, 605e, 605f1, 605f2, 605h, 605i, and/or 605j) corresponding to a request to authenticate with the first energy provider. In some embodiments, in response to detecting the input corresponding to the request to authenticate with the first energy provider, the computer system displays, via the display generation component a user interface (e.g., 666) including: contact information (e.g., 666c, 666c1, 666c2, and/or 666c3) (e.g., a name, an email address, a telephone number, and/or a physical address) corresponding to a contact card of the computer system; and a user interface element (e.g., 666c) to accept the contact information. In some embodiments, in response to detecting the input corresponding to the request to authenticate with the first energy provider, the user interface includes a user interface element to edit the contact information (e.g., concurrently with the contact information). In some embodiments, while displaying user interface including the contact information and the user interface element to accept the contact information, the computer system detects, via the input device, an input (e.g., 605e, 605f1, and/or 605f2) (e.g., a selection input and/or a non-selection input) corresponding to the user interface element to accept the contact information. In some embodiments, in response to detecting the input (e.g., 605c) corresponding to the user interface element to accept the contact information, the computer system initiates a process to verify an energy account (e.g., of the first energy provider) that corresponds to the contact information. In some embodiments, the process to verify an energy account that corresponds to the contact information includes comparing the contact information to a record of an energy account associated with the first energy provider. In some embodiments, the process to verify an energy account that corresponds to the contact information includes displaying, via the display generation component, a representation (e.g., 668c and/or 668c) of account information corresponding to the first energy account and/or a user interface element to receive a code from the first energy provider. Displaying a user interface with contact information corresponding to a contact card and initiating a process to verify an energy account that corresponds to the contact information allows the computer system to provide the user with an ability to connect the computer system to an energy account based on existing contact information that is stored in the contact card, thereby performing an operation when a set of conditions has been met without requiring further user input, reducing the number of inputs needed to perform an operation, and/or providing improved visual feedback to the user.

In some embodiments, the user interface, including the contact information (e.g., 666c) and the user interface element (e.g., 666e) to accept the contact information, includes a user interface element (e.g., 666d) to edit the contact information (e.g., concurrently with the contact information and/or the user interface element to accept the contact information);

In some embodiments, the input is a first input. In some embodiments, before detecting the input corresponding to the request to display energy usage data, the computer system displays, via the display generation component, a user interface (e.g., 602, 620, 622, 666, 668, 670, 624, 672, and/or 674) to connect to the first energy provider, wherein the user interface to connect to the first energy provider includes a user interface element (e.g., 605e and/or 624f) to sign in to the first energy provider with a password. In some embodiments, the user interface to connect to the first energy provider includes a user interface element to identify an energy account of the first energy provider. In some embodiments, while displaying the user interface element to identify an energy account of the first energy provider, the computer system detects, via the input device, an input (e.g., a selection input and/or a non-selection input) (e.g., 666c) corresponding to the user interface element to identify an energy account of the first energy provider. In some embodiments, in response to detecting the input corresponding to the user interface element to identify an energy account of the first energy provider, the computer system displays, via the display generation component, identity information and/or account information as described above (e.g., 666d and/or 666e). In some embodiments, while displaying the user interface element to sign in to the first energy provider with a password, the computer system detects, via the input device, an input (e.g., 605h) (e.g., a selection input and/or a non-selection input) corresponding to the user interface element to sign in to the first energy provider with a password. In some embodiments, in response to detecting the input corresponding to the user interface element to sign in to the first energy provider with a password, the computer system displays, via the display generation component, a user interface (e.g., 672, 674, 676, 602, 632, and/or 604) (e.g., a webpage or a screen of an application) corresponding to the first energy provider. In some embodiments, the user interface corresponding to the first energy provider is provided by the first energy provider. In some embodiments, the user interface corresponding to the first energy provider includes a field for adding a username, a field for adding a password, and/or a user interface element for signing into the first energy provider (e.g., using the username and/or the password). In some embodiments, after logging into the first energy provider using the user interface corresponding to the first energy provider, the computer system displays, via the display generation component, an indication that the first energy account has been verified (e.g., a terms and conditions user interface corresponding to displaying energy usage data). Providing a user interface of an energy provider to connect to an energy account allows the computer system to provide a user with an ability to provide inputs, such as a password, directly to the energy provider to connect the computer system to the energy account, thereby performing an operation when a set of conditions has been met without requiring further user input and/or reducing the number of inputs needed to perform an operation.

In some embodiments, the indication of the first amount of energy used in the first time period includes first average data (e.g., 638) (e.g., average of all subset values) corresponding to the first time period. In some embodiments, the first average data is an average of values for multiple subsets of data for the first time period. In some embodiments, the multiple subsets of data correspond to a complete first time period. In some embodiments, the multiple subsets of data correspond to a partial first time period (e.g., trending data). In some embodiments, the indication of the second amount of energy used in the second time period includes second average data (e.g., 638) (e.g., average of all subset values) corresponding to the second time period. In some embodiments, the second average data is an average of values for subsets of data for the second time period. In some embodiments, the multiple subsets of data correspond to a complete second time period. In some embodiments, the multiple subsets of data correspond to a partial second time period (e.g., trending data). Outputting average data for time periods allows the computer system to provide information that summarizes the results across a selected time period, thereby reducing the number of inputs needed to perform an operation and/or providing improved visual feedback to the user.

In some embodiments, the indication (e.g., 638) of the first amount of energy used in the first time period includes first total data (e.g., 638) (e.g., sum of all subset values) corresponding to the first time period. In some embodiments, the first total data is a sum of values for multiple subsets of data for the first time period. In some embodiments, the multiple subsets of data correspond to a complete first time period. In some embodiments, the multiple subsets of data correspond to a partial first time period, and the first total data is a projection (e.g., trend projection, forecast, prediction, estimate) of the sum of values for the complete first time period (e.g., hypothetical values) based on the partial first time period (e.g., available values). In some embodiments, the indication (e.g., 638) of the second amount of energy used in the second time period includes second total data (e.g., 638) (e.g., sum of all subset values) corresponding to the second time period. In some embodiments, the second total data is a sum of values for subsets of data for the second time period. In some embodiments, the multiple subsets of data correspond to a complete second time period. In some embodiments, the multiple subsets of data correspond to a partial second time period, and the second total data is a projection (e.g., trend projection, forecast, prediction, estimate) of the sum of values for the complete second time period (e.g., hypothetical values) based on the partial second time period (e.g., available values). Outputting total data for time periods allows the computer system to provide information that summarizes the results across a selected time period, thereby reducing the number of inputs needed to perform an operation and/or providing improved visual feedback to the user.

In some embodiments, the indication (e.g., 638) of the first amount of energy used in the first time period includes an indication of a negative value. In some embodiments, a positive value indicates net consumption of energy usage. In some embodiments, the indication of the positive value extends in a first direction (e.g., upward) away from an axis (e.g., the x-axis) when the value is positive. In some embodiments, the negative value indicates net production (e.g., solar, by solar, wind, and/or other power generation) of energy usage. In some embodiments, the indication of the negative value extends in a second direction (e.g., downward), different from (e.g., opposite) the first direction, away from the axis (e.g., the x-axis) when the value is negative. In some embodiments, in accordance with a determination that a value corresponding to one of multiple subsets of the energy usage data for the first time period is positive, a portion of the first representation corresponding to the one of the multiple subsets of the energy usage data for the first time period is output with a first visual characteristic. In some embodiments, in accordance with a determination that a value corresponding to one of multiple subsets of the energy usage data for the first time period is negative, a portion of the first representation corresponding to the one of the multiple subsets of the energy usage data for the first time period is output with a second visual characteristic different from the first visual characteristic (e.g., while another portion of the first representation is output with the first visual characteristic). In some embodiments, the indication (e.g., 638) of the second amount of energy used in the second time period includes an indication of a negative value. In some embodiments, a positive value indicates net consumption of energy usage. In some embodiments, the indication of the positive value extends in a first direction (e.g., upward) away from an axis (e.g., the x-axis) when the value is positive. In some embodiments, the negative value indicates net production (e.g., solar, by solar, wind, and/or other power generation) of energy usage. In some embodiments, the indication of the negative value extends in a second direction (e.g., downward), different from (e.g., opposite) the first direction, away from the axis (e.g., the x-axis) when the value is negative. In some embodiments, in accordance with a determination that a value corresponding to one of multiple subsets of the energy usage data for the second time period is positive, a portion of the second representation corresponding to the one of the multiple subsets of the energy usage data for the second time period is output with a first visual characteristic. In some embodiments, in accordance with a determination that a value corresponding to one of multiple subsets of the energy usage data for the second time period is negative, a portion of the second representation corresponding to the one of the multiple subsets of the energy usage data for the second time period is output with a second visual characteristic different from the first visual characteristic (e.g., while another portion of the second representation is output with the first visual characteristic). Providing an indication of a negative value allows the computer system to provide to a user information regarding the nature of the information being displayed, thereby performing an operation when a set of conditions has been met without requiring further user input and/or providing improved visual feedback to the user.

In some embodiments, in accordance with a determination that the first time period is of a first type (e.g., 636a, 636b, 636c, 636d, and/or 636e) of time period, the first representation (e.g., 644) (e.g., graph) is displayed with first subset data corresponding to multiple subsets (e.g., smaller increments of time, hours within a day, days within a month, months within 6 months) of the data for the first time period of the first type (e.g., day, month, and/or 6 months). In some embodiments, the first representation is a graph (e.g., scatter plot, bar graph, line chart, pie chart, and/or box plot). In some embodiments, each of the multiple subsets of the data for the first time period of the first type is distributed along a horizontal axis (e.g., x-axis), and a value for each of the multiple subsets of the data for the first time period of the first type extends along a vertical axis (e.g., y-axis). In some embodiments, the multiple subsets of data correspond to a complete first time period of the first type. In some embodiments, the multiple subsets of data correspond to a partial first time period of the first type. In some embodiments, the first representation includes comparison data. In some embodiments, in accordance with a determination that the first time period is of a second type (e.g., 636a, 636b, 636c, 636d, and/or 636e) of time period (e.g., week and/or year) different from the first type of time period, the first representation (e.g., 644) (e.g., graph) is displayed with second subset data, different from the first subset data, corresponding to multiple subsets (e.g., smaller increments of time, hours within a day, days within a month, months within 6 months) of the data for the first time period of the second type. In some embodiments, the first representation is a graph (e.g., scatter plot, bar graph, line chart, pie chart, and/or box plot). In some embodiments, each of the multiple subsets of the data for the first time period of the first type is distributed along a horizontal axis (e.g., x-axis), and a value for each of the multiple subsets of the data for the first time period of the first type extends along a vertical axis (e.g., y-axis). In some embodiments, the multiple subsets of data correspond to a complete first time period of the first type. In some embodiments, the multiple subsets of data correspond to a partial first time period of the first type. In some embodiments, the second representation includes comparison data. Outputting different representations for subsets of time periods based on a selected time period time allows the computer system to provide a user with information that is most relevant to the time period type that is selected, thereby performing an operation when a set of conditions has been met without requiring further user input, reducing the number of inputs needed to perform an operation, and/or providing improved visual feedback to the user.

In some embodiments, the input is a first input. In some embodiments, after displaying the first representation of energy usage data corresponding to the first energy account of the first energy provider, the computer system displays, via the display generation component, a user interface (e.g., 602) including: information (e.g., 662 and/or 662a-662h) corresponding to the first energy provider; and a user interface element (e.g., 662i) to disconnect from the first energy provider (and/or the first energy account). In some embodiments, the information corresponding to the first energy provider includes a name, address, phone number, email address and/or other identifying information of the first energy provider. In some embodiments, while displaying the user interface including the information corresponding to the first energy provider and the user interface element to disconnect from the first energy provider, the computer system detects, via the input device, an input (e.g., 605ab) (e.g., a selection input and/or a non-selection input) corresponding to the user interface element to disconnect from the first energy provider. In some embodiments, detecting the input corresponding to the user interface element to disconnect from the first energy provider includes detecting, via the input device, a tap input on the user interface element to disconnect from the first energy provider. In some embodiments, after detecting the input (e.g., 605ab) corresponding to the user interface element to disconnect from the first energy provider, the computer system initiates a process to disconnect from the first energy provider. In some embodiments, after disconnecting from the first energy provider, the computer system detects, via the input device, a second input (e.g., a selection input and/or a non-selection input) corresponding to (e.g., directed to, at a location of, related to, and/or associated with) a request to display energy usage data. In some embodiments, in response to detecting the second input corresponding to the request to display energy usage data and in accordance with a determination that the first energy provider is disconnected, the computer system foregoes display of energy usage data corresponding to the first energy provider. Displaying a user interface to disconnect from an energy provider allows the computer system to provide a user with an ability to disconnect the computer system from the energy provider without taking additional steps, thereby performing an operation when a set of conditions has been met without requiring further user input, reducing the number of inputs needed to perform an operation, and/or providing additional control options without cluttering the user interface with additional displayed controls.

In some embodiments, the input is a first input. In some embodiments, after displaying the first representation (e.g., 628, 628a-628d, 638, 640, 644, 646, 646b, 646, and/or 648b) of energy usage data corresponding to the first energy account of the first energy provider, the computer system detects that the computer system has been disconnected from the first energy provider (and/or the first energy account). In some embodiments, detection that the computer system has been disconnected from the first energy provider occurs upon an attempt to retrieve information (e.g., energy usage data) from the first energy provider. In some embodiments, detection that the computer system has been disconnected from the first energy provider represents a failure to access information (e.g., energy usage data) and/or adequately provide authorization to the first energy provider. In some embodiments, after (and/or in response to) detecting that the computer system has been disconnected from the first energy provider, the computer system displays, via the display generation component, a user interface element (e.g., 616b) (e.g., within a notification and/or a user interface of an application, such as a home application) corresponding to an option to reconnect to the first energy provider. In some embodiments, while displaying the user interface element corresponding to an option to reconnect to the first energy provider, the computer system detects, via the input device, an input (e.g., 605ac) (e.g., a selection input and/or a non-selection input) corresponding to the user interface element corresponding to an option to reconnect to the first energy provider. In some embodiments, detecting the input corresponding to an option to reconnect to the first energy provider includes detecting, via the input device, a tap input on the user interface element corresponding to an option to reconnect to the first energy provider. In some embodiments, in response to detecting the input (e.g., 605ac) corresponding to an option to reconnect to the first energy provider, the computer system initiates a process to reconnect to the first energy provider. In some embodiments, after reconnecting to the first energy provider, the computer system detects, via the input device, a second input (e.g., 605l, 605m, 605n, 6050, 605p, 605q1, 605q2, 605s, 605f, 605w, and/or 605x) (e.g., a selection input and/or a non-selection input) corresponding to (e.g., directed to, at a location of, related to, and/or associated with) a request to display energy usage data. In some embodiments, in response to detecting the second input (e.g., 605k, 605l, 605m, 605n, 6050, 605p, 605w, 605x, and/or 605y) corresponding to the request to display energy usage data and in accordance with a determination that the first energy provider is connected (and/or reconnected), the computer system displays, via the display generation component, a third representation (e.g., 628, 628a-628d, 638, 640, 644, 646, 646b, 648, and/or 648b) of energy usage data corresponding to the first energy provider. Displaying a user interface element to reconnect to an energy provider when disconnection is detected allows the computer system to provide a user with an ability to reconnect the computer system to the energy provider without taking additional steps, thereby performing an operation when a set of conditions has been met without requiring further user input, reducing the number of inputs needed to perform an operation, and/or providing additional control options without cluttering the user interface with additional displayed controls.

In some embodiments, before detecting the input corresponding to the request to display energy usage data, in accordance with a determination that a location (e.g., geographic and/or physical location) (and/or region) of the computer system (e.g., detected by the computer system such as via GPS and/or set in a setting of the computer system) corresponds to a participating energy provider (e.g., 620a, 622c1, 622c, 622c3, 624a, and/or 676a) (e.g., at FIGS. 6B, 6C, and/or 6D) (e.g., the first energy provider, the second energy provider, and/or another energy provider different from the first energy provider and the second energy provider) (and/or the computer system and/or an application of the computer system is not already connected to an energy provider), the computer system displays, via the display generation component, a user interface element (e.g., 620c, 620f, 622c, 622e, and/or 622f) to initiate a process to connect to a participating energy provider. In some embodiments, before detecting the input corresponding to the request to display energy usage data, in accordance with a determination that the location of the computer system does not correspond to a participating energy provider, the computer system forgoes display of, via the display generation component, the user interface element (e.g., 620c, 620f, 622c, 622e, and/or 622f) to initiate the process to connect to a participating energy provider. In some embodiments, while displaying the user interface element to initiate the process to connect to a participating energy provider, the computer system detects, via the input device, an input (e.g., 605b1, 605b2, 605c, 605d1, and/or 605d2) (e.g., a selection input and/or a non-selection input) corresponding to the user interface element to initiate the process to connect to a participating energy provider. In some embodiments, detecting the input corresponding to the user interface element to initiate the process to connect to a participating energy provider includes detecting, via the input device, a tap input on the user interface element corresponding to the user interface element to initiate the process to connect to a participating energy provider.

In some embodiments, in response to detecting the input (e.g., 620c, 620f, 622c, 622c, and/or 622f) corresponding to the user interface element to initiate the process to connect to a participating energy provider, the computer system initiates the process to connect to a participating energy provider (e.g., 620a, 622c1, 622c, 622c3, 624a, and/or 676a). In some embodiments, in response to detecting the input corresponding to the user interface element to initiate the process to connect to a participating energy provider, the computer system displays (e.g., as part of the process to connect to a participating energy provider), via the display generation component, (1) a user interface element (e.g., 620c, 622c, and/or 616b) to, when selected, connect to a particular energy provider in a first manner (e.g., as described above) and/or (2) a user interface element (e.g., 620f and/or 622f) to, when selected, connect to a particular energy provider in a second manner different from the first manner (e.g., as described above). In some embodiments, in response to detecting the input corresponding to the user interface element to initiate the process to connect to a participating energy provider, the computer system displays (e.g., as part of the process to connect to a participating energy provider), via the display generation component, (1) a user interface element to, when selected, connect to a first energy provider and/or (2) a user interface element to, when selected, connect to a second energy provider different from the first energy provider. Displaying a user interface element to initiate a process to connect to a participating energy provider based on a location allows the computer system to provide a user with an option for connecting to the participating energy provider when possible, thereby performing an operation when a set of conditions has been met without requiring further user input, reducing the number of inputs needed to perform an operation, and/or providing additional control options without cluttering the user interface with additional displayed controls.

In some embodiments, before detecting the input corresponding to the request to display energy usage data, in accordance with a determination that a location (e.g., geographic and/or physical location) (and/or region) of the computer system (e.g., detected by the computer system such as via GPS and/or set in a setting of the computer system) corresponds to the first energy provider (e.g., 622c1, 622c, 622c3, 624a, and/or 676a) and the second energy provider (e.g., 622c1, 622c, 622c3, 624a, and/or 676a), the computer system displays (e.g., at FIGS. 6C and 6D), via the display generation component, a first user interface element (e.g., 622c1, 622c2, and/or 622c3) corresponding to the first energy provider and a second user interface element (e.g., 622c1, 622c2, and/or 622c3) corresponding the second energy provider, wherein the second user interface element is separate from the first user interface element. In some embodiments, before detecting the input corresponding to the request to display energy usage data, in accordance with a determination that the location of the computer system corresponds to a single energy provider (e.g., 620a), the computer system forgoes (e.g., at FIG. 6B) display of, via the display generation component, the first user interface element corresponding to the first energy provider and the second user interface element corresponding the second energy provider. In some embodiments, the computer system detects, via the input device, a set of one or more inputs including an input (e.g., 605c, 605d1, and/or 605d2) (e.g., a selection input and/or a non-selection input) detected while displaying the first user interface element corresponding to the first energy provider and the second user interface element corresponding the second energy provider. In some embodiments, in response to detecting the set of one or more inputs (e.g., 605c, 605d1, and/or 605d2), in accordance with a determination that the input (e.g., 605c, 605d1, and/or 605d2) detected while displaying the first user interface element corresponding to the first energy provider and the second user interface element corresponding the second energy provider corresponds to the first user interface element corresponding to the first energy provider, the computer system initiates a process to connect to the first energy provider. In some embodiments, in response to detecting the set of one or more inputs, in accordance with a determination that the input (e.g., 605c, 605d1, and/or 605d2) detected while displaying the first user interface element corresponding to the first energy provider and the second user interface element corresponding the second energy provider corresponds to the second user interface element corresponding to the second energy provider, the computer system initiates a process to connect to the second energy provider. Displaying a user interface element to initiate a process to connect to one of multiple energy providers based on a location allows the computer system to provide a user with relevant options for connecting to one of multiple participating energy providers, thereby performing an operation when a set of conditions has been met without requiring further user input, reducing the number of inputs needed to perform an operation, and/or providing additional control options without cluttering the user interface with additional displayed controls.

Note that details of the processes described above with respect to method 700 (e.g., FIG. 7) are also applicable in an analogous manner to other methods described herein. For example, method 800 optionally includes one or more of the characteristics of the various methods described above with reference to method 700. For example, the input corresponding to the request to display energy usage data of method 700 can be the input corresponding to the respective time period type of method 800. For brevity, these details are not repeated herein.

FIG. 8 is a flow diagram illustrating a method (e.g., method 800) for outputting different types of comparisons for different time periods in accordance with some embodiments. Some operations in method 800 are, optionally, combined, the orders of some operations are, optionally, changed, and some operations are, optionally, omitted.

As described below, method 800 provides an intuitive way for outputting different types of comparisons for different time periods. Method 800 reduces the cognitive burden on a user, thereby creating a more efficient human-machine interface. For battery-operated computing devices, enabling a user to interact with such devices faster and more efficiently conserves power and increases the time between battery charges.

In some embodiments, method 800 is performed at a computer system (e.g., 600) that is in communication (e.g., wired communication and/or wireless communication) with an input device (e.g., a touch-sensitive surface, a camera, a depth sensor, a microphone, a hardware input mechanism, a rotatable input mechanism, a physical input mechanism, a button, a crown, a knob, a dial, a physical slider, and/or an accelerometer) and an output device (e.g., a display generation component, an audio generation component, and/or a haptic generation component). In some embodiments, the computer system is a watch, a phone, a tablet, a fitness tracking device, a processor, a head-mounted display (HMD) device, a communal device, a media device, a speaker, a television, and/or a personal computing device. In some embodiments, the display generation component is a display screen, a projector, and/or a touch-sensitive display. In some embodiments, the audio generation component is a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output.

The computer system detects (802), via the input device, an input (e.g., 605m, 605n, 6050, and/or 605p) (e.g., a selection input and/or a non-selection input) corresponding to a respective time period type (e.g., 636a, 636b, 636c, 636d, and/or 636c) (e.g., day, week, month, 6 months, year). In some embodiments, detecting the input corresponding to the respective time period type includes detecting (e.g., via a touch-sensitive surface, a hardware input mechanism, a rotatable input mechanism, a physical input mechanism, a button, a crown, a knob, a dial, a physical slider, or other type of input device) an input corresponding to selection of the respective time period type, such as a tap input on a user interface element representing the respective time period type, where different user interface elements represent different time period types. In some embodiments, detecting the input corresponding to the respective time period type includes detecting an input as described above with respect to the input corresponding to the request to display energy usage data of method 700. In such embodiments, the respective time period type can be a default time period type for outputting initial data, a last-used time period type, and/or a time period type configured for the computer system.

In response to (804) detecting the input (e.g., 605m, 605n, 6050, and/or 605p) corresponding to the respective time period type (e.g., 636a, 636b, 636c, 636d, and/or 636c), in accordance with a determination that the respective time period type is a first type (e.g., 636a, 636b, 636c, 636d, and/or 636c) (e.g., day, month, and/or 6 months), the computer system outputs (806), via the output device, a comparison (e.g., 640) (e.g., percentage change and/or difference in amounts) of data (e.g., energy usage data, oil usage data, gas usage data, electrical usage data, health data, and/or workout data) for a first time period (e.g., a current or past time period) of the first type (e.g., a current or past day, a current or past month, or a current or past 6 months) relative to a second time period (e.g., a preceding or following time period) of the first type (e.g., the same day of the preceding week, the same month of the preceding year, the same 6 months of the preceding year), wherein the second time period of the first type is different from (e.g., precedes or follows) the first time period of the first type by more than a length of a time period of the first type (e.g., not the immediately preceding or following time period of the first type). In some embodiments, the comparison of data for the first time period of the first type relative to the second time period of the first type includes a numerical value. In some embodiments, the comparison of data for the first time period of the first type relative to the second time period of the first type includes a display of graphical information (e.g., 644). In some embodiments, the comparison of data for the first time period of the first type relative to the second time period of the first type is output with other data for the first time period of the first type (e.g., and not output with other data for the second time period of the first type).

In response to (804) detecting the input corresponding to the respective time period type, in accordance with a determination that the respective time period type is a second type (e.g., 636a, 636b, 636c, 636d, and/or 636c) (e.g., week and/or year), different than the first type, the computer system outputs (808), via the output device, a comparison (e.g., 640) (e.g., percentage change and/or difference in amounts) of data for a first time period (e.g., a current or past time period) of the second type relative to a second time period (e.g., a preceding or following time period) of the second type (e.g., comparison of the current week to the immediately preceding week or comparison of the current year to the immediately preceding year), wherein the second time period of the second type is different from (e.g., precedes or follows) the first time period of the second type by a length of a time period of the second type (e.g., an immediately adjacent (e.g., preceding or following) time period of the second type). In some embodiments, the comparison of data for the first time period of the second type relative to the second time period of the second type includes a numerical value. In some embodiments, the comparison of data for the first time period of the second type relative to the second time period of the second type includes a display of graphical information (e.g., 644). In some embodiments, the second time period of the first type is different from the first time period of the first type by the length of a time period of the second type. In some embodiments, the comparison of data for the first time period of the second type relative to the second time period of the second type is output with other data for the first time period of the second type (e.g., and not output with other data for the second time period of the second type). Outputting different comparisons based on what time period type is selected allows the computer system to provide relevant and/or informative comparisons when outputting data without requiring a user to navigate between different sets of data to make their own comparison, thereby reducing the number of inputs needed to perform an operation, performing an operation when a set of conditions has been met without requiring further user input, and/or providing improved visual feedback to the user.

In some embodiments, the second time period of the first type (e.g., 636a, 636b, 636c, 636d, and/or 636e) is different from (e.g., precedes or follows) the first time period of the first type (e.g., 636a, 636b, 636c, 636d, and/or 636c) by a time period of a third type (e.g., 636a, 636b, 636c, 636d, and/or 636c) different from a time period of the first type and a time period of the second type. In some embodiments, the second time period of the first type is within a time period of the third type (e.g., week or year). In some embodiments, a time period of the third type is of greater duration than a time period of the first type and/or a time period of the second type. Providing adjacent time period types for outputting comparisons allows the computer system to provide comparisons that use time periods from other time period types for current output, thereby reducing the number of inputs needed to perform an operation, performing an operation when a set of conditions has been met without requiring further user input, and/or providing improved visual feedback to the user.

In some embodiments, the second time period of the first type (e.g., 636a, 636b, 636c, 636d, and/or 636c) is a time period that is within the second time period of the second type (e.g., 636a, 636b, 636c, 636d, and/or 636e) (e.g., the preceding week or the preceding year). In some embodiments, the second time period of the second type includes multiple increments that each represent a time period of the first type (e.g., day, month, and/or 6 months). In some embodiments, a time period of the second type (e.g., week and/or year) is shorter than a time period of the first type (e.g., day, month, and/or 6 months). In some embodiments, the first time period of the first type is a time period that is within the first time period of the second type. Providing non-adjacent time periods that are within time periods of another time period of another type for outputting comparisons allows the computer system to provide comparisons that more closely relate to other time periods from other time period types for current output, thereby reducing the number of inputs needed to perform an operation, performing an operation when a set of conditions has been met without requiring further user input, and/or providing improved visual feedback to the user.

In some embodiments, the data for the first time period of the first type (e.g., 636a, 636b, 636c, 636d, and/or 636c) is (and/or includes) energy usage data (e.g., oil usage, gas usage, and/or electrical usage data). In some embodiments, the energy usage data is a basis for providing an indication, representation, graph, value, and/or other output (e.g., 628, 638, 640, 642, 644, 646b, 648b, and/or 652). In some embodiments, the energy usage data includes information and/or a measurement corresponding to an amount of energy consumed. In some embodiments, the energy usage data includes information and/or a measurement corresponding to an amount of energy produced (e.g., by solar, wind, and/or other power generation). In some embodiments, the data for the first time period of the first type, for the second time period of the first type, for the first time period of the second type, and/or for the second time period of the second type is and/or includes health data. In some embodiments, the data for the first time period of the first type, for the second time period of the first type, for the first time period of the second type, and/or for the second time period of the second type is and/or includes information and/or a measurement corresponding to height, weight, body mass index, body fat percentage, electrodermal activity, waist circumference, wrist temperature, blood pressure, fitness level (e.g., VO2 max), electrocardiogram, heart rate, heart rate variability, resting heart rate, walking heart rate average, blood oxygen, respiratory rate, and/or sleep activity. In some embodiments, the data or the first time period of the first type, for the second time period of the first type, for the first time period of the second type, and/or for the second time period of the second type is and/or includes workout data corresponding to a user and/or an activity (e.g., workout, event, and/or session). In some embodiments, the data is and/or includes information and/or a measurement corresponding to an activity, steps taken, workout duration, calories burned, and/or distance travelled (e.g., running, walking, cycling, and/or swimming). In some embodiments, the data for the second time period of the first type is and/or includes energy usage data. In some embodiments, the data for the first time period of the second type is and/or includes energy usage data. In some embodiments, the data for the second time period of the second type is and/or includes energy usage data.

In some embodiments, the comparison (e.g., 640) of the data for the first time period of the first type relative to the second time period of the first type is output as a first percentage (and/or a first representation of a percentage) (e.g., instead of and/or not as an amount). In some embodiments, the comparison of the data for the first time period of the first type relative to the second time period of the first type is output as a ratio of total energy usage data across the first time period of the first type to total energy usage data across the second time period of the first type. In some embodiments, the first percentage includes an indication of a negative value when the energy usage in the second time period of the first type exceeds the energy usage in the first time period of the first type. In some embodiments, the first percentage includes an indication of a positive value when the energy usage in the first time period of the first type exceeds the energy usage in the second time period of the first type. In some embodiments, the comparison (e.g., 640) of data for the first time period of the second type relative to the second time period of the second type is output as a second percentage (and/or a second representation of a percentage) (e.g., instead of and/or not as an amount). In some embodiments, the second percentage is the same as or different from the first percentage. In some embodiments, the comparison of data for the first time period of the second type relative to the second time period of the second type is output as a ratio of total energy usage data across the first time period of the second type to total energy usage data across the second time period of the second type. In some embodiments, the second percentage includes an indication of a positive value when the energy usage in the first time period of the second type exceeds the energy usage in the second time period of the second type. In some embodiments, the second percentage includes an indication of a negative value when the energy usage in the second time period of the second type exceeds the energy usage in the first time period of the second type. In some embodiments, the comparison of the data for the first time period of the first type relative to the second time period of the first type includes an indication of a number and an indication of a unit of measurement. In some embodiments, the comparison of the data for the first time period of the first type relative to the second time period of the first type includes a numerical value. In some embodiments, the comparison of the data for the first time period of the second type relative to the second time period of the second type includes an indication of a number and an indication of a unit of measurement. In some embodiments, the comparison of the data for the first time period of the second type relative to the second time period of the second type includes a numerical value. Outputting a comparison that uses a percentage allows the computer system to consolidate two pieces of information into a single metric that is relevant to both and comparable across different sets of data, thereby reducing the number of inputs needed to perform an operation and/or providing improved visual feedback to the user.

In some embodiments, the comparison (e.g., 640) of data for the first time period of the first type relative to the second time period of the first type is output as a first amount (and/or a first representation of an amount) (e.g., instead of and/or not as a percentage). In some embodiments, the comparison of data for the first time period of the first type relative to the second time period of the first type is output as a difference between total energy usage data across the first time period of the first type and total energy usage data across the second time period of the first type. In some embodiments, the first amount includes an indication of a positive value when the net energy usage in the first time period of the first type exceeds the net energy usage in the second time period of the first type. In some embodiments, the first amount includes an indication of a negative value when the net energy usage in the second time period of the first type exceeds the net energy usage in the first time period of the first type. In some embodiments, the comparison (e.g., 640) of data for the first time period of the second type relative to the second time period of the second type is output as a second amount (and/or a second representation of an amount) (e.g., instead of and/or not as a percentage). In some embodiments, the second percentage is the same as or different from the first percentage. In some embodiments, the comparison of data for the first time period of the second type relative to the second time period of the second type is output as a difference between total energy usage data across the first time period of the second type and total energy usage data across the second time period of the second type. In some embodiments, the second amount includes an indication of a positive value when the net energy usage in the first time period of the second type exceeds the net energy usage in the second time period of the second type. In some embodiments, the second amount includes an indication of a negative value when the net energy usage in the second time period of the second type exceeds the net energy usage in the first time period of the second type. In some embodiments, the comparison of the data for the first time period of the first type relative to the second time period of the first type includes an indication of a number and an indication of a unit of measurement. In some embodiments, the comparison of the data for the first time period of the first type relative to the second time period of the first type includes a numerical value. In some embodiments, the comparison of the data for the first time period of the second type relative to the second time period of the second type includes an indication of a number and an indication of a unit of measurement. In some embodiments, the comparison of the data for the first time period of the second type relative to the second time period of the second type includes a numerical value. Outputting a comparison that uses an amount allows the computer system to show information as absolute amounts that are useful for comparisons across different sets of data, thereby reducing the number of inputs needed to perform an operation and/or providing improved visual feedback to the user.

In some embodiments, in accordance with a determination that a first set of one or more criteria is satisfied, the comparison (e.g., 640) of the data for the first time period of the first type relative to the second time period of the first type is output as an amount (e.g., feet, miles, heartbeats, exercises, calories, and/or kWh) (e.g., instead of and/or not as a percentage). In some embodiments, in response to detecting the input corresponding to the respective time period type and in accordance with the determination that the first set of one or more criteria is satisfied, the computer system outputs, via the output device, an indication indicating that net energy was provided to an electrical grid. In some embodiments, the first set of one or more criteria includes and/or is a criterion that is satisfied when a subset (e.g., of multiple subsets, such as hours within a day, days within a week, days within a month, and/or months within a year) of the data for the first time period of the first type includes a negative value (e.g., more energy was provided to an electrical grid than used). In some embodiments, the first set of one or more criteria includes and/or is a criterion that is satisfied when the data for the first time period of the first type is a first type of data (e.g., solar) and not a second type of data (e.g., non-solar, such as oil and/or gas) different from the first type of data. In some embodiments, the first set of one or more criteria includes and/or is a criterion that is satisfied when the data for the first time period of the first type corresponds to a first type of energy (e.g., solar) and not a second type of energy (e.g., non-solar, such as oil and/or gas). In some embodiments, the first set of one or more criteria includes and/or is a criterion that is satisfied when an account corresponding to the data for the first time period of the first type is configured as, associated with, and/or set up in a first manner (e.g., solar) and not a second manner different from the first manner (e.g., non-solar, such as oil and/or gas). In some embodiments, the first set of one or more criteria includes and/or is a criterion that is satisfied when a subset of multiple subsets of data for a third time period of the first type, different from the first time period of the first type and/or the second time period of the first type includes a negative value. In some embodiments, in accordance with a determination that a second set of one or more criteria, different from the first set of one or more criteria, is satisfied, the comparison (e.g., 640) of the data for the first time period of the second type relative to the second time period of the second type is output as a percentage (e.g., instead of and/or not as an amount). In some embodiments, in response to detecting the input corresponding to the respective time period type and in accordance with the determination that the second set of one or more criteria is satisfied, the computer system outputs, via the output device, an indication indicating that net energy was received from an electrical grid. In some embodiments, the second set of one or more criteria includes and/or is a criterion that is satisfied when a subset of multiple subsets (e.g., hours within a day, days within a week, days within a month, months within a year) of the data for the first time period of the first type does not include a negative value (and/or each subset of multiple subsets of the data for the first time period includes a positive value and/or more energy was used than sent to the electrical grid). In some embodiments, the second set of one or more criteria includes and/or is a criterion that is satisfied when the data for the first time period of the first type is the second type of data. In some embodiments, the second set of one or more criteria includes and/or is a criterion that is satisfied when the data for the first time period of the first type corresponds to the second type of energy. In some embodiments, the second set of one or more criteria includes and/or is a criterion that is satisfied when an account corresponding to the data for the first time period of the first type is configured as, associated with, and/or set up in the second manner. In some embodiments, the second set of one or more criteria includes and/or is a criterion that is satisfied when a subset of multiple subsets of data for a third time period of the second type, different from the first time period of the second type and/or the second time period of the second type, does not include a negative value. Sometimes outputting a percentage and other times outputting an amount enables the computer system to select a format of data that is comprehensible to a user while still being a single value, thereby performing an operation when a set of conditions has been met without requiring further user input and/or providing improved visual feedback to the user.

In some embodiments, in conjunction with (e.g., in response to, before, after, and/or while) detecting the input corresponding to the respective time period type, the computer system outputs, via the output device, a user interface element (e.g., 636) (e.g., a menu, a slider, and/or a group of one or more individual user interface elements) including a representation (e.g., 636a, 636b, 636c, 636d, and/or 636c) of the first type (e.g., including an indication identification of the first type, such as “D,” “W,” “M,” “6M,” and/or “Y”) and a representation (e.g., 636a, 636b, 636c, 636d, and/or 636e) of the second type (e.g., including an indication identification of the second type, such as “D,” “W,” “M,” “6M,” and/or “Y”), wherein the representation of the second type is separate (and/or different) from the representation of the first type. In some embodiments, the input corresponding to the respective time period type includes an input at and/or directed to the user interface element. In some embodiments, in response to detecting the input corresponding to the respective time period type and in accordance with the determination that the respective time period type is the first type, the computer system emphasizes (e.g., highlights, bolds, and/or visually distinguishes) the representation of the first type from the representation of the second type. In some embodiments, in response to detecting the input corresponding to the respective time period type and in accordance with the determination that the respective time period type is the second type, the computer system emphasizes (e.g., highlights, bolds, and/or visually distinguishes) the representation of the second type from the representation of the first type. In some embodiments, user interface element includes a representation of a third type different from the first type and the second type (e.g., separate and/or different from the representation of the first type and/or the representation of the second type) while including the representation of the first type and the representation of the second type. In some embodiments, in response to detecting an additional input corresponding to a different representation of the user interface element, the computer system outputs, via the output device, an additional comparison of data corresponding to a time period type corresponding to the different representation (e.g., rather than a previous comparison of data). Outputting a user interface element that includes representations of different types of time period allows the computer system to provide selectable options for a user to change the time period type to be applied to the comparison of data, thereby reducing the number of inputs needed to perform an operation, providing additional control options without cluttering the user interface with additional displayed controls, and/or providing improved visual feedback to the user.

In some embodiments, in response to detecting the input corresponding to the respective time period type, in accordance with the determination that the respective time period type is the first type, the computer system outputs, via the output device, first average data (e.g., 638) (e.g., average of all subset values) corresponding to the first time period of the first type. In some embodiments, the first average data is output with the comparison of the data for the first time period of the first type relative to the second time period of the first type. In some embodiments, the first average data is an average of values for multiple subsets of data for the first time period of the first type. In some embodiments, the multiple subsets of data correspond to a complete first time period of the first type. In some embodiments, the multiple subsets of data correspond to a partial first time period of the first type (e.g., trending data). In some embodiments, in response to detecting the input corresponding to the respective time period type, in accordance with the determination that the respective time period type is the second type, the computer system outputs, via the output device, second average data (e.g., 638) (e.g., average of all subset values) corresponding to the first time period of the second type. In some embodiments, the second average data is output with the comparison of the data for the first time period of the second type relative to the second time period of the second type. In some embodiments, the second average data is an average of values for subsets of data for the first time period of the second type. In some embodiments, the multiple subsets of data correspond to a complete first time period of the second type. In some embodiments, the multiple subsets of data correspond to a partial first time period of the second type (e.g., trending data). Outputting average data for time periods allows the computer system to provide information that summarizes the results across a selected time period, thereby reducing the number of inputs needed to perform an operation and/or providing improved visual feedback to the user.

In some embodiments, in response to detecting the input corresponding to the respective time period type, in accordance with the determination that the respective time period type is the first type, the computer system outputs, via the output device, first total data (e.g., 638) (e.g., sum of all subset values) corresponding to the first time period of the first type. In some embodiments, the first total data is output with the comparison of the data for the first time period of the first type relative to the second time period of the first type. In some embodiments, the first total data is a sum of values for multiple subsets of data for the first time period of the first type. In some embodiments, the multiple subsets of data correspond to a complete first time period of the first type. In some embodiments, the multiple subsets of data correspond to a partial first time period of the first type, and the first total data is a projection (e.g., trend projection, forecast, prediction, estimate) of the sum of values for the complete first time period of the first type (e.g., hypothetical values) based on the partial first time period of the first type (e.g., available values). In some embodiments, in response to detecting the input corresponding to the respective time period type, in accordance with the determination that the respective time period type is the second type, the computer system outputs, via the output device, second total data (e.g., 638) (e.g., sum of all subset values) corresponding to the first time period of the second type. In some embodiments, the second total data is output with the comparison of the data for the first time period of the second type relative to the second time period of the second type. In some embodiments, the second total data is a sum of values for subsets of data for the first time period of the second type. In some embodiments, the multiple subsets of data correspond to a complete first time period of the second type. In some embodiments, the multiple subsets of data correspond to a partial first time period of the second type, and the second total data is a projection (e.g., trend projection, forecast, prediction, estimate) of the sum of values for the complete first time period of the second type (e.g., hypothetical values) based on the partial first time period of the second type (e.g., available values). Outputting total data for time periods allows the computer system to provide information that summarizes the results across a selected time period, thereby reducing the number of inputs needed to perform an operation and/or providing improved visual feedback to the user.

In some embodiments, in response to detecting the input corresponding to the respective time period type (e.g., 636a, 636b, 636c, 636d, and/or 636e), in accordance with the determination that the respective time period type is the first type, the computer system outputs, via the output device, a first representation (e.g., 644) (e.g., graph) of first subset data corresponding to multiple subsets (e.g., smaller increments of time, hours within a day, days within a month, months within 6 months) of the data for the first time period of the first type. In some embodiments, the first representation is a graph (e.g., scatter plot, bar graph, line chart, pic chart, and/or box plot). In some embodiments, each of the multiple subsets of the data for the first time period of the first type is distributed along a horizontal axis (e.g., x-axis), and a value for each of the multiple subsets of the data for the first time period of the first type extends along a vertical axis (e.g., y-axis). In some embodiments, the multiple subsets of data correspond to a complete first time period of the first type. In some embodiments, the multiple subsets of data correspond to a partial first time period of the first type. In some embodiments, each of the multiple subsets of the data for the first time period of the first type is a time period of a third type, different than the first type and the second type. In some embodiments, in response to detecting the input corresponding to the respective time period type, in accordance with the determination that the respective time period type is the second type, the computer system outputs, via the output device, a second representation (e.g., 644) (e.g., graph) of second subset data corresponding to multiple subsets (e.g., smaller increments of time, days within a week, months within a year) of the data for the first time period of the second type. In some embodiments, the second representation is a graph (e.g., scatter plot, bar graph, line chart, pic chart, and/or box plot). In some embodiments, each of the multiple subsets of the data for the first time period of the second type is distributed along a horizontal axis (e.g., x-axis), and a value for each of the multiple subsets of the data for the first time period of the second type extends along a vertical axis (e.g., y-axis). In some embodiments, the multiple subsets of data correspond to a complete first time period of the second type. In some embodiments, the multiple subsets of data correspond to a partial first time period of the second type. In some embodiments, each of the multiple subsets of the data for the first time period of the second type is a time period of the first type. In some embodiments, each of the multiple subsets of the data for the first time period of the second type is a time period of a third type, different than the first type and the second type. Outputting representations of subset data for time periods allows the computer system to provide specific information within a selected time period, thereby reducing the number of inputs needed to perform an operation and/or providing improved visual feedback to the user.

In some embodiments, in accordance with a determination that a value (e.g., usage amount) corresponding to one of the multiple subsets of the data for the first time period of the first type is positive (e.g., indicating net consumption of energy), a portion of the first representation (e.g., 644) corresponding to the one of the multiple subsets of the data for the first time period of the first type is output with a first visual characteristic (e.g., feature, color, emphasis, shape, size, and/or highlight). In some embodiments, the value indicates net consumption of energy when the value is positive. In some embodiments, the value can extend in a first direction (e.g., upward) away from an axis (e.g., the x-axis) when the value is positive. In some embodiments, in accordance with a determination that a value corresponding to one of the multiple subsets of the data for the first time period of the second type is positive, a portion of the second representation corresponding to the one of the multiple subsets of the data for the first time period of the second type is output with the first visual characteristic. In some embodiments, in accordance with a determination that the value corresponding to the one of the multiple subsets of the data for the first time period of the first type is negative (e.g., indicating net production of energy), the portion of the first representation (e.g., 644) corresponding to the one of the multiple subsets of the data for the first time period of the first type is output with a second visual characteristic (e.g., feature, color, emphasis, shape, size, and/or highlight) different from the first visual characteristic (e.g., without outing the portion of the first representation corresponding to the one of the multiple subsets of the data for the first time period of the first type is output with the first visual characteristic). In some embodiments, the value indicates net production (e.g., solar, by solar, wind, and/or other power generation) of energy when the value is negative. In some embodiments, the value can extend in a second direction (e.g., downward), different than (e.g., opposite) the first direction, away from the axis (e.g., the x-axis) when the value is negative. In some embodiments, in accordance with a determination that the value corresponding to one of the multiple subsets of the data for the first time period of the second type is negative, the portion of the second representation corresponding to the one of the multiple subsets of the data for the first time period of the second type is output with the second visual characteristic (e.g., while another portion of the second representation is output with the first visual characteristic). Outputting different visual characteristics of representations for positive and negative values allows the computer system to provide information that is readily comprehensible to the user observing the representation, thereby reducing the number of inputs needed to perform an operation and/or providing improved visual feedback to the user.

In some embodiments, the input is a first input (e.g., 605m, 605n, 6050, and/or 605p). In some embodiments, in response to detecting the first input (e.g., 605m, 605n, 6050, and/or 605p) corresponding to the respective time period type, the computer system outputs, via the output device, a first representation (e.g., 628, 638, 640, 642, 644, 646b, 648b, and/or 652) (e.g., total data for the first time period of the first type, sum of all subset values, and/or graph depicting subsets) of energy usage within the first time period of the first type. In some embodiments, the first representation indicates a total energy usage that is attributable to a combination of multiple usage types. In some embodiments, the first representation of energy usage within the first time period of the first type is output while outputting the comparison of the data for the first time period of the first type relative to the second time period of the first type. In some embodiments, the first representation is a representation of total data for the first time period of the first type. In some embodiments, the first representation is a graph corresponding to the first time period of the first type. In some embodiments, the first representation is a sum of all subset values in the graph. In some embodiments, in response to detecting the first input corresponding to the respective time period type, the computer system outputs, via the output device, a user interface element (e.g., 646 and/or 648) (e.g., a menu, a slider, and/or a group of one or more individual user interface elements) corresponding to multiple usage types (e.g., time-of-use (TOU) types, rates, peak, partial-peak, and/or off-peak). In some embodiments, each of the multiple usage types represents a subset of the total energy usage within the first time period of the first type. In some embodiments, after (and/or while) outputting the user interface element (e.g., 646 and/or 648) corresponding to the multiple usage types (and/or after and/or while outputting the first representation of energy usage within the first time period of the first type), the computer system detects, via the input device, a second input (e.g., 605w and/or 605x) (e.g., a selection input and/or a non-selection input) corresponding to a respective usage type of the multiple usage types. In some embodiments, detecting the second input corresponding to the respective usage type of the multiple usage types includes detecting, via the input device, an input corresponding to selection of a user interface element, such as a tap input on a user interface element representing a usage type, where different user interface elements represent different usage types. In some embodiments, the user interface element corresponding to the multiple usage types is output while outputting the comparison of the data for the first time period of the first type relative to the second time period of the first type. In some embodiments, the user interface element includes a representation for each of the multiple usage types. In some embodiments, in response to detecting the second input (e.g., 605w and/or 605x) corresponding to the respective usage type of the multiple usage types, in accordance with a determination that the second input corresponds to a first one (e.g., 646 and/or 648) of the multiple usage types, the computer system outputs, via the output device, a second representation (e.g., 628, 638, 640, 642, 644, 646b, 648b, and/or 652) (e.g., portion of data for the first time period of the first type, sum of certain subset values, and/or graph depicting subsets) of the energy usage within the first time period of the first type that corresponds to the first one of the multiple usage types (e.g., portion of the total energy usage that is attributable to the selected usage type). In some embodiments, in response to detecting the second input corresponding to the first one of the multiple usage types, the computer system maintains display of the user interface element. In some embodiments, in response to detecting the second input corresponding to the first one of the multiple usage types, the computer system emphasizes (e.g., highlights, bolds, and/or visually distinguishes) a representation of the first one of the multiple usage types within the user interface element. In some embodiments, the second representation indicates a portion of the total energy usage that is attributable to the first one of the multiple usage types. In some embodiments, the second representation is and/or includes a numeric value. In some embodiments, the second representation is and/or includes a modified graph. In some embodiments, while indicating the portion of the total energy usage that is attributable to the selected usage type, the second representation includes at least a portion of the first representation (e.g., as an indication of a total energy usage that is attributable to a combination of all available usage types). In some embodiments, the second representation includes both the total energy usage and the portion thereof that is attributable to a particular usage type. In some embodiments, the computer system detects an additional input with respect to another usage type of the multiple usage types and updates the representation to correspond to the other usage type of the multiple usage types. In some embodiments, in response to detecting the second input corresponding to the respective usage type of the multiple usage types and in accordance with the determination that the second input corresponds to the first one of the multiple usage types, the computer system ceases output of at least a portion of the first representation (and/or ceases output of the first representation). In some embodiments, in response to detecting the second input corresponding to the respective usage type of the multiple usage types, in accordance with a determination that the second input corresponds to a second one (e.g., 646 and/or 648), different from the first one, of the multiple usage types, the computer system outputs, via the output device, a third representation (e.g., 628, 638, 640, 642, 644, 646b, 648b, and/or 652) (e.g., portion of data for the first time period of the first type, sum of certain subset values, and/or graph depicting subsets) of the energy usage within the first time period of the first type that corresponds to the second one of the multiple usage types (e.g., portion of the total energy usage that is attributable to the selected usage type). In some embodiments, in response to detecting the second input corresponding to the second one of the multiple usage types, the computer system maintains display of the user interface element. In some embodiments, in response to detecting the second input corresponding to the second one of the multiple usage types, the computer system emphasizes (e.g., highlights, bolds, and/or visually distinguishes) a representation of the second one of the multiple usage types within the user interface element. In some embodiments, the second representation indicates a portion of the total energy usage that is attributable to the second one of the multiple usage types. In some embodiments, the second representation is and/or includes a numeric value. In some embodiments, the second representation is and/or includes a modified graph. In some embodiments, while indicating the portion of the total energy usage that is attributable to the selected usage type, the third representation includes at least a portion of the first representation (e.g., as an indication of a total energy usage that is attributable to a combination of all available usage types). In some embodiments, the third representation includes both the total energy usage and the portion thereof that is attributable to a particular usage type. In some embodiments, the computer system detects an additional input with respect to the another usage type of the multiple usage types and updates the representation to correspond to the other usage type of the multiple usage types. In some embodiments, in response to detecting the second input corresponding to the respective usage type of the multiple usage types and in accordance with a determination that the second input corresponds to the second one of the multiple usage types, the computer system ceases output of at least a portion of the first representation (and/or ceases display of the first representation). Outputting selectable user interface elements for usage types and output different representations for different usage types allows the computer system to provide the user with options to select information to be displayed based on the selection of usage type, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, the input is a first input (e.g., 605m, 605n, 6050, and/or 605p). In some embodiments, while outputting the comparison of the data for the first time period of the first type relative to the second time period of the first type, the computer system detects, via the input device, a second input (e.g., 605q1, 605q2, 605s, and/or 605f) (e.g., a swipe input and/or a non-swipe input). In some embodiments, detecting the second input includes detecting, via the input device, an input corresponding to a request to output a different time. In some embodiments, a non-swipe input includes a verbal input, an audible request, an audible command, an audible statement, a tap input, a hold-and-drag input, a gaze input, an air gesture, mouse movement, and/or a mouse click. In some embodiments, in response to detecting the second input, the computer system outputs, via the output device, a comparison (e.g., 640) (e.g., percentage change and/or difference in amounts) of data (e.g., energy usage data, oil usage data, gas usage data, electrical usage data, health data, and/or workout data) for a third time period of the first type, different from the first time period of the first type and the second time period of the first type, relative to a fourth time period (e.g., a preceding or following time period) of the first type, wherein the fourth time period of the first type is different from (e.g., precedes or follows) the third time period of the first type by more than a length of a time period of the first type (e.g., not the immediately preceding or following time period of the first type). In some embodiments, the comparison of data for the second time period of the first type relative to the third time period of the first type includes a numerical value. In some embodiments, the comparison of data for the second time period of the first type relative to the third time period of the first type includes a display of graphical information (e.g., 644). In some embodiments, the comparison of data for the second time period of the first type relative to the third time period of the first type is output with other data for the first time period of the first type (e.g., and not output with other data for the second time period of the first type). In some embodiments, the third time period of the first type is different from (e.g., precedes or follows) the second time period of the first type by more than the length of the time period of the first type (e.g., not the immediately preceding or following time period of the first type). In some embodiments, the computer system outputs a representation of total data for the first time period of the first type. In some embodiments, the representation is a graph corresponding to the first time period of the first type. In some embodiments, the representation is a sum of all subset values in the graph. In some embodiments, the second input is provided and detected at the representation. In some embodiments, in response to detecting the second input, the computer system modifies the representation (e.g., updated). In some embodiments, the second input is directional. In some embodiments, in response to a detection that the second input is in a first direction (e.g., left or right), the computer system modifies the representation to correspond to data for a time period in a first chronological direction (e.g., before or after) with respect to the first time period of the first type. In some embodiments, in response to a detection that the second input is in a second direction (e.g., left or right), different than (e.g., opposite) the first direction, the computer system modifies the representation to correspond to data for a time period in a second chronological direction (e.g., before or after), different than (e.g., opposite) the first chronological direction, with respect to the first time period of the first type. In some embodiments, the modified representation is a modified graph. In some embodiments, the second input is a swipe input. In some embodiments, the second input is a tap input (e.g., at a selectable element corresponding to a chronological direction for modifying the representation). In some embodiments, the second input is a non-swipe input. In some embodiments, a non-swipe input includes a verbal input, an audible request, an audible command, an audible statement, a tap input, a hold-and-drag input, a gaze input, an air gesture, mouse movement, and/or a mouse click. In some embodiments, while outputting the comparison of the data for the first time period of the second type relative to the second time period of the second type, the computer system detects, via the input device, a third input (e.g., 605q1, 605q2, 605s, and/or 605f) (e.g., a swipe input and/or a non-swipe input). In some embodiments, detecting the third input includes detecting, via the input device, an input corresponding to a request to output a different time. In some embodiments, a non-swipe input includes a verbal input, an audible request, an audible command, an audible statement, a tap input, a hold-and-drag input, a gaze input, an air gesture, mouse movement, and/or a mouse click. In some embodiments, in response to detecting the third input, the computer system outputs, via the output device, a comparison (e.g., 640) (e.g., percentage change and/or difference in amounts) of data (e.g., energy usage data, oil usage data, gas usage data, electrical usage data, health data, and/or workout data) for the second time period of the second type relative to a third time period (e.g., a preceding or following time period) of the second type, wherein the third time period of the second type is different from (e.g., precedes or follows) the second time period of the second type by the length of the time period of the second type (e.g., an immediately adjacent (e.g., preceding or following) time period of the second type). In some embodiments, the comparison of data for the second time period of the second type relative to the third time period of the second type includes a numerical value. In some embodiments, the comparison of data for the second time period of the second type relative to the third time period of the second type includes a display of graphical information (e.g., 644). In some embodiments, the comparison of data for the second time period of the second type relative to the third time period of the second type is output with other data for the second time period of the second type (e.g., and not output with other data for the third time period of the second type). In some embodiments, the third time period of the second type is different from (e.g., precedes or follows) the second time period of the second type by the length of the time period of the second type (e.g., an immediately adjacent (e.g., preceding or following) time period of the second type). In some embodiments, the computer system outputs a representation of total data for the first time period of the second type. In some embodiments, the representation is a graph corresponding to the first time period of the second type. In some embodiments, the representation is a sum of all subset values in the graph. In some embodiments, the third input is provided and detected at the representation. In some embodiments, in response to detecting the third input, the computer system modifies the representation (e.g., updated). In some embodiments, the third input is directional. In some embodiments, in response to a detection that the third input is in a first direction (e.g., left or right), the computer system modifies the representation to correspond to data for a time period in a first chronological direction (e.g., before or after) with respect to the first time period of the second type. In some embodiments, in response to a detection that the third input is in a second direction (e.g., left or right), different than (e.g., opposite) the first direction, the computer system modifies the representation to correspond to data for a time period in a second chronological direction (e.g., before or after), different than (e.g., opposite) the first chronological direction, with respect to the first time period of the second type. In some embodiments, the modified representation is a modified graph. In some embodiments, the third input is a swipe input. In some embodiments, the third input is a tap input (e.g., at a selectable element corresponding to a chronological direction for modifying the representation). In some embodiments, the third input is a non-swipe input. In some embodiments, a non-swipe input includes a verbal input, an audible request, an audible command, an audible statement, a tap input, a hold-and-drag input, a gaze input, an air gesture, mouse movement, and/or a mouse click. Outputting comparisons for different time periods in response to an input allows the computer system to provide the user with options to select the time period for which the comparison is to be output, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, while outputting the comparison of the data for the first time period of the first type relative to the second time period of the first type, the computer system detects, via the input device, a third input (e.g., 605q1, 605q2, 605s, and/or 605f) (e.g., a swipe input and/or a non-swipe input) corresponding to (e.g., directed to, at a location of, related to, and/or associated with) a request to output data for a respective time period (e.g., swipe to a different time period, selection of particular time period). In some embodiments, detecting the third input corresponding to the request to output data for the respective time period includes detecting, via the input device, an input corresponding to selection of a user interface element, such as a tap input and/or a swipe input on a user interface element representing a time period, where different user interface elements represent different time periods. In some embodiments, in response to detecting the third input (e.g., 605q1, 605q2, 605s, and/or 605f) corresponding to the request to output data for the respective time period, in accordance with a determination that the respective time period is a future time period (e.g., a time period that is chronologically after the current time, the current moment, the current day, the current week, the current month, the current 6 months, and/or the current year), the computer system outputs, via the output device, a first indication (e.g., 652) (e.g., notification that data is not available or not available yet). In some embodiments, in response to detecting the third input corresponding to the request to output data for the respective time period and in accordance with the determination that the respective time period is a future time period, the computer system forgoes or ceases output of a comparison (e.g., 640), a representation, a user interface element (e.g., 646 and/or 648) corresponding to multiple usage types, other data, and/or another user interface element. In some embodiments, in response to detecting the third input corresponding to the request to output data for the respective time period and in accordance with the determination that the respective time period is a future time period, the computer system maintains a user interface element comprising multiple representations, each representation to a respective one of multiple time period types, other data, and/or another user interface element. In some embodiments, in response to detecting the third input corresponding to the request to output data for the respective time period, in accordance with a determination that the respective time period is not associated with (e.g., include and/or correspond to) data (e.g., data of the selected type is not available and/or obtainable from a data source for the selected time period) and that the respective time period is a past time period (e.g., a time period that is chronologically before the current time, the current moment, the current day, the current week, the current month, the current 6 months, and/or the current year), the computer system outputs, via the output device, a second indication (e.g., 652) (e.g., notification that data is not available or not available yet) different from the first indication. In some embodiments, in response to detecting the third input corresponding to the request to output data for the respective time period and in accordance with the determination that the respective time period is a past time period, the computer system forgoes or ceases output of a comparison (e.g., 640), a representation, a user interface element (e.g., 646 and/or 648) corresponding to multiple usage types, other data, and/or another user interface element. In some embodiments, in response to detecting the third input corresponding to the request to output data for the respective time period and in accordance with the determination that the respective time period is a past time period, the computer system maintains a user interface element comprising multiple representations, each representation to a respective one of multiple time period types, other data, and/or another user interface element. Outputting comparison data for certain time periods based on the availability of data allows the computer system to provide the user with information that is most likely to be useful to the user, thereby performing an operation when a set of conditions has been met without requiring further user input, reducing the number of inputs needed to perform an operation, and/or providing improved visual feedback to the user.

Note that details of the processes described above with respect to method 800 (e.g., FIG. 8) are also applicable in an analogous manner to other methods described herein. For example, method 700 optionally includes one or more of the characteristics of the various methods described above with reference to method 800. For example, the data output of method 800 can be based on a connection from method 700. For brevity, these details are not repeated herein.

FIG. 9 is a flow diagram illustrating a method (e.g., method 900) for outputting data when data is not complete in accordance with some embodiments. Some operations in method 900 are, optionally, combined, the orders of some operations are, optionally, changed, and some operations are, optionally, omitted.

As described below, method 900 provides an intuitive way for outputting data when data is not complete. Method 900 reduces the cognitive burden on a user, thereby creating a more efficient human-machine interface. For battery-operated computing devices, enabling a user to interact with such devices faster and more efficiently conserves power and increases the time between battery charges.

In some embodiments, method 900 is performed at a computer system (e.g., 600) that is in communication (e.g., wired communication and/or wireless communication) with an input device (e.g., a touch-sensitive surface, a camera, a depth sensor, a microphone, a hardware input mechanism, a rotatable input mechanism, a physical input mechanism, a button, a crown, a knob, a dial, a physical slider, and/or an accelerometer) and an output device (e.g., a display generation component, an audio generation component, and/or a haptic generation component). In some embodiments, the computer system is a watch, a phone, a tablet, a fitness tracking device, a processor, a head-mounted display (HMD) device, a communal device, a media device, a speaker, a television, and/or a personal computing device. In some embodiments, the display generation component is a display screen, a projector, and/or a touch-sensitive display. In some embodiments, the audio generation component is a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output.

The computer system detects (902), via the input device, an input (e.g., 605l, 605m, 605n, 6050, 605p, 605q1, 605q2, 605s, 605f, 605w, and/or 605x) (e.g., a selection input and/or a non-selection input) corresponding to (e.g., directed to, at a location of, related to, and/or associated with) a request to output current data (e.g., of a first type, such as energy usage data, oil usage data, gas usage data, electrical usage data, health data, and/or workout data). In some embodiments, detecting the input corresponding to the request to output current data includes detecting (e.g., via a touch-sensitive surface, a hardware input mechanism, a rotatable input mechanism, a physical input mechanism, a button, a crown, a knob, a dial, a physical slider, or other type of input device) an input corresponding to selection of a user interface element, such as a tap input on a user interface element representing a time period type, where different user interface elements represent different time period types. In some embodiments, detecting the input corresponding to the request to output current data includes detecting an input as described above with respect to the input corresponding to the request to display energy usage data of method 700.

In response to (904) detecting the input (e.g., 605l, 605m, 605n, 6050, 605p, 605q1, 605q2, 605s, 605f, 605w, and/or 605x) corresponding to the request to output current data, in accordance with a determination that a current time period (e.g., a time period that includes the current moment (e.g., day, week, month, 6 months, year)) is not associated with data (e.g., data of the first type is not available and/or obtainable from a data source for the current time period), the computer system outputs (906), via the output device, an indication (e.g., 628, 638, 640, 642, 644, 646b, and/or 648b) (e.g., a graph, time period information, comparison data, and/or usage data) of data for a preceding time period (e.g., a time period immediately preceding the current time period, a most recent one of the time period for which data is available). In some embodiments, in response to detecting the input corresponding to the request to output current data, the computer system outputs, via the output device, an indication indicating whether data for the current time period is available. In some embodiments, in response to detecting the input corresponding to the request to output current data, the computer system outputs, via the output device, an indication indicating whether data is for the current time period or the preceding time period.

In response to (904) detecting the input corresponding to the request to output current data, in accordance with a determination that the current time period is associated with data (e.g., data of the first type is available and/or obtainable from a data source for the current time period), the computer system outputs (908), via the output device, an indication (e.g., 628, 638, 640, 642, 644, 646b, and/or 648b) (e.g., a graph, time period information, comparison data, and/or usage data) of data for the current time period without outputting the indication of data for the preceding time period. Outputting indications for certain time periods based on the availability of data allows the computer system to provide the user with information that is most likely to be useful to the user, thereby performing an operation when a set of conditions has been met without requiring further user input, reducing the number of inputs needed to perform an operation, and/or providing improved visual feedback to the user.

In some embodiments, the indication (e.g., 628, 638, 640, 642, 644, 646b, and/or 648b) of data for the current time period includes multiple subsets (e.g., hours within a day, days within a week, days within a month, months within a year) of the current time period. In some embodiments, at least one of the multiple subsets is a future subset (e.g., a subset that is chronologically after the current time, the current moment, the current day, the current week, the current month, the current 6 months, and/or the current year) (e.g., that is not associated with data) (e.g., data is not available and/or obtainable from a data source for the future subset). In some embodiments, in response to detecting the input corresponding to the request to output current data, the computer system outputs, via the output device, an indication indicating whether data for the future subset is available. In some embodiments, in response to detecting the input corresponding to the request to output current data, the computer system outputs, via the output device, an indication indicating whether the subset is a future subset or a past subset. In some embodiments, in response to detecting the input corresponding to the request to output current data, the computer system outputs, via the output device, an indication indicating the future subset with at least one other subset of the current time period for which data is available. Outputting indications to include a future subset allows the computer system to provide the user with an indication of the information relating to the future subset, thereby reducing the number of inputs needed to perform an operation and/or providing improved visual feedback to the user.

In some embodiments, the indication (e.g., 628, 638, 640, 642, 644, 646b, and/or 648b) of data for the current time period includes multiple subsets (e.g., hours within a day, days within a week, days within a month, months within a year) of the current time period. In some embodiments, at least one of the multiple subsets is a past subset (e.g., a subset that is chronologically before the current time, the current moment, the current day, the current week, the current month, the current 6 months, and/or the current year) that is not associated with data (e.g., data of the first type is not available and/or obtainable from a data source for the past subset). In some embodiments, in response to detecting the input corresponding to the request to output current data, the computer system outputs, via the output device, an indication indicating whether data for the past subset is available. In some embodiments, in response to detecting the input corresponding to the request to output current data, the computer system outputs, via the output device, an indication indicating whether the subset is a future subset or a past subset. In some embodiments, in response to detecting the input corresponding to the request to output current data, the computer system outputs, via the output device, an indication indicating the past subset with at least one other subset of the current time period for which data is available. Outputting indications to include a past subset allows the computer system to provide the user with an indication of the information relating to the past subset, thereby reducing the number of inputs needed to perform an operation and/or providing improved visual feedback to the user.

In some embodiments, the indication (e.g., 628, 638, 640, 642, 644, 646b, and/or 648b) of data for the current time period includes multiple subsets (e.g., hours within a day, days within a week, days within a month, months within a year) of the current time period. In some embodiments, in response to detecting the input corresponding to the request to output current data and in accordance with the determination that the current time period is associated with data, the computer system outputs, via the output device, an indication (e.g., 628, 638, 640, 642, 644, 646b, and/or 648b) (e.g., color, emphasis, and/or highlighting) of a current one of the multiple subsets. In some embodiments, the indication of the current one of the multiple subsets includes a visual characteristic (e.g., feature, color, emphasis, shape, size, and/or highlight) different from a visual characteristic of another subset of the multiple subsets different from the current one. In some embodiments, the current one of the multiple subsets is the current time, the current moment, the current day, the current week, the current month, the current 6 months, or the current year. In some embodiments, the current one is a subset for which data is not available and/or a subset that is not associated with data. In some embodiments, the current one is a subset for which data is available and/or a subset that is associated with data. Outputting an indication of a current one of multiple subsets allows the computer system to provide the user with an indication of how the time period for which information is output relates to the current moment, thereby reducing the number of inputs needed to perform an operation and/or providing improved visual feedback to the user.

In some embodiments, the indication of data for the current time period includes: a first representation (e.g., 644) (e.g., a bar, a dot, a location of a line at a point, and/or a segment of a pic in a graph) of a first subset (e.g., smaller increment of time, hour within a day, day within a week, day within a month, month within 6 months, and/or month within a year) of the current time period; and In some embodiments, the first representation is located at a first horizontal location along a horizontal axis (e.g., x-axis) and at a first vertical location along a vertical axis (e.g., y-axis). a second representation (e.g., 644) (e.g., a bar, a dot, a location of a line at a point, and/or a segment of a pie in a graph) of a second subset (e.g., smaller increment of time, hour within a day, day within a week, day within a month, month within 6 months, and/or month within a year) of the current time period. In some embodiments, the second representation is separate (and/or different) from the first representation. In some embodiments, the second representation is located at a second horizontal location (e.g., different from the first horizontal location) along the horizontal axis and at a second vertical location (e.g., the same as or different from the first vertical location) along the vertical axis. In some embodiments, the indication of data for the preceding time period includes a third representation (e.g., a bar, a dot, a location of a line at a point, and/or a segment of a pie in a graph) of a first subset (e.g., smaller increment of time, hour within a day, day within a week, day within a month, month within 6 months, and/or month within a year) of the preceding time period. In some embodiments, the third representation is located at the first horizontal location along the horizontal axis and at a third vertical location (e.g., the same as or different from the first vertical location and/or the second vertical location) along the vertical axis (e.g., y-axis). In some embodiments, a fourth representation (e.g., a bar, a dot, a location of a line at a point, and/or a segment of a pie in a graph) of a second subset (e.g., smaller increment of time, hour within a day, day within a week, day within a month, month within 6 months, and/or month within a year) of the preceding time period. In some embodiments, the fourth representation is separate (and/or different) from the third representation. In some embodiments, the fourth representation is located at the second horizontal location along the horizontal axis and at a fourth vertical location (e.g., the same as or different from the first vertical location, the second vertical location, and/or the third vertical location) along the vertical axis. Outputting representations of subset data for a time period allows the computer system to provide specific information within the time period, thereby reducing the number of inputs needed to perform an operation and/or providing improved visual feedback to the user.

In some embodiments, in accordance with a determination that a value (e.g., usage amount) corresponding to the first subset (and/or the first representation) is positive (e.g., indicating net consumption of energy), a portion of the first representation (e.g., 638 and/or 644) is output with a first visual characteristic (e.g., feature, color, emphasis, shape, size, and/or highlight). In some embodiments, the value indicates net consumption of energy when the value is positive. In some embodiments, the portion can extend in a first direction (e.g., upward) away from an axis (e.g., the x-axis) in a graph (e.g., 644) when the value is positive. In some embodiments, in accordance with a determination that a value corresponding to the second subset (and/or the second representation) is positive, a portion of the second representation is output with the first visual characteristic. In some embodiments, in accordance with a determination that the value corresponding to the first subset (and/or the first representation) is negative (e.g., indicating net production of energy), the portion of the first representation (e.g., 638 and/or 644) is output with a second visual characteristic (e.g., feature, color, emphasis, shape, size, and/or highlight) different from the first visual characteristic (e.g., without being output with the first visual characteristic). In some embodiments, the value indicates net production (e.g., solar, by solar, wind, and/or other power generation) of energy when the value is negative. In some embodiments, the portion can extend in a second direction (e.g., downward), different from (e.g., opposite) the first direction, away from the axis (e.g., the x-axis) in a graph (e.g., 644) when the value is negative. In some embodiments, in accordance with a determination that the value corresponding to the second subset (and/or the second representation) is negative, the portion of the second representation is output with the second visual characteristic (e.g., without being output with the first visual characteristic). Outputting different visual characteristics of representations for positive and negative values allows the computer system to provide information that is readily comprehensible to the user observing the representation, thereby reducing the number of inputs needed to perform an operation and/or providing improved visual feedback to the user.

In some embodiments, the input is a first input (e.g., 605l, 605m, 605n, 6050, 605p, 605q1, 605q2, 605s, 605f, 605w, and/or 605x). In some embodiments, while outputting the indication of data for the current time period, the computer system detects, via the input device, a second input (e.g., 605q1, 605q2, 605s, and/or 605f) (e.g., a selection input and/or a non-selection input). In some embodiments, detecting the second input includes detecting, via the output device, an input corresponding to selection of a user interface element, such as a tap input and/or a swipe input on a user interface element representing a time period, where different user interface elements represent different time periods. In some embodiments, in response to detecting the second input and in accordance with a determination that the second input corresponds to the preceding time period, the computer system outputs, via the output device, the indication (e.g., 628, 638, 640, 642, 644, 646b, 648b, and/or 652) of data for the preceding time period without outputting the indication of data for the current time period. In some embodiments, the second input is detected at the indication of data for the current time period. In some embodiments, the second input is directional. In some embodiments, in response to detecting the second input and in accordance with a determination that the second input is in a first direction (e.g., left or right), the computer system outputs, via the output device, an indication of data for a time period in a first chronological direction (e.g., before or after) with respect to the current time period. In some embodiments, in response detecting the second input and in accordance with a determination that the second input is in a second direction (e.g., left or right) different from (e.g., opposite) the first direction, the computer system outputs, via the output device, an indication of data for a time period in a second chronological direction (e.g., before or after), different from (e.g., opposite) the first chronological direction, with respect to the current time period. In some embodiments, the second input is a swipe input. In some embodiments, the second input is a tap input (e.g., at a selectable element corresponding to a chronological direction for modifying the indication). In some embodiments, the second input is a non-swipe input. In some embodiments, a non-swipe input includes a verbal input, an audible request, an audible command, an audible statement, a tap input, a hold-and-drag input, a gaze input, an air gesture, mouse movement, and/or a mouse click. Outputting indications for different time periods in response to an input allows the computer system to provide the user with options to select the time period for which the indication is to be output, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, the data for the current time period is energy usage data (e.g., oil usage, gas usage, and/or electrical usage data). In some embodiments, the energy usage data is a basis for providing an indication, representation, graph, value, and/or other output (e.g., 628, 638, 640, 642, 644, 646b, 648b, and/or 652). In some embodiments, the energy usage data includes information and/or a measurement corresponding to an amount of energy consumed. In some embodiments, the energy usage data includes information and/or a measurement corresponding to an amount of energy produced (e.g., by solar, wind, and/or other power generation). In some embodiments, the data for the current time period and/or for the preceding time period includes health data. In some embodiments, the data for the current time period and/or for the preceding time period includes information and/or a measurement corresponding to height, weight, body mass index, body fat percentage, electrodermal activity, waist circumference, wrist temperature, blood pressure, fitness level (e.g., VO2 max), electrocardiogram, heart rate, heart rate variability, resting heart rate, walking heart rate average, blood oxygen, respiratory rate, and/or sleep activity. In some embodiments, the data for the current time period and/or for the preceding time period is workout data corresponding to a user and/or an activity (e.g., workout, event, and/or session). In some embodiments, the data for the current time period and/or for the preceding time period includes information and/or a measurement corresponding to an activity, steps taken, workout duration, calories burned, and/or distance travelled (e.g., running, walking, cycling, and/or swimming). In some embodiments, the data for the preceding time period is energy usage data.

In some embodiments, in response to detecting the input corresponding to the request to output current data and in accordance with the determination that the current time period is associated with data, the computer system outputs, via the output device, a comparison (e.g., 640) (e.g., percentage change and/or difference in amounts) of data for the current time period relative to the preceding time period (e.g., comparison of the current week to the immediately preceding week or comparison of the current year to the immediately preceding year). In some embodiments, the comparison of data for the current time period relative to the preceding time period is output with other data for the current time period (e.g., and not output with other data for the preceding time period). In some embodiments, in response to detecting the input corresponding to the request to output current data and in accordance with the determination that the current time period is not associated with data, the computer system outputs, via the output device, a comparison (e.g., 640) (e.g., percentage change and/or difference in amounts) of data for the preceding time period relative to an additional preceding time period. In some embodiments, the comparison of data for the current time period relative to the preceding time period includes a numerical value. In some embodiments, the comparison of data for the current time period relative to the preceding time period includes a display of graphical information (e.g., 644). Outputting a comparison based on what time period type is selected allows the computer system to provide relevant and/or informative comparisons when outputting data without requiring a user to navigate between different sets of data to make their own comparison, thereby reducing the number of inputs needed to perform an operation, performing an operation when a set of conditions has been met without requiring further user input, and/or providing improved visual feedback to the user.

In some embodiments, in accordance with a determination that a first set of one or more criteria is satisfied, the comparison (e.g., 640) of the data for the current time period relative to the preceding time period is output (e.g., at FIGS. 6W and 6X) as an amount (e.g., feet, miles, heartbeats, exercises, calories, and/or kWh) (e.g., instead of and/or not as a percentage). In some embodiments, in response to detecting the input corresponding to the respective time period type and in accordance with the determination that the first set of one or more criteria is satisfied, the computer system outputs, via the output device, an indication indicating that net energy was provided to an electrical grid. In some embodiments, the first set of one or more criteria includes and/or is a criterion that is satisfied when a subset (e.g., of multiple subsets, such as hours within a day, days within a week, days within a month, and/or months within a year) of the data for the current time period includes a negative value (e.g., more energy was provided to an electrical grid than used). In some embodiments, the first set of one or more criteria includes and/or is a criterion that is satisfied when the data for the current time period is a first type of data (e.g., solar) and not a second type of data (e.g., non-solar, such as oil and/or gas) different from the first type of data. In some embodiments, the first set of one or more criteria includes and/or is a criterion that is satisfied when the data for the current time period corresponds to a first type of energy (e.g., solar) and not a second type of energy (e.g., non-solar, such as oil and/or gas). In some embodiments, the first set of one or more criteria includes and/or is a criterion that is satisfied when an account corresponding to the data for the current time period is configured as, associated with, and/or set up in a first manner (e.g., solar) and not a second manner different from the first manner (e.g., non-solar, such as oil and/or gas). In some embodiments, the first set of one or more criteria includes and/or is a criterion that is satisfied when a subset of multiple subsets of data for an additional time period, different from the current time period and/or the preceding time period includes a negative value. In some embodiments, in accordance with a determination that a second set of one or more criteria, different from the first set of one or more criteria, is satisfied, the comparison (e.g., 640) of the data for the current time period relative to the preceding time period is output (e.g., at FIGS. 6M-6R and 6V) as a percentage (e.g., instead of and/or not as an amount). In some embodiments, in response to detecting the input corresponding to the respective time period type and in accordance with the determination that the second set of one or more criteria is satisfied, the computer system outputs, via the output device, an indication indicating that net energy was received from an electrical grid. In some embodiments, the second set of one or more criteria includes and/or is a criterion that is satisfied when a subset of multiple subsets (e.g., hours within a day, days within a week, days within a month, months within a year) of the data for the current time period does not include a negative value (and/or each subset of multiple subsets of the data for the first time period includes a positive value and/or more energy was used than sent to the electrical grid). In some embodiments, the second set of one or more criteria includes and/or is a criterion that is satisfied when the data for the current time period is the second type of data. In some embodiments, the second set of one or more criteria includes and/or is a criterion that is satisfied when the data for the current time period corresponds to the second type of energy. In some embodiments, the second set of one or more criteria includes and/or is a criterion that is satisfied when an account corresponding to the data for the current time period is configured as, associated with, and/or set up in the second manner. In some embodiments, the second set of one or more criteria includes and/or is a criterion that is satisfied when a subset of multiple subsets of data for an additional time period, different from the current time period and/or the preceding time period, does not include a negative value. Sometimes outputting a percentage and other times outputting an amount enables the computer system to select a format of data that is comprehensible to a user while still being a single value, thereby performing an operation when a set of conditions has been met without requiring further user input and/or providing improved visual feedback to the user.

In some embodiments, the input is a first input (e.g., 605l, 605m, 605n, 6050, 605p, 605q1, 605q2, 605s, 605f, 605w, and/or 605x). In some embodiments, while outputting the indication of data for the preceding time period, the computer system detects, via the input device, a third input (e.g., 605q1, 605q2, 605s, and/or 605f) (e.g., a selection input and/or a non-selection input). In some embodiments, detecting the third input includes detecting, via the input device, an input corresponding to selection of a user interface element, such as a tap input and/or a swipe input on a user interface element representing a time period, where different user interface elements represent different time periods. In some embodiments, in response to detecting the third input and in accordance with a determination that the third input corresponds to the current time period, the computer system outputs, via the output device, the indication (e.g., 628, 638, 640, 642, 644, 646b, and/or 648b) of data for the current time period without outputting the indication of data for the preceding time period. In some embodiments, the third input is detected at the indication of data for the preceding time period. In some embodiments, the third input is directional. In some embodiments, in response to detecting the third input and in accordance with a determination that the third input is in a first direction (e.g., left or right), the computer system outputs, via the output device, the indication of data for a time period in a first chronological direction (e.g., before or after) with respect to the preceding time period. In some embodiments, in response to detecting the third input and in accordance with a determination that the third input is in a second direction (e.g., left or right) different from (e.g., opposite) the first direction, the computer system outputs, via the output device, the indication of data for a time period in a second chronological direction (e.g., before or after), different from (e.g., opposite) the first chronological direction, with respect to the preceding time period. In some embodiments, the third input is a swipe input. In some embodiments, the third input is a tap input (e.g., at a selectable element corresponding to a chronological direction for modifying the indication). In some embodiments, the third input is a non-swipe input. In some embodiments, a non-swipe input includes a verbal input, an audible request, an audible command, an audible statement, a tap input, a hold-and-drag input, a gaze input, an air gesture, mouse movement, and/or a mouse click. Outputting indications for different time periods in response to an input allows the computer system to provide the user with options to select the time period for which the indication is to be output, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, in response to detecting the third input and in accordance with a determination that the third input corresponds to the current time period and that the current time period is not associated with data, the computer system outputs (e.g., FIG. 6S, 6T, and/or 6U), via the output device, an indication (e.g., 652) that data is not available (e.g., notification that data is not available or not available yet). In some embodiments, in response to detecting the third input and in accordance with a determination that the third input corresponds to the current time period and that the current time period is not associated with data, the computer system forgoes or ceases output of a comparison (e.g., 640), a representation, a user interface element (e.g., 646 and/or 648) corresponding to multiple usage types, other data, and/or another user interface element. In some embodiments, in response to detecting the third input and in accordance with a determination that the third input corresponds to the current time period and that the current time period is not associated with data, the computer system maintains display of a user interface element including multiple representations, each corresponding to a respective one of multiple time period types, other data, and/or another user interface element. Outputting an indication that the data is not available allows the computer system to provide the user with information that allows the user to understand why information based on data is not being displayed, thereby reducing the number of inputs needed to perform an operation and/or providing improved visual feedback to the user.

In some embodiments, in response to detecting the input (e.g., 605l, 605m, 605n, 6050, 605p, 605q1, 605q2, 605s, 605f, 605w, and/or 605x) corresponding to the request to output current data, in accordance with the determination that the current time period is not associated with data, the computer system outputs (e.g., at FIG. 6M), via the output device, average data (e.g., 638) (e.g., average of all subset values) corresponding to the preceding time period. In some embodiments, the average data corresponding to the preceding time period is output with the indication of data for the preceding time period. In some embodiments, the average data corresponding to the preceding time period is an average of values for subsets of data for the preceding time period. In some embodiments, the multiple subsets of data correspond to a complete preceding time period. In some embodiments, the multiple subsets of data correspond to a partial preceding time period (e.g., trending data). In some embodiments, the average data corresponding to the preceding time period is output without the average data corresponding to the current time period. In some embodiments, in response to detecting the input corresponding to the request to output current data, in accordance with a determination that the current time period is associated with data, the computer system outputs, via the output device, average data (e.g., 638) (e.g., average of all subset values) corresponding to the current time period. In some embodiments, the average data corresponding to the current time period is output with the indication of data for the current time period. In some embodiments, the average data corresponding to the current time period is an average of values for subsets of data for the current time period. In some embodiments, the multiple subsets of data correspond to a complete current time period. In some embodiments, the multiple subsets of data correspond to a partial current time period (e.g., trending data). In some embodiments, the average data corresponding to the current time period is output without the average data corresponding to the preceding time period. Outputting average data for time periods allows the computer system to provide information that summarizes the results across a selected time period, thereby reducing the number of inputs needed to perform an operation and/or providing improved visual feedback to the user.

Note that details of the processes described above with respect to method 900 (e.g., FIG. 9) are also applicable in an analogous manner to other methods described herein. For example, method 800 optionally includes one or more of the characteristics of the various methods described above with reference to method 900. For example, the data output of method 900 can be provided along with the data output of method 800. For brevity, these details are not repeated herein.

FIG. 10 is a flow diagram illustrating a method (e.g., method 1000) for outputting comparison data of different types in accordance with some embodiments. Some operations in method 1000 are, optionally, combined, the orders of some operations are, optionally, changed, and some operations are, optionally, omitted.

As described below, method 1000 provides an intuitive way for outputting comparison data of different types. Method 1000 reduces the cognitive burden on a user, thereby creating a more efficient human-machine interface. For battery-operated computing devices, enabling a user to interact with such devices faster and more efficiently conserves power and increases the time between battery charges.

In some embodiments, method 1000 is performed at a computer system (e.g., 600) that is in communication (e.g., wired communication and/or wireless communication) with an input device (e.g., a touch-sensitive surface, a camera, a depth sensor, a microphone, a hardware input mechanism, a rotatable input mechanism, a physical input mechanism, a button, a crown, a knob, a dial, a physical slider, and/or an accelerometer) and an output device (e.g., a display generation component, an audio generation component, and/or a haptic generation component). In some embodiments, the computer system is a watch, a phone, a tablet, a fitness tracking device, a processor, a head-mounted display (HMD) device, a communal device, a media device, a speaker, a television, and/or a personal computing device. In some embodiments, the display generation component is a display screen, a projector, and/or a touch-sensitive display. In some embodiments, the audio generation component is a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output.

The computer system detects (1002), via the input device, an input (e.g., 605l, 605m, 605n, 6050, 605p, 605q1, 605q2, 605s, 605f, 605w, and/or 605x) (e.g., a selection input and/or a non-selection input) corresponding to a request to output data (e.g., energy usage data, oil usage data, gas usage data, electrical usage data, health data, and/or workout data) for a first time period (e.g., day, week, month, 6 months, and/or year). In some embodiments, detecting the input corresponding to the request to output data for the first time period includes detecting an input as described above with respect to the input corresponding to the request to display energy usage data of method 700. In such embodiments, the first time period can be a current time period, a default time period for outputting initial data, a last-used time period, and/or a time period configured for the computer system. In some embodiments, the first time period is a current or past time period.

In response to (1004) detecting the input (e.g., 605l, 605m, 605n, 6050, 605p, 605q1, 605q2, 605s, 605f, 605w, and/or 605x) corresponding to the request to output data for the first time period, in accordance with a determination that a subset of multiple subsets (e.g., hours within a day, days within a week, days within a month, months within a year) of the data for the first time period includes a negative value (e.g., more energy was provided to an electrical grid than used), the computer system outputs (1006), via the output device, a comparison (e.g., 640) of the data for the first time period relative to a second time period (e.g., a preceding or following time period), different from the first time period, (e.g., change relative to a preceding time period) as an amount (e.g., feet, miles, heartbeats, exercises, calories, and/or kWh). In some embodiments, the comparison of the data indicates a relationship between usage within the first time period and the second time period. In some embodiments, the comparison of the data as an amount includes an indication of a number and an indication of a unit of measurement. In some embodiments, the comparison of the data as an amount includes a numerical value. In some embodiments, the comparison of the data as an amount includes a display of graphical information (e.g., 644). In some embodiments, the comparison of the data as an amount is output with other data for the first time period (e.g., and not output with other data for the second time period). In some embodiments, in response to detecting the input corresponding to the request to output data for the first time period and in accordance with the determination that a subset of multiple subsets of the data for the first time period includes a negative value, the computer system outputs, via the output device, an indication indicating that net energy was provided to an electrical grid. In some embodiments, in response to detecting the input corresponding to the request to output data for the first time period and in accordance with a determination that a subset of multiple subsets of data for the second time period includes a negative value, the computer system outputs, via the output device, a comparison (e.g., 640) of the data for the first time period relative to the second time period as an amount. In some embodiments, in response to detecting the input corresponding to the request to output data for the first time period and in accordance with a determination that a subset of multiple subsets of data for a third time period, different from the first time period and/or the second time period, includes a negative value, the computer system outputs, via the output device, a comparison (e.g., 640) of the data for the first time period relative to the second time period as an amount.

In response to (1004) detecting the input corresponding to the request to output data for the first time period, in accordance with a determination that a subset of multiple subsets (e.g., hours within a day, days within a week, days within a month, months within a year) of the data for the first time period does not include a negative value (and/or each subset of multiple subsets of the data for the first time period includes a positive value and/or more energy was used than sent to the electrical grid), the computer system outputs (1008), via the output device, the comparison (e.g., 640) of the data for the first time period relative to the second time period as a percentage (e.g., instead of as an amount). In some embodiments, the comparison of the data as a percentage includes an indication of a number and an indication of a unit of measurement. In some embodiments, the comparison of the data as a percentage includes a numerical value. In some embodiments, the comparison of the data as a percentage includes a display of graphical information (e.g., 644). In some embodiments, the comparison of the data as a percentage is output with other data for the first time period (e.g., and not output with other data for the second time period). In some embodiments, in response to detecting the input corresponding to the request to output data for the first time period and in accordance with the determination that a subset of multiple subsets of the data for the first time period does not include a negative value, the computer system outputs, via the output device, an indication indicating that net energy was received from an electrical grid. In some embodiments, in response to detecting the input corresponding to the request to output data for the first time period and in accordance with a determination that a subset of multiple subsets of data for the second time period does not include a negative value, the computer system outputs, via the output device, the comparison of the data as a percentage. In some embodiments, in response to detecting the input corresponding to the request to output data for the first time period and in accordance with a determination that a subset of multiple subsets of data for a third time period, different from the first time period and/or the second time period, does not include a negative value, the computer system outputs, via the output device, the comparison of the data as a percentage. Sometimes outputting a percentage and other times outputting an amount enables the computer system to select a format of data that is comprehensible to a user while still being a single value, thereby performing an operation when a set of conditions has been met without requiring further user input and/or providing improved visual feedback to the user.

In some embodiments, in response to detecting the input (e.g., 605l, 605m, 605n, 6050, 605p, 605q1, 605q2, 605s, 605f, 605w, and/or 605x) corresponding to the request to output data for the first time period, in accordance with the determination that the subset of multiple subsets of the data for the first time period includes a negative value, the computer system outputs a first indication (e.g., 638 and/or 644) (e.g., surplus and/or net generation, positive value, and/or a feature extending in a first direction on a graph). In some embodiments, in response to detecting the input corresponding to the request to output data for the first time period and in accordance with the determination that the subset of multiple subsets of the data for the first time period includes a negative value, the computer system outputs, via the output device, the first indication indicating that net energy was provided to an electrical grid. In some embodiments, in response to detecting the input corresponding to the request to output data for the first time period and in accordance with the determination that the subset of multiple subsets of the data for the first time period includes a negative value, the computer system outputs, via the output device, a value corresponding to the subset and/or the first time period is output as the first indication with a negative value. In some embodiments, the output of the first indication includes a unit of measurement. In some embodiments, the value corresponding to the subset and/or the first time period is a total, an average, and/or another combination corresponding to the multiple subsets. In some embodiments, in response to detecting the input corresponding to the request to output data for the first time period, in accordance with the determination that the subset of multiple subsets of the data for the first time period does not include a negative value, the computer system outputs a second indication (e.g., 638 and/or 644) (e.g., usage and/or net consumption, negative value, feature extending in a second direction, different than the first direction, on a graph) different from the first indication. In some embodiments, in response to detecting the input corresponding to the request to output data for the first time period and in accordance with the determination that the subset of multiple subsets of the data for the first time period does not include a negative value, the computer system outputs, via the output device, the second indication indicating that net energy was received from an electrical grid (e.g., usage, net consumption). In some embodiments, in response to detecting the input corresponding to the request to output data for the first time period and in accordance with the determination that the subset of multiple subsets of the data for the first time period does not include a negative value, the computer system outputs, via the output device, a value corresponding to the subset and/or the time period is output as the second indication with a positive value. In some embodiments, the output of the second indication includes a unit of measurement. In some embodiments, the value corresponding to the subset and/or the first time period is a total, an average, and/or another a combination corresponding to the multiple subsets. Outputting different indications depending on whether a value is positive or negative enables the computer system to provide information to the user regarding which of two different outcomes are provided, thereby performing an operation when a set of conditions has been met without requiring further user input, reducing the number of inputs needed to perform an operation, and/or providing improved visual feedback to the user.

In some embodiments, in response to detecting the input (e.g., 605l, 605m, 605n, 6050, 605p, 605q1, 605q2, 605s, 605f, 605w, and/or 605x) corresponding to the request to output data for the first time period and in accordance with a determination that one of multiple subsets of the current time period is not associated with data, the computer system outputs, via the output device, a comparison (e.g., 640) of an average (e.g., 638) (e.g., average of all subset values) of available data for the first time period relative to an average (e.g., average of all subset values) of available data for the second time period. In some embodiments, the average of available data for the first time period is an average of values for subsets of data for the first time period. In some embodiments, the average of available data for the second time period is an average of values for subsets of data for the second time period. In some embodiments, the multiple subsets correspond to a complete current time period. In some embodiments, the multiple subsets correspond to a partial current time period (e.g., trending data). In some embodiments, computer system outputs an indication of the average of available data corresponding to the first time period. In some embodiments, the average of available data corresponding to the first time period is output without the average data corresponding to the second time period. Outputting an average of available data based on one or more subsets allows the computer system to provide summary information to the user based on the available data, thereby reducing the number of inputs needed to perform an operation, performing an operation when a set of conditions has been met without requiring further user input, and/or providing improved visual feedback to the user.

In some embodiments, in response to detecting the input (e.g., 605l, 605m, 605n, 6050, 605p, 605q1, 605q2, 605s, 605f, 605w, and/or 605x) corresponding to the request to output data for the first time period, the computer system outputs, via the output device, a representation (e.g., 644) (e.g., graph) of subset data corresponding to multiple subsets (e.g., smaller increments of time, hours within a day, days within a week, days within a month, months within 6 months, months within a year) of data for the first time period. In some embodiments, the representation is a graph (e.g., scatter plot, bar graph, line chart, pie chart, and/or box plot). In some embodiments, each of the multiple subsets of the data for the first time period is distributed along a horizontal axis (e.g., x-axis), and a value for each of the multiple subsets of the data for the first time period extends along a vertical axis (e.g., y-axis). In some embodiments, the multiple subsets of data correspond to a complete first time period. In some embodiments, the multiple subsets of data correspond to a partial first time period. In some embodiments, the representation is output with the comparison of the data for the first time period relative to the second time period. Outputting representations of subset data for time periods allows the computer system to provide specific information within a selected time period, thereby reducing the number of inputs needed to perform an operation and/or providing improved visual feedback to the user.

In some embodiments, outputting the representation (e.g., 644) includes outputting, via the output device, an indication of at least one future subset of the data for the first time period (e.g., a subset that is chronologically after the current moment, the current day, the current week, the current month, the current 6 months, and/or the current year) that is not associated with data (e.g., data of the first type is not available and/or obtainable from a data source for the future subset). In some embodiments, a future subset is a subset that is chronologically after the current moment, the current day, the current week, the current month, the current 6 months, and/or the current year. In some embodiments, the computer system outputs, via the output device, an indication indicating whether data for the future subset is available. In some embodiments, the computer system outputs, via the output device, an indication indicating that the subset is a future subset. In some embodiments, the computer system outputs, via the output device, an indication indicating the future subset with at least one other subset of the first time period for which data is available. Outputting indications to include a future subset allows the computer system to provide the user with an indication of the information relating to the future subset, thereby reducing the number of inputs needed to perform an operation and/or providing improved visual feedback to the user.

In some embodiments, outputting the representation (e.g., 644) includes outputting, via the output device, an indication of at least one past subset of the data for the first time period (e.g., a subset that is chronologically after the current moment, the current day, the current week, the current month, the current 6 months, and/or the current year) that is not associated with data (e.g., data of the first type is not available and/or obtainable from a data source for the past subset). In some embodiments, a past subset is a subset that is chronologically before the current moment, the current day, the current week, the current month, the current 6 months, and/or the current year. In some embodiments, the computer system outputs, via the output device, an indication indicating whether data for the past subset is available. In some embodiments, the computer system outputs, via the output device, an indication indicating an indication indicating that the subset is a past subset. In some embodiments, the computer system outputs, via the output device, an indication indicating the past subset with at least one other subset of the first time period for which data is available. Outputting indications to include a past subset allows the computer system to provide the user with an indication of the information relating to the past subset, thereby reducing the number of inputs needed to perform an operation and/or providing improved visual feedback to the user.

In some embodiments, outputting the representation (e.g., 644) includes outputting, via the output device, an indication of at least one past subset of the data for the first time period (e.g., a subset that is chronologically after the current moment, the current day, the current week, the current month, the current 6 months, and/or the current year) that has a value of 0 (e.g., data is available but has a value of zero). In some embodiments, a past subset is a subset that is chronologically before the current moment, the current day, the current week, the current month, the current 6 months, and/or the current year. In some embodiments, the computer system outputs, via the output device, an indication indicating whether data for the past subset is available. In some embodiments, the computer system outputs, via the output device, an indication indicating that the subset is a past subset. In some embodiments, the computer system outputs, via the output device, an indication indicating the past subset with at least one other subset of the first time period for which data the corresponding value is not zero. In some embodiments, the computer system outputs, via the output device, an indication indicating the past subset in a manner that is similar or the same as an indication indicating that past subset is not associated with data (e.g., data is not available). In some embodiments, where the representation is a graph, a subset for which data is not available is depicted as if the value were zero. Outputting indications to include a subset with a value of zero allows the computer system to provide the user with an indication of the information relating to the past subset, thereby reducing the number of inputs needed to perform an operation and/or providing improved visual feedback to the user.

In some embodiments, in response to detecting the input (e.g., 605l, 605m, 605n, 6050, 605p, 605q1, 605q2, 605s, 605f, 605w, and/or 605x) corresponding to the request to output the data for the first time period, the computer system outputs, via the output device, an indication (e.g., 644) (e.g., color, emphasis, and/or highlighting) of a current one of the multiple subsets. In some embodiments, the indication of the current one of the multiple subsets includes a visual characteristic (e.g., feature, color, emphasis, shape, size, and/or highlight) different from a visual characteristic of another subset of the multiple subsets different from the current one. In some embodiments, the current one of the multiple subsets is the current time, the current moment, the current day, the current week, the current month, the current 6 months, or the current year. In some embodiments, the current one is a subset for which data is not available and/or a subset that is not associated with data. In some embodiments, the current one is a subset for which data is available and/or a subset that is associated with data. Outputting an indication of a current one of multiple subsets allows the computer system to provide the user with an indication of how the time period for which information is output relates to the current moment, thereby reducing the number of inputs needed to perform an operation and/or providing improved visual feedback to the user.

In some embodiments, in accordance with a determination that a value (e.g., 638 and/or 644) (e.g., usage amount) corresponding to the current one of the multiple subsets is positive (e.g., indicating net consumption of energy), a portion (e.g., 638 and/or 644) of the representation of subset data corresponding to multiple subsets of data for the first time period is output with a first visual characteristic (e.g., feature, color, emphasis, shape, size, and/or highlight). In some embodiments, the value indicates net consumption of energy when the value is positive. In some embodiments, the portion can extend in a first direction (e.g., upward) away from an axis (e.g., the x-axis) when the value is positive. In some embodiments, in accordance with a determination that a value corresponding to the second subset (and/or the second representation) is positive, a portion of the second representation is output with the first visual characteristic. In some embodiments, in accordance with a determination that the value (e.g., 638 and/or 644) corresponding to the current one of the multiple subsets is negative (e.g., indicating net production of energy), the portion (e.g., 638 and/or 644) of the representation of subset data corresponding to multiple subsets of data for the first time period is output with a second visual characteristic (e.g., feature, color, emphasis, shape, size, and/or highlight) different from the first visual characteristic. (e.g., without being output with the first visual characteristic). In some embodiments, the value indicates net production (e.g., solar, by solar, wind, and/or other power generation) of energy when the value is negative. In some embodiments, the portion can extend in a second direction (e.g., downward), different from (e.g., opposite) the first direction, away from the axis (e.g., the x-axis) when the value is negative. In some embodiments, in accordance with a determination that the value corresponding to the second subset (and/or the second representation) is negative, the portion of the second representation is output with the second visual characteristic (e.g., without being output with the first visual characteristic). Outputting different visual characteristics of representations for positive and negative values allows the computer system to provide information that is readily comprehensible to the user observing the representation, thereby reducing the number of inputs needed to perform an operation and/or providing improved visual feedback to the user.

In some embodiments, the input is a first input (e.g., 605l, 605m, 605n, 6050, 605p, 605q1, 605q2, 605s, 605f, 605w, and/or 605x). In some embodiments, while outputting the comparison of the data for the first time period relative to a second time period, the computer system detects, via the input device, a second input (e.g., 605q1, 605q2, 605s, and/or 605f) (e.g., a selection input and/or a non-selection input). In some embodiments, detecting the second input includes detecting, via the output device, an input corresponding to selection of a user interface element, such as a tap input and/or a swipe input on a user interface element representing a time period, where different user interface elements represent different time periods. In some embodiments, in response to detecting the second input and in accordance with a determination that the second input corresponds to the second time period, the computer system outputs, via the output device, a comparison (e.g., 640) of data for the second time period relative to a third time period, different than the first time period and the second time period, without outputting the comparison of the data for the first time period relative to a second time period. In some embodiments, the second input is detected at the indication of data for the first time period. In some embodiments, the second input is directional. In some embodiments, in response to detecting the second input and in accordance with a determination that the second input is in a first direction (e.g., left or right), the computer system outputs, via the output device, an indication of data for a time period in a first chronological direction (e.g., before or after) with respect to the first time period. In some embodiments, in response detecting the second input and in accordance with a determination that the second input is in a second direction (e.g., left or right) different from (e.g., opposite) the first direction, the computer system outputs, via the output device, an indication of data for a time period in a second chronological direction (e.g., before or after), different from (e.g., opposite) the first chronological direction, with respect to the first time period. In some embodiments, the second input is a swipe input. In some embodiments, the second input is a tap input (e.g., at a selectable element corresponding to a chronological direction for modifying the indication). In some embodiments, the second input is a non-swipe input. In some embodiments, a non-swipe input includes a verbal input, an audible request, an audible command, an audible statement, a tap input, a hold-and-drag input, a gaze input, an air gesture, mouse movement, and/or a mouse click. Outputting a comparison for a time period in response to an input received while outputting a comparison for another time period allows the computer system to provide the user with options to select the time period for which the comparison is to be output, thereby performing an operation when a set of conditions has been met without requiring further user input, reducing the number of inputs needed to perform an operation, providing additional control options without cluttering the user interface with additional displayed controls, and/or providing improved visual feedback to the user.

In some embodiments, in accordance with a determination that the subset of the multiple subsets of the data for the first time period does not include a negative value (e.g., 638 and/or 644), the comparison (e.g., 640) of the data for the second time period relative to the third time period is output as a percentage. In some embodiments, the format (e.g., expression, labeling, units, percentage, and/or or amount) of the comparisons is maintained while transitioning (e.g., scrolling and/or swiping) through multiple time periods (e.g., for consistency). In some embodiments, the format of the comparisons across multiple time periods is maintained for immediate transitions between adjacent time periods. Outputting a comparison as a percentage across different time periods allows the computer system to provide consistent information to the user to readily make comparisons across different time periods, thereby reducing the number of inputs needed to perform an operation and/or providing improved visual feedback to the user.

In some embodiments, in accordance with a determination that the subset of the multiple subsets of the data for the first time period includes a negative value (e.g., 638 and/or 644), the comparison (e.g., 640) of the data for the second time period relative to the third time period is output as an amount. In some embodiments, the format (e.g., expression, labeling, units, percentage, and/or amount) of the comparisons is maintained while transitioning (e.g., scrolling and/or swiping) through multiple time periods (e.g., for consistency). In some embodiments, the format of the comparisons across multiple time periods is maintained for immediate transitions between adjacent time periods. Outputting a comparison as an amount across different time periods allows the computer system to provide consistent information to the user to readily make comparisons across different time periods, thereby reducing the number of inputs needed to perform an operation and/or providing improved visual feedback to the user.

In some embodiments, in accordance with a determination that a subset of multiple subsets of the data for the second time period does not include a negative value (e.g., 638 and/or 644), the comparison (e.g., 640) of the data for the second time period relative to the third time period is output as a percentage. In some embodiments, in accordance with a determination that a subset of multiple subsets of the data for the second time period includes a negative value (e.g., 638 and/or 644), the comparison (e.g., 640) of the data for the second time period relative to the third time period is output as an amount. In some embodiments, the format (e.g., expression, labeling, units, percentage, and/or amount) of the comparisons across multiple time periods is evaluated independently of the others without requiring consistency. In some embodiments, the format need not be maintained while transitioning (e.g., scrolling and/or swiping) through multiple time periods. Outputting a comparison as a percentage or an amount based on a current time period, rather than another time period, allows the computer system to provide updated information to the user to have information that is most relevant to the current time period, thereby reducing the number of inputs needed to perform an operation and/or providing improved visual feedback to the user.

In some embodiments, the data is energy usage data (e.g., oil usage, gas usage, and/or electrical usage data). In some embodiments, the energy usage data is a basis for providing an indication, representation, graph, value, and/or other output (e.g., 628, 638, 640, 642, 644, 646b, 648b, and/or 652). In some embodiments, the energy usage data includes information and/or a measurement corresponding to an amount of energy consumed. In some embodiments, the energy usage data includes information and/or a measurement corresponding to an amount of energy produced (e.g., by solar, wind, and/or other power generation). In some embodiments, the data for the first time period and/or for the second time period includes health data. In some embodiments, the data for the first time period and/or for the second time period includes information and/or a measurement corresponding to height, weight, body mass index, body fat percentage, electrodermal activity, waist circumference, wrist temperature, blood pressure, fitness level (e.g., VO2 max), electrocardiogram, heart rate, heart rate variability, resting heart rate, walking heart rate average, blood oxygen, respiratory rate, and/or sleep activity. In some embodiments, the data for the first time period and/or for the second time period is workout data corresponding to a user and/or an activity (e.g., workout, event, and/or session). In some embodiments, the data for the first time period and/or for the second time period includes information and/or a measurement corresponding to an activity, steps taken, workout duration, calories burned, and/or distance travelled (e.g., running, walking, cycling, and/or swimming). In some embodiments, the data for the second time period is energy usage data.

In some embodiments, in response to detecting the input (e.g., 605l, 605m, 605n, 6050, 605p, 605q1, 605q2, 605s, 605f, 605w, and/or 605x) corresponding to the request to output data for the first time period, the computer system outputs, via the output device, total (e.g., absolute) data (e.g., 638) (e.g., sum of all subset values) corresponding to the first time period. In some embodiments, the total data is output with the comparison of data for the first time period relative to the second time period. In some embodiments, the total data is a sum of values for multiple subsets of data for the first time period. In some embodiments, the multiple subsets of data correspond to a complete first time period. In some embodiments, the multiple subsets of data correspond to a partial first time period, and the total data is a projection (e.g., trend projection, forecast, prediction, estimate) of the sum of values for the complete first time period (e.g., hypothetical values) based on the partial first time period (e.g., available values). Outputting total data for time periods allows the computer system to provide information that summarizes the results across a selected time period, thereby reducing the number of inputs needed to perform an operation and/or providing improved visual feedback to the user.

In some embodiments, in response to detecting the input (e.g., 605l, 605m, 605n, 6050, 605p, 605q1, 605q2, 605s, 605f, 605w, and/or 605x) corresponding to the request to output data for the first time period, the computer system outputs, via the output device, average data (e.g., 638) (e.g., average of all subset values) corresponding to the first time period. In some embodiments, the average data is output with the comparison of data for the first time period relative to the second time period. In some embodiments, the average data is an average of values for multiple subsets of data for the first time period. In some embodiments, the multiple subsets of data correspond to a complete first time period. In some embodiments, the multiple subsets of data correspond to a partial first time period (e.g., trending data). Outputting average data for time periods allows the computer system to provide information that summarizes the results across a selected time period, thereby reducing the number of inputs needed to perform an operation and/or providing improved visual feedback to the user.

In some embodiments, the input is a first input (e.g., 605l, 605m, 605n, 6050, 605p, 605q1, 605q2, 605s, 605f, 605w, and/or 605x). In some embodiments, in response to detecting the first input (e.g., 605l, 605m, 605n, 6050, 605p, 605q1, 605q2, 605s, 605f, 605w, and/or 605x) corresponding to the request to output data for the first time period, the computer system outputs, via the output device, a first representation (e.g., 628, 638, 640, 642, 644, 646b, 648b, and/or 652) (e.g., total data for the first time period, sum of all subset values, and/or graph depicting subsets) of energy usage within the first time period. In some embodiments, the first representation indicates a total energy usage that is attributable to a combination of multiple usage types. In some embodiments, the first representation of energy usage within the first time period is output while outputting the comparison of the data for the first time period relative to the second time period of the first type. In some embodiments, the first representation is a representation of total data for the first time period. In some embodiments, the first representation is a graph corresponding to the first time period. In some embodiments, the first representation is a sum of all subset values in the graph. In some embodiments, in response to detecting the first input corresponding to the request to output data for the first time period, the computer system outputs, via the output device, a user interface element (e.g., 646 and/or 648) (e.g., a menu, a slider, and/or a group of one or more individual user interface elements) corresponding to multiple usage types (e.g., time-of-use (TOU) types, rates, peak, partial-peak, and/or off-peak). In some embodiments, the each of the multiple usage types represents a subset of the total energy usage within the first time period. In some embodiments, after (and/or while) outputting the user interface element (e.g., 646 and/or 648) corresponding to the multiple usage types (and/or after and/or while outputting the first representation of energy usage within the first time period), the computer system detects, via the input device, a second input (e.g., 605w and/or 605x) (e.g., a selection input and/or a non-selection input) corresponding to a respective usage type of the multiple usage types. In some embodiments, detecting the second input corresponding to the respective usage type of the multiple usage types includes detecting, via the input device, an input corresponding to selection of a user interface element, such as a tap input on a user interface element representing a usage type, where different user interface elements represent different usage types. In some embodiments, the user interface element corresponding to the multiple usage types is output while outputting the comparison of the data for the first time period relative to the second time period of the first type. In some embodiments, the user interface element includes a representation for each of the multiple usage types. In some embodiments, in response to detecting the second input (e.g., 605w and/or 605x) corresponding to the respective usage type of the multiple usage types, in accordance with a determination that the second input (e.g., 605w and/or 605x) corresponds to a first one (e.g., 646 and/or 648) of the multiple usage types, the computer system outputs, via the output device, a second representation (e.g., 628, 638, 640, 642, 644, 646b, 648b, and/or 652) (e.g., portion of data for the first time period, sum of certain subset values, and/or graph depicting subsets) of the energy usage within the first time period that corresponds to the first one of the multiple usage types (e.g., portion of the total energy usage that is attributable to the selected usage type). In some embodiments, in response to detecting the second input corresponding to the first one of the multiple usage types, the computer system maintains display of the user interface element. In some embodiments, in response to detecting the second input corresponding to the first one of the multiple usage types, the computer system emphasizes (e.g., highlights, bolds, and/or visually distinguishes) a representation of the first one of the multiple usage types within the user interface element. In some embodiments, the second representation indicates a portion of the total energy usage that is attributable to the first one of the multiple usage types. In some embodiments, the second representation is and/or includes a numeric value. In some embodiments, the second representation is and/or includes a modified graph. In some embodiments, while indicating the portion of the total energy usage that is attributable to the selected usage type, the modified representation maintains at least a portion of the first representation (e.g., as an indication of a total energy usage that is attributable to a combination of all available usage types). In some embodiments, the modified representation illustrates both the total energy usage and the portion thereof that is attributable to a particular usage type. In some embodiments, the computer system detects an additional input with respect to the menu and updates the representation to correspond to another one of the multiple usage types. In some embodiments, in accordance with a determination that the second input corresponds to a first one of the multiple usage types, the computer system ceases output of at least a portion of the first representation. In some embodiments, in response to detecting the second input corresponding to the respective usage type of the multiple usage types, in accordance with a determination that the second input (e.g., 605w and/or 605x) corresponds to a second one of the multiple usage types, the computer system outputs, via the output device, a third representation (e.g., 628, 638, 640, 642, 644, 646b, 648b, and/or 652) (e.g., portion of data for the first time period, sum of certain subset values, and/or graph depicting subsets) of the energy usage within the first time period that corresponds to the second one (e.g., 646 and/or 648) of the multiple usage types (e.g., portion of the total energy usage that is attributable to the selected usage type). In some embodiments, in response to detecting the second input corresponding to the second one of the multiple usage types, the computer system maintains display of the user interface element. In some embodiments, in response to detecting the second input corresponding to the second one of the multiple usage types, the computer system emphasizes (e.g., highlights, bolds, and/or visually distinguishes) a representation of the second one of the multiple usage types within the user interface element. In some embodiments, the second representation indicates a portion of the total energy usage that is attributable to the second one of the multiple usage types. In some embodiments, the second representation is and/or includes a numeric value. In some embodiments, the second representation is and/or includes a modified graph. In some embodiments, while indicating the portion of the total energy usage that is attributable to the selected usage type, the modified representation maintains at least a portion of the first representation (e.g., as an indication of a total energy usage that is attributable to a combination of all available usage types). In some embodiments, the modified representation illustrates both the total energy usage and the portion thereof that is attributable to a particular usage type. In some embodiments, the computer system detects an additional input with respect to the menu and updates the representation to correspond to another one of the multiple usage types. In some embodiments, in accordance with a determination that the second input corresponds to a second one of the multiple usage types, the computer system ceases output of at least a portion of the first representation. Outputting selectable user interface elements for usage types and output different representations for different usage types allows the computer system to provide the user with options to select information to be displayed based on the selection of usage type, thereby performing an operation when a set of conditions has been met without requiring further user input, reducing the number of inputs needed to perform an operation, providing additional control options without cluttering the user interface with additional displayed controls, and/or providing improved visual feedback to the user.

Note that details of the processes described above with respect to method 1000 (e.g., FIG. 10) are also applicable in an analogous manner to the methods described herein. For example, method 900 optionally includes one or more of the characteristics of the various methods described herein with reference to method 1000. For example, the data output of method 1000 can be provided along with the data output of method 900. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve data management. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing data. Accordingly, use of such personal information data enables users to have a computer system perform operations for managing data. Further, other uses for personal information data that benefit the user are also contemplated by the present disclosure. For instance, health and fitness data may be used to provide insights into a user's general wellness, or may be used as positive feedback to individuals using technology to pursue wellness goals. Energy usage data may be used to provide insights into a user's energy consumption and/or generation, or may be used as positive feedback to individuals using technology to pursue energy goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to services, or publicly available information.

What is claimed is:

1. A method, comprising:
at a computer system that is in communication with an input device and an output device:
detecting, via the input device, an input corresponding to a respective time period type; and
in response to detecting the input corresponding to the respective time period type:
in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and
in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

2. The method of claim 1, wherein the second time period of the first type is different from the first time period of the first type by a time period of a third type different from a time period of the first type and a time period of the second type.

3. The method of claim 1, wherein the second time period of the first type is a time period that is within the second time period of the second type.

4. The method of claim 1, wherein the data for the first time period of the first type is energy usage data.

5. The method of claim 1, wherein:
the comparison of the data for the first time period of the first type relative to the second time period of the first type is output as a first percentage; and
the comparison of data for the first time period of the second type relative to the second time period of the second type is output as a second percentage.

6. The method of claim 1, wherein:
the comparison of data for the first time period of the first type relative to the second time period of the first type is output as a first amount; and
the comparison of data for the first time period of the second type relative to the second time period of the second type is output as a second amount.

7. The method of claim 1, wherein:
in accordance with a determination that a first set of one or more criteria is satisfied, the comparison of the data for the first time period of the first type relative to the second time period of the first type is output as an amount; and
in accordance with a determination that a second set of one or more criteria, different from the first set of one or more criteria, is satisfied, the comparison of the data for the first time period of the second type relative to the second time period of the second type is output as a percentage.

8. The method of claim 1, further comprising:
in conjunction with detecting the input corresponding to the respective time period type, outputting, via the output device, a user interface element including a representation of the first type and a representation of the second type, wherein the representation of the second type is separate from the representation of the first type.

9. The method of claim 1, further comprising:
in response to detecting the input corresponding to the respective time period type:
in accordance with the determination that the respective time period type is the first type, outputting, via the output device, first average data corresponding to the first time period of the first type; and
in accordance with the determination that the respective time period type is the second type, outputting, via the output device, second average data corresponding to the first time period of the second type.

10. The method of claim 1, further comprising:
in response to detecting the input corresponding to the respective time period type:
in accordance with the determination that the respective time period type is the first type, outputting, via the output device, first total data corresponding to the first time period of the first type; and
in accordance with the determination that the respective time period type is the second type, outputting, via the output device, second total data corresponding to the first time period of the second type.

11. The method of claim 1, further comprising:
in response to detecting the input corresponding to the respective time period type:
in accordance with the determination that the respective time period type is the first type, outputting, via the output device, a first representation of first subset data corresponding to multiple subsets of the data for the first time period of the first type; and
in accordance with the determination that the respective time period type is the second type, outputting, via the output device, a second representation of second subset data corresponding to multiple subsets of the data for the first time period of the second type.

12. The method of claim 11, wherein:
in accordance with a determination that a value corresponding to one of the multiple subsets of the data for the first time period of the first type is positive, a portion of the first representation corresponding to the one of the multiple subsets of the data for the first time period of the first type is output with a first visual characteristic; and
in accordance with a determination that the value corresponding to the one of the multiple subsets of the data for the first time period of the first type is negative, the portion of the first representation corresponding to the one of the multiple subsets of the data for the first time period of the first type is output with a second visual characteristic different from the first visual characteristic.

13. The method of claim 1, wherein the input is a first input, the method further comprising:
in response to detecting the first input corresponding to the respective time period type:
outputting, via the output device, a first representation of energy usage within the first time period of the first type; and
outputting, via the output device, a user interface element corresponding to multiple usage types;
after outputting the user interface element corresponding to the multiple usage types, detecting, via the input device, a second input corresponding to a respective usage type of the multiple usage types; and
in response to detecting the second input corresponding to the respective usage type of the multiple usage types:
in accordance with a determination that the second input corresponds to a first one of the multiple usage types, outputting, via the output device, a second representation of the energy usage within the first time period of the first type that corresponds to the first one of the multiple usage types; and
in accordance with a determination that the second input corresponds to a second one, different from the first one, of the multiple usage types, outputting, via the output device, a third representation of the energy usage within the first time period of the first type that corresponds to the second one of the multiple usage types.

14. The method of claim 1, wherein the input is a first input, the method further comprising:
while outputting the comparison of the data for the first time period of the first type relative to the second time period of the first type, detecting, via the input device, a second input;
in response to detecting the second input, outputting, via the output device, a comparison of data for a third time period of the first type, different from the first time period of the first type and the second time period of the first type, relative to a fourth time period of the first type, wherein the fourth time period of the first type is different from the third time period of the first type by more than a length of a time period of the first type;
while outputting the comparison of the data for the first time period of the second type relative to the second time period of the second type, detecting, via the input device, a third input; and
in response to detecting the third input, outputting, via the output device, a comparison of data for the second time period of the second type relative to a third time period of the second type, wherein the third time period of the second type is different from the second time period of the second type by the length of the time period of the second type.

15. The method of claim 1, further comprising:
while outputting the comparison of the data for the first time period of the first type relative to the second time period of the first type, detecting, via the input device, a third input corresponding to a request to output data for a respective time period;
in response to detecting the third input corresponding to the request to output data for the respective time period:
in accordance with a determination that the respective time period is a future time period, outputting, via the output device, a first indication; and
in accordance with a determination that the respective time period is not associated with data and that the respective time period is a past time period, outputting, via the output device, a second indication different from the first indication.

16. A non-transitory computer-readable storage medium storing one or more programs configured to be executed by one or more processors of a computer system that is in communication with an input device and an output device, the one or more programs including instructions for:
detecting, via the input device, an input corresponding to a respective time period type; and
in response to detecting the input corresponding to the respective time period type:
in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and
in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.

17. A computer system configured to communicate with an input device and an output device, comprising:
one or more processors; and
memory storing one or more programs configured to be executed by the one or more processors, the one or more programs including instructions for:
detecting, via the input device, an input corresponding to a respective time period type; and
in response to detecting the input corresponding to the respective time period type:
in accordance with a determination that the respective time period type is a first type, outputting, via the output device, a comparison of data for a first time period of the first type relative to a second time period of the first type, wherein the second time period of the first type is different from the first time period of the first type by more than a length of a time period of the first type; and
in accordance with a determination that the respective time period type is a second type, different than the first type, outputting, via the output device, a comparison of data for a first time period of the second type relative to a second time period of the second type, wherein the second time period of the second type is different from the first time period of the second type by a length of a time period of the second type.
